(19) United States
(12) Patent Application Publication
(10) Pub. No.: US 2024/0056173 A1
(43) Pub. Date: Feb. 15, 2024

(54) WIRELESS COMMUNICATION SYSTEM, RELAY APPARATUS, WIRELESS COMMUNICATION METHOD AND PROGRAM

(71) Applicant: NIPPON TELEGRAPH AND TELEPHONE CORPORATION, Tokyo (JP)

(72) Inventors: Kazumitsu SAKAMOTO, Musashino-shi (JP); Yosuke FUJINO, Musashino-shi (JP); Daisuke GOTO, Musashino-shi (JP); Yasuyoshi KOJIMA, Musashino-shi (JP); Kiyohiko ITOKAWA, Musashino-shi (JP)

(73) Assignee: NIPPON TELEGRAPH AND TELEPHONE CORPORATION, Tokyo (JP)

(21) Appl. No.: 18/268,108

(22) PCT Filed: Dec. 24, 2020
(86) PCT No.: PCT/JP2020/048435

§ 371 Date: Jun. 16, 2023

(51) Int. Cl. H04B 7/185

(52) U.S. Cl. CPC H04B 7/18513

(57) ABSTRACT

A moving relay apparatus includes a first signal receiver, a second signal transmitter, and a transmission data controller. The first signal receiver receives a wireless first signal transmitted by the first communication apparatus by a reception antenna, and acquires waveform data of the first signal received by the reception antenna. A second signal transmitter transmits the waveform data acquired by the first signal receiver to the second communication apparatus by a second signal. A transmission data controller controls a data amount of the waveform data generated by the first signal receiver on the basis of information regarding communication quality between the relay apparatus and the first communication apparatus at a relay apparatus position where the first signal has been received.

### TECHNICAL FIELD

The present invention relates to a wireless communication system, a relay apparatus, a wireless communication method and a program.

### BACKGROUND ART

With the development of Internet of Things (IoT) technology, it has been studied to install IoT terminals including various sensors in various places. The IoT terminal may be installed in a place where it is difficult to install a base station, such as a buoy or a ship on the sea, or a mountainous area, for example. Accordingly, it is considered that data collected by IoT terminals installed in various places is relayed to the base station installed on the ground by a relay apparatus mounted on a low earth orbit satellite. For example, the relay apparatus mounted on the low earth orbit satellite receives data from an IoT terminal and transmits reception waveform data in an antenna to the base station (see, for example, Non Patent Literature 1). The base station restores a signal received by each antenna of a relay station by using the reception waveform data received from the relay apparatus. The base station performs reception processing such as signal processing and decoding on the recovered signal to obtain the data transmitted from the IoT terminal.

### CITATION LIST

### Non Patent Literature

Non Patent Literature 1: Kiyohiko Itokawa, Daisuke Goto, Yasuyoshi Kojima, Fumihiro Yamashita, Kento Yoshizawa, Kazumitsu Sakamoto, Yosuke Fujino, Chiharu Kato, and Mitsuhiro Nakadai, “Proposal of 920 MHz Band Satellite IoT Platform Utilizing Low Earth Orbit MIMO Technology”, The Institute of Electronics, Information and Communication Engineers (IEICE), 2020 Communication Society Conference, B-3-12, September 2020

### SUMMARY OF INVENTION

### Technical Problem

In a case where the relay apparatus mounted on the low earth orbit satellite transmits waveform data of an antenna that has received the data from the IoT terminal to the ground, a communication band from the relay apparatus to the base station may be congested due to an enormous data amount.

In view of the above circumstances, an object of the present invention is to provide a wireless communication system, a relay apparatus, a wireless communication method and a program capable of reducing a data amount when a relay apparatus relays received data while moving.

### Solution to Problem

One aspect of the present invention is a wireless communication system including a first communication apparatus, a second communication apparatus, and a moving relay apparatus, in which the relay apparatus includes a first signal receiver that receives a wireless first signal transmitted by the first communication apparatus by a reception antenna, and acquires waveform data of the first signal received by the reception antenna, a second signal transmitter that transmits the waveform data acquired by the first signal receiver to the second communication apparatus by a second signal, and a transmission data controller that controls a data amount of the waveform data generated by the first signal receiver on the basis of information regarding communication quality between the relay apparatus and the first communication apparatus at a relay apparatus position where the first signal has been received, and the second communication apparatus includes a second signal receiver that receives the second signal transmitted from the relay apparatus, a second signal reception processor that performs reception processing of the second signal received by the second signal receiver and acquires the waveform data, and a first signal reception processor that performs reception processing of the first signal indicated by the waveform data acquired by the second signal reception processor, and acquires data set to the first signal by the first communication apparatus.

One aspect of the present invention is a relay apparatus in a wireless communication system including a first communication apparatus, a second communication apparatus, and a moving relay apparatus, the relay apparatus including a first signal receiver that receives a wireless first signal transmitted by the first communication apparatus by a reception antenna, and acquires waveform data of the first signal received by the reception antenna, a second signal transmitter that transmits the waveform data acquired by the first signal receiver to the second communication apparatus by a second signal, and a transmission data controller that controls a data amount of the waveform data generated by the first signal receiver on the basis of information regarding communication quality between the relay apparatus and the first communication apparatus at a relay apparatus position where the first signal has been received.

One aspect of the present invention is a wireless communication method executed by a wireless communication system including a first communication apparatus, a second communication apparatus, and a moving relay apparatus, the wireless communication method including a first signal reception step of receiving, by the relay apparatus, a wireless first signal transmitted by the first communication apparatus by a reception antenna, and acquiring waveform data of the first signal received by the reception antenna, a second signal transmitting step of transmitting, by the relay apparatus, the waveform data acquired in the first signal reception step to the second communication apparatus by a second signal, a transmission data control step of controlling, by the relay apparatus, a data amount of the waveform data generated in the first signal reception step on the basis of information regarding communication quality between the relay apparatus and the first communication apparatus at a relay apparatus position where the first signal has been received, a second signal reception step of receiving, by the second communication apparatus, the second signal transmitted from the relay apparatus, a second signal reception processing step of performing, by the second communication apparatus, reception processing of the second signal received in the second signal reception step and acquiring the waveform data, and a first signal reception processing step of performing, by the second communication apparatus, reception processing of the first signal indicated by the waveform data acquired in the second signal reception processing step, and acquiring data set to the first signal by the first communication apparatus.

One aspect of the present invention is a wireless communication method executed by a relay apparatus in a wireless communication system including a first communication apparatus, a second communication apparatus, and a moving relay apparatus, the wireless communication method including a first signal reception step of receiving a wireless first signal transmitted by the first communication apparatus by a reception antenna, and acquiring waveform data of the first signal received by the reception antenna, a second signal transmission step of transmitting the waveform data acquired in the first signal reception step to the second communication apparatus by a second signal, and a transmission data control step of controlling a data amount of the waveform data generated by the first signal receiver on the basis of information regarding communication quality between the relay apparatus and the first communication apparatus at a relay apparatus position where the first signal has been received.

One aspect of the present invention is a program of a relay apparatus in a wireless communication system including a first communication apparatus, a second communication apparatus, and a moving relay apparatus, the program causing a computer to execute a reception control step of performing control to acquire waveform data of a wireless first signal from the first communication apparatus received by a reception antenna, a transmission control step of performing control to transmit the waveform data to the second communication apparatus by a second signal, and a transmission data control step of controlling a data amount of the waveform data to be generated on the basis of information regarding communication quality between the relay apparatus and the first communication apparatus at a relay apparatus position where the first signal has been received.

### Advantageous Effects of Invention

According to the present invention, it is possible to reduce a data amount when a relay apparatus relays received data while moving.

### BRIEF DESCRIPTION OF DRAWINGS

FIG. 1 is a diagram for explaining a wireless communication system according to an embodiment of the present invention.

FIG. 2 is a configuration diagram of the wireless communication system according to a first embodiment.

FIG. 3 is a flowchart illustrating processing of the wireless communication system according to the embodiment.

FIG. 4 is a flowchart illustrating processing of a mobile relay station according to the embodiment.

FIG. 5 is a flowchart illustrating processing of the wireless communication system according to the embodiment.

FIG. 6 is a configuration diagram of the wireless communication system according to the embodiment.

FIG. 7 is a configuration diagram of a base station communicator according to the embodiment.

FIG. 8 is a flowchart illustrating processing of the wireless communication system according to the embodiment.

FIG. 9 is a configuration diagram of a wireless communication system according to a second embodiment.

FIG. 10 is a flowchart illustrating processing of a mobile relay station according to the embodiment.

FIG. 11 is a configuration diagram of the wireless communication system according to the embodiment.

FIG. 12 is a flowchart illustrating processing of the wireless communication system according to the embodiment.

FIG. 13 is a configuration diagram of a wireless communication system according to a third embodiment.

FIG. 14 is a flowchart illustrating processing of a mobile relay station according to the embodiment.

FIG. 15 is a flowchart illustrating processing of the wireless communication system according to the embodiment.

FIG. 16 is a flowchart illustrating processing of the mobile relay station according to the embodiment.

FIG. 17 is a flowchart illustrating processing of a base station according to the embodiment.

FIG. 18 is a flowchart illustrating processing of the base station according to the embodiment.

FIG. 19 is a configuration diagram of a wireless communication system according to a fourth embodiment.

FIG. 20 is a configuration diagram of a mobile relay station according to a fifth embodiment.

FIG. 21 is a configuration diagram of a mobile relay station according to a sixth embodiment.

FIG. 22 is a configuration diagram of a wireless communication system according to a seventh embodiment.

FIG. 23 is a flowchart illustrating processing of a mobile relay station according to the embodiment.

FIG. 24 is a configuration diagram of the wireless communication system according to the embodiment.

FIG. 25 is a flowchart illustrating processing of the wireless communication system according to the embodiment.

FIG. 26 is a configuration diagram of a wireless communication system according to an eighth embodiment.

FIG. 27 is a flowchart illustrating processing of a mobile relay station according to the embodiment.

FIG. 28 is a configuration diagram of the wireless communication system according to the embodiment.

FIG. 29 is a flowchart illustrating processing of the wireless communication system according to the embodiment.

FIG. 30 is a configuration diagram of a wireless communication system according to a ninth embodiment.

FIG. 31 is a flowchart illustrating processing of a mobile relay station according to the embodiment.

FIG. 32 is a flowchart illustrating processing of the wireless communication system according to the embodiment.

FIG. 33 is a flowchart illustrating processing of the mobile relay station according to the embodiment.

FIG. 34 is a flowchart illustrating processing of a base station according to the embodiment.

FIG. 35 is a flowchart illustrating processing of the base station according to the embodiment.

FIG. 36 is a configuration diagram of a wireless communication system according to a tenth embodiment.

FIG. 37 is a configuration diagram of a mobile relay station according to an eleventh embodiment.

FIG. 38 is a configuration diagram of a mobile relay station according to a twelfth embodiment.

FIG. 39 is a configuration diagram of a mobile relay station according to a thirteenth embodiment.

FIG. 40 is a configuration diagram of the mobile relay station according to the embodiment.

FIG. 41 is a hardware configuration diagram of the mobile relay station according to the first to thirteenth embodiments.

### DESCRIPTION OF EMBODIMENTS

Embodiments of the present invention are now described in detail with reference to the drawings. In each embodiment described below, the same components as those in other embodiments are denoted by the same reference numerals, and redundant description may be omitted.

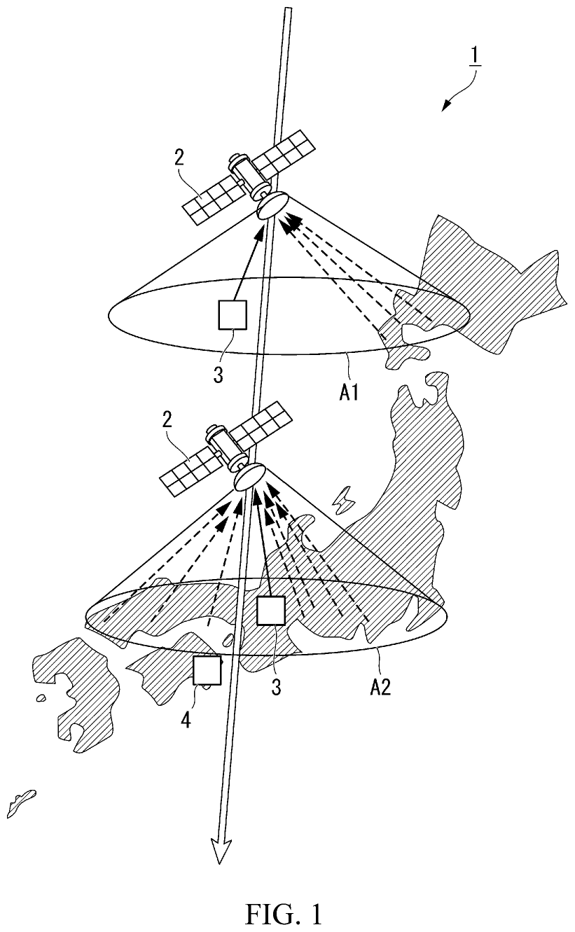

FIG. 1 is a diagram for describing an overview of a wireless communication system 1 according to an embodiment of the present invention. The wireless communication system 1 includes a mobile relay station 2, a terminal station 3, and a base station 4. Although the number of each of the mobile relay stations 2, the terminal stations 3, and the base stations 4 included in the wireless communication system 1 is arbitrary, it is assumed that the number of terminal stations 3 is large.

The mobile relay station 2 is an example of a relay apparatus that is mounted on a mobile object and whose communicable area moves with the lapse of time. The mobile relay station 2 of the present embodiment is provided in a low earth orbit (LEO) satellite. The altitude of the LEO satellite is 2000 km or less, and the LEO satellite goes around the earth in about 1.5 hours. The terminal station 3 and the base station 4 are installed on the earth such as on the ground or on the sea. The terminal station 3 is, for example, an IoT terminal. A radio signal from the terminal station 3 to the mobile relay station 2 is referred to as a terminal uplink signal, a radio signal from the mobile relay station 2 to the base station 4 is referred to as a base station downlink signal, and a radio signal from the base station 4 to the mobile relay station 2 is referred to as a base station uplink signal.

The terminal station 3 collects data such as environment data detected by the sensor, and transmits a terminal uplink signal in which the collected data is set to the mobile relay station 2. The mobile relay station 2 receives the terminal uplink signal transmitted from each of the plurality of terminal stations 3 while moving above the earth. In FIG. 1, the mobile relay station 2 receives a terminal uplink signal from a terminal station 3 installed in an area A1 of a communication destination at a certain time. Thereafter, the mobile relay station 2 receives the terminal uplink signal from the terminal station 3 installed in the area A2 of the communication destination. The mobile relay station 2 accumulates data received from the terminal station 3 by the terminal uplink signal, and wirelessly transmits the accumulated data to the base station 4 by the base station downlink signal at a timing at which communication with the base station 4 is possible. The base station 4 acquires data collected by the terminal station 3 from the received base station downlink signal.

The mobile relay station 2 includes an antenna used for wireless communication with the terminal station 3 and an antenna used for wireless communication with the base station 4. Therefore, the mobile relay station 2 can also perform wireless communication with the terminal station 3 and wireless communication with the base station 4 in parallel. Hereinafter, an antenna by which the mobile relay station 2 receives the terminal uplink signal transmitted from the terminal station 3 is also referred to as a reception antenna, and an antenna by which the mobile relay station 2 transmits the base station downlink signal to the base station 4 is also referred to as a transmission antenna.

As the mobile relay station, it is conceivable to use a relay station mounted on an unmanned aerial vehicle such as a geostationary satellite, a drone, or a high altitude platform station (HAPS). However, in a case of the relay station mounted on the geostationary satellite, although the coverage area (footprint) on the ground is large, a link budget for an IoT terminal installed on the ground is very small due to the high altitude. On the other hand, in a case of the relay station mounted on the drone or the HAPS, although the link budget is high, the coverage area is narrow. Furthermore, the drone requires a battery and the HAPS requires a solar panel. In the present embodiment, the mobile relay station 2 is mounted on the LEO satellite. Thus, in addition to the link budget remaining within limits, the LEO satellites have no air resistance and low fuel consumption due to orbiting outside the atmosphere. Further, the footprint is also larger than that in a case where the relay station is mounted on the drone or the HAPS.

Since the mobile relay station 2 mounted on the LEO satellite performs communication while moving at a high speed, a time during which each terminal station 3 or base station 4 can communicate with the mobile relay station 2 is limited. Specifically, when viewed on the ground, the mobile relay station 2 passes through the sky in about several minutes. Further, wireless communication methods of various specifications are used for the terminal station 3. Accordingly, the mobile relay station 2 receives the terminal uplink signal from the terminal station 3 within the coverage at the current position during movement, and stores waveform data obtained by sampling the waveform of the received terminal uplink signal. The mobile relay station 2 wirelessly transmits the base station downlink signal in which the stored waveform data is set to the base station 4 at a timing at which the base station 4 exists in the coverage. The base station 4 demodulates the base station downlink signal received from the mobile relay station 2 to obtain waveform data. The base station 4 performs signal processing and decoding on the terminal uplink signal indicated by the waveform data to obtain terminal transmission data which is data transmitted by the terminal station 3.

Further, the mobile relay station 2 mounted on the LEO satellite has a smaller link budget than in the case where the relay station is mounted on the drone or the HAPS. Accordingly, the mobile relay station 2 may receive the terminal uplink signal using a plurality of reception antennas. For reception by the plurality of reception antennas, for example, multiple input multiple output (MIMO) is used. Communication quality can be improved by a diversity effect and a beamforming effect of communication using the plurality of reception antennas. Hereinafter, the waveform data obtained by sampling the waveform of the terminal uplink signal received by a certain reception antenna of the mobile relay station 2 is also referred to as waveform data of the reception antenna.

In order for the base station 4 to normally obtain the terminal transmission data from the waveform data, the mobile relay station 2 needs to transmit high-quality waveform data to the base station 4. The high-quality waveform data can be obtained by receiving the terminal uplink signal by the plurality of reception antennas or increasing a quantization bit number when generating the waveform data. However, when the mobile relay station 2 transmits the waveform data thus acquired to the ground to the base station 4, the data amount becomes enormous. Therefore, there is a possibility that a downlink communication band between the mobile relay station 2 and the base station 4 becomes tight. Furthermore, there is also a possibility that the power consumption of the mobile relay station 2 increases. Accordingly, in the present embodiment, when it is assumed that the communication quality between the mobile relay station 2 and the terminal station 3 is good, the mobile relay station 2 reduces the data amount of the waveform data generated in the reception processing. Specifically, in a case where the mobile relay station 2 includes the plurality of reception antennas, the mobile relay station 2 receives the terminal uplink signal using a smaller number of reception antennas among the reception antennas as the communication quality is good or is assumed to be good. Alternatively, the mobile relay station 2 generates waveform data sampled by reducing the quantization bit number as the communication quality is good or is assumed to be good.

For example, it is assumed that the larger the elevation angle from the terminal station 3 to the mobile relay station 2 (closer to 90 degrees), the better the communication quality. Since the terminal station 3 often does not move or moves less frequently, the elevation angle from the terminal station 3 to the mobile relay station 2 is determined by the position of the mobile relay station 2. Further, for example, it is assumed that the lower the population density in the region where the terminal station 3 is installed, the better the communication quality. As illustrated in FIG. 1, in an area A1 having a low population density, there are few interference waves indicated by broken arrows. Therefore, it is assumed that the communication quality of the terminal uplink signal from the terminal station 3 installed in the area A1 is high. On the other hand, in the area A2 having a high population density, there are many interference waves indicated by broken arrows. Therefore, it is assumed that the communication quality of the terminal uplink signal from the terminal station 3 installed in the area A2 is lower than the communication quality of the terminal uplink signal from the terminal station 3 installed in the area A1.

Further, the mobile relay station 2 is circling above the earth and passes through the same path many times. The base station 4 determines a required number of reception antennas as to how many reception antennas is required for the waveform data in each area or the required quantization bit number for each area on the basis of a decoding result of the waveform data obtained when the mobile relay station 2 moved on the same path in the past. The higher the ratio of normal decoding, the higher the communication quality, and thus the more the number of reception antennas can be reduced or the quantization bit number can be reduced. The base station 4 notifies the mobile relay station 2 of the required number of reception antennas or the required quantization bit number determined for each area.

A detailed embodiment of the wireless communication system will be described below.

### First Embodiment

The wireless communication system of a first embodiment determines the number of reception antennas according to an elevation angle with respect to the mobile relay station from a predetermined position in an area on the earth, which is a communication destination of the mobile relay station. The predetermined position is, for example, the center of the area.

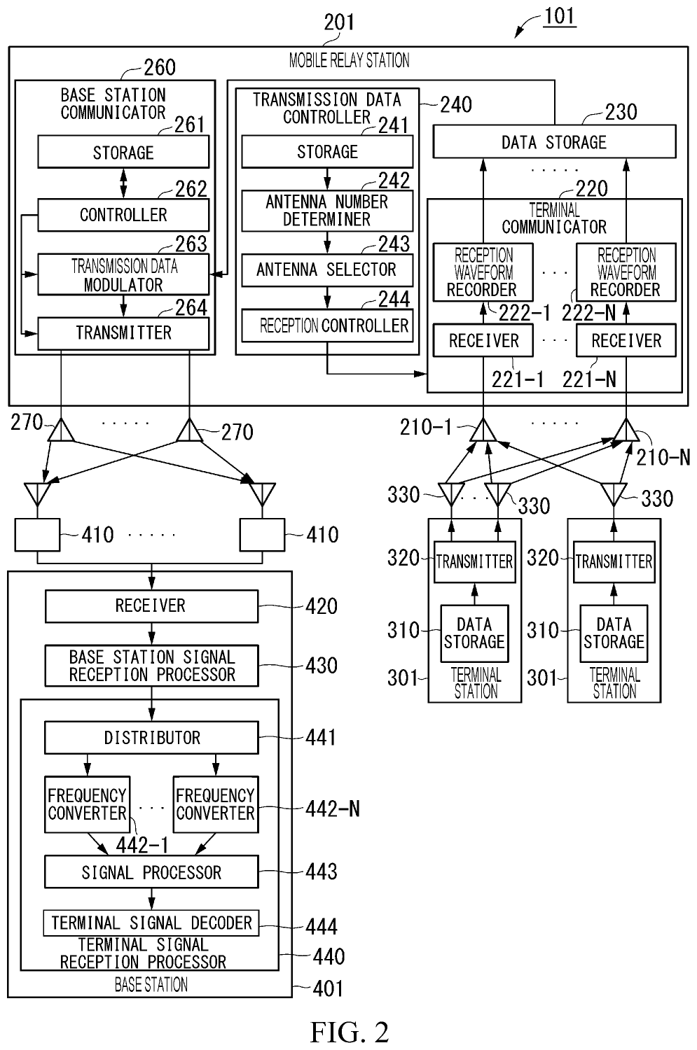

FIG. 2 is a configuration diagram of a wireless communication system 101 according to the first embodiment. The wireless communication system 101 includes a mobile relay station 201, a terminal station 301, and a base station 401. The mobile relay station 201 is used as the mobile relay station 2 in FIG. 1, the terminal station 301 is used as the terminal station 3 in FIG. 1, and the base station 401 is used as the base station 4 in FIG. 1.

It is possible to make a satellite reception beam formed by the post-processing in the base station 401 to be sharp toward a front direction of a reception array antenna plane of the mobile relay station 201. That is, a separation distance on the ground necessary for separating a desired signal and an interference signal is reduced. Therefore, when it is assumed that the mobile relay station 201 faces the reception array antenna plane in the center direction of the earth (geocentric direction), when the elevation angle from the terminal station 301 to the mobile relay station 201 is large, signal separation of the terminal uplink signal received by the mobile relay station 201 is easy. Accordingly, the mobile relay station 201 receives the terminal uplink signal using some of the plurality of reception antennas at the high elevation angle.

Specifically, when collecting data from the terminal station 301 in a specific area at a certain time, the mobile relay station 201 calculates the elevation angle to the mobile relay station 201 at the time from the center position of the area. The mobile relay station 201 calculates the number of reception antennas by substituting the calculated value of the elevation angle into a relational expression for calculating the number of reception antennas using the elevation angle as a parameter. The mobile relay station 201 transmits the waveform data of the reception antennas of the calculated number of reception antennas to the base station 401 by the base station downlink signal. Hereinafter, a case where the mobile relay station 201 relays the base station downlink signal to the base station 401 by MIMO using a plurality of transmission antennas will be described as an example.

The mobile relay station 201 includes N (N is an integer of 2 or more) antennas 210, a terminal communicator 220, a data storage 230, a transmission data controller 240, a base station communicator 260, and M (M is an integer of 2 or more) antennas 270.

The antenna 210 is a reception antenna that receives a terminal uplink signal transmitted from the terminal station 301. The N antennas 210 are referred to as antennas 210-1 to 210-N.

The terminal communicator 220 includes N receivers 221 and N reception waveform recorders 222. The N receivers 221 are referred to as receivers 221-1 to 221-N, and the N reception waveform recorders 222 are referred to as reception waveform recorders 222-1 to 222-N.

The receiver 221-n (n is an integer between 1 and N) receives the terminal uplink signal through the antenna 210-n. The reception processing by the receiver 221-n can include amplification by a low noise amplifier (LNA) and filtering of a frequency band by a band pass filter (BPF). The reception waveform recorder 222-n samples a reception waveform of the terminal uplink signal received by the receiver 221-n as a radio frequency (RF) signal as it is, and generates waveform data indicating a value obtained by the sampling. The reception waveform recorder 222-n writes reception waveform information in which antenna identification information of the antenna 210-n, the reception time of the terminal uplink signal at the antenna 210-n, the generated waveform data, and the quantization bit number used for generating the waveform data are set to the data storage 230. The antenna identification information is information for specifying each antenna 210. When the quantization bit number is fixed, the reception waveform information may not include the information of the quantization bit number.

The data storage 230 stores the reception waveform information generated by the reception waveform recorder 222.

The transmission data controller 240 includes a storage 241, an antenna number determiner 242, an antenna selector 243, and a reception controller 244. The storage 241 stores orbit information and communication area information. The orbit information is information from which a position, a velocity, a moving direction, and the like at an arbitrary time of the LEO satellite equipped with the own station can be obtained. The communication area information is information from which information of the position of the communication area at each time can be acquired. For example, the communication area information is information in which a time zone indicated by a start time and an end time is associated with a position of the communication area in the time zone. The communication area is an area on the earth that is a communication destination of the mobile relay station 201. The mobile relay station 201 receives the terminal uplink signal from the terminal station 301 installed in the communication area. The communication area is calculated in advance on the basis of the orbit information of the LEO satellite. In other words, the communication area is determined by the position of the mobile relay station 201.

The antenna number determiner 242 calculates the elevation angle from the center position of the communication area to the LEO satellite using the position of the LEO satellite and the information of the position of the communication area at each time. The antenna number determiner 242 acquires the position of the LEO satellite at each time on the basis of the orbit information stored in the storage 241. Further, the antenna number determiner 242 acquires information of the position of the communication area at each time from the area information stored in the storage 241. The antenna number determiner 242 calculates the number of reception antennas by substituting the calculated value of the elevation angle as a parameter value into the relational expression for calculating the number of reception antennas using the elevation angle as a parameter. This relational expression is predefined. Alternatively, relational data in which the range of the elevation angle is associated with the number of reception antennas may be stored in the storage 241, and the antenna number determiner 242 may read the number of reception antennas corresponding to the calculated value of the elevation angle from the relational data. The closer the elevation angle is to 90 degrees, the smaller the number of reception antennas.

The antenna selector 243 selects the antennas 210 by the number of reception antennas determined by the antenna number determiner 242 from the N antennas 210.

Hereinafter, the selected antenna 210 is also referred to as a selected reception antenna. The antenna selector 243 selects the antennas 210 by the number of reception antennas so that the area formed by the selected reception antennas is as wide as possible and density of the selected reception antennas in the area is close to uniform. Note that the storage 241 may store in advance antenna selection information in which the number of reception antennas is associated with the antenna identification information of the antenna 210 to be selected as the selected reception antennas. The antenna selector 243 reads the antenna identification information corresponding to the number of reception antennas from the antenna selection information, and sets the antennas 210 specified by the read antenna identification information as the selected reception antennas.

The reception controller 244 performs reception using the selected reception antennas determined by the antenna selector 243, and performs control to stop reception using the antennas 210 other than the selected reception antennas determined by the antenna selector 243. Since the antenna 210 is a passive element, a power supply is unnecessary. Accordingly, for example, the reception controller 244 operates the receiver 221-n and the reception waveform recorder 222-n corresponding to the antenna 210-n of the selected reception antenna, and controls to stop operations of the receiver 221-n and the reception waveform recorder 222-n corresponding to the antenna 210-n other than the selected reception antennas.

The base station communicator 260 transmits the base station downlink signal to the base station 401 by MIMO. The base station communicator 260 includes a storage 261, a controller 262, a transmission data modulator 263, and a transmitter 264. The storage 261 stores a transmission start timing calculated in advance on the basis of the orbit information of the LEO satellite on which the own station is mounted and the position of the base station 401. Furthermore, the storage 261 stores in advance a weight for each transmission time of the base station downlink signal to be transmitted from each antenna 270. The weight for each transmission time is calculated on the basis of the orbit information of the LEO satellite and the position of each antenna station 410 included in the base station 401. Note that the base station communicator 260 may use a constant weight regardless of the transmission time.

The controller 262 controls the transmission data modulator 263 and the transmitter 264 to transmit the base station downlink signal to the base station 401 at the transmission start timing stored in the storage 261. Furthermore, the controller 262 instructs the transmitter 264 on the weight for each transmission time read from the storage 261. The transmission data modulator 263 reads the reception waveform information from the data storage 230, and sets the read reception waveform information as transmission data. The transmission data modulator 263 converts the transmission data into a parallel signal and then modulates the parallel signal.

The transmitter 264 weights the modulated parallel signal by a weight instructed from the controller 262 and generates the base station downlink signal transmitted from each antenna 270. Although not illustrated, the transmitter 264 includes a power amplifier corresponding to each antenna 270. The transmitter 264 amplifies the base station downlink signal transmitted from a certain antenna 270 by a power amplifier corresponding to the antenna 270, and outputs the signal to the antenna 270. Thus, the base station downlink signal is transmitted from the M antennas 270 by MIMO. Note that the base station communicator 260 may not use the weight for transmission of the base station downlink signal, and the weight may be used only for reception of the base station downlink signal in the base station 401.

The antenna 270 operates as a transmission antenna that wirelessly transmits the base station downlink signal. In addition, the antenna 270 may receive a base station uplink signal wirelessly transmitted from the base station 401.

The terminal station 301 is an IoT terminal (ground IoT terminal) installed on the ground. The terminal station 301 includes a data storage 310, a transmitter 320, and one or a plurality of antennas 330. The data storage 310 stores sensor data and the like. The transmitter 320 reads the sensor data from the data storage 310 as terminal transmission data, and wirelessly transmits a terminal uplink signal in which the read terminal transmission data is set from the antenna 330. The transmitter 320 transmits the signal by low power wide area (LPWA), for example. LPWA includes LoRaWAN (registered trademark), Sigfox (registered trademark), LTE-M (Long Term Evolution for Machines), NB (Narrow Band)-IoT, and the like, but any wireless communication method can be used. In addition, the transmitter 320 may perform transmission with another terminal station 301 by time division multiplexing, orthogonal frequency division multiplexing (OFDM), or the like. The transmitter 320 determines a channel and a transmission timing to be used for transmission of a terminal uplink signal by its own station by a method determined in advance in a wireless communication method to be used.

The base station 401 includes a plurality of antenna stations 410, a receiver 420, a base station signal reception processor 430, and a terminal signal reception processor 440. The antenna station 410 is arranged at a position away from the other antenna stations 410 so that an arrival angle difference of signals from each of the plurality of antennas 270 of the mobile relay station 201 increases. Each antenna station 410 converts the base station downlink signal received from the mobile relay station 201 into an electrical signal and outputs the electrical signal to the receiver 420.

The receiver 420 aggregates the base station downlink signals received from the plurality of antenna stations 410. The receiver 420 stores a weight for each reception time with respect to the base station downlink signal received by each antenna station 410 on the basis of the orbit information of the LEO satellite and the position of each antenna station 410. The receiver 420 multiplies the base station downlink signal input from each antenna station 410 by a weight corresponding to the reception time of the base station downlink signal, and combines reception signals multiplied by the weight. Note that the same weight may be used regardless of the reception time. The base station signal reception processor 430 demodulates and decodes the combined reception signal to obtain the reception waveform information. The base station signal reception processor 430 outputs the reception waveform information to the terminal signal reception processor 440.

The terminal signal reception processor 440 performs reception processing of the terminal uplink signal indicated by the reception waveform information. At this time, the terminal signal reception processor 440 performs reception processing according to the wireless communication method used for transmission by the terminal station 301 and acquires the terminal transmission data. The terminal signal reception processor 440 includes a distributor 441, N frequency convertors 442, a signal processor 443, and a terminal signal decoder 444. The N frequency convertors 442 are respectively referred to as frequency convertors 442-1 to 442-N.

The distributor 441 reads the waveform data at the same reception time and the quantization bit number of the waveform data from the reception waveform information. The distributor 441 outputs the read waveform data and the quantization bit number of the waveform data to the frequency convertors 442-1 to 442-N according to the antenna identification information associated with the waveform data. That is, the distributor 441 outputs the waveform data and the quantization bit number associated with the antenna identification information of the antenna 210-n to the frequency convertor 442-n. Note that, when the antenna 210-n is not the selected reception antenna, no waveform data is output to the frequency convertor 442-n. In addition, the distributor 441 may output the waveform data and the quantization bit number obtained from the reception waveform information to different frequency convertors 442 regardless of the antenna identification information associated with the waveform data. In a case where the quantization bit number is fixed, the distributor 441 may not output the quantization bit number to the frequency convertor 442.

Each of the frequency convertors 442 to which received the waveform data from the distributor 441 has been input restores the waveform data to a signal waveform received by the receiver 221 on the basis of the quantization bit number. The frequency convertor 442 frequency-converts the signal represented by the restored signal waveform from the RF signal to the baseband signal. For the frequency conversion, a quadrature demodulator or the like is used. Each of the frequency convertors 442-1 to 442-N outputs the frequency-converted reception signal to the signal processor 443.

To the signal processor 443, the reception signal is input from each of the frequency convertors 442 to which the waveform data is input among the frequency convertors 442-1 to 442-N. The signal processor 443 performs processing such as frame detection (terminal signal detection), Doppler shift compensation, and offline beam control on the input reception signal. The frame detection is processing of detecting a section including a terminal transmission signal (terminal transmission frame) from the waveform data. The signal processor 443 specifies the wireless communication method used by the terminal station 301 to transmit the terminal uplink signal on the basis of the information specific to the wireless communication method included in the reception signal indicated by the waveform data, and detects the terminal transmission frame according to the specified wireless communication method. The offline beam control is processing in which the mobile relay station 201 transmits recorded waveform data to the base station 401 without performing reception beam control, and the base station 401 performs reception beam control as post-processing. In the reception beam control, the signal processor 443 multiplies reception signals of respective reception systems by weights for performing amplitude correction and phase correction and then adds and combines the signals so that the reception signals are intensified and combined. Note that the signal processor 443 may simply add and combine the reception signals of the respective reception systems without performing the reception beam control. The signal processor 443 outputs a symbol obtained from the added and combined reception signals to the terminal signal decoder 444. The terminal signal decoder 444 decodes the symbol output from signal processor 443 to obtain the terminal transmission data transmitted from the terminal station 301. The terminal signal decoder 444 can also use a decoding method with a large calculation load, such as successive interference cancellation (SIC).

An operation of the wireless communication system 101 will be described.

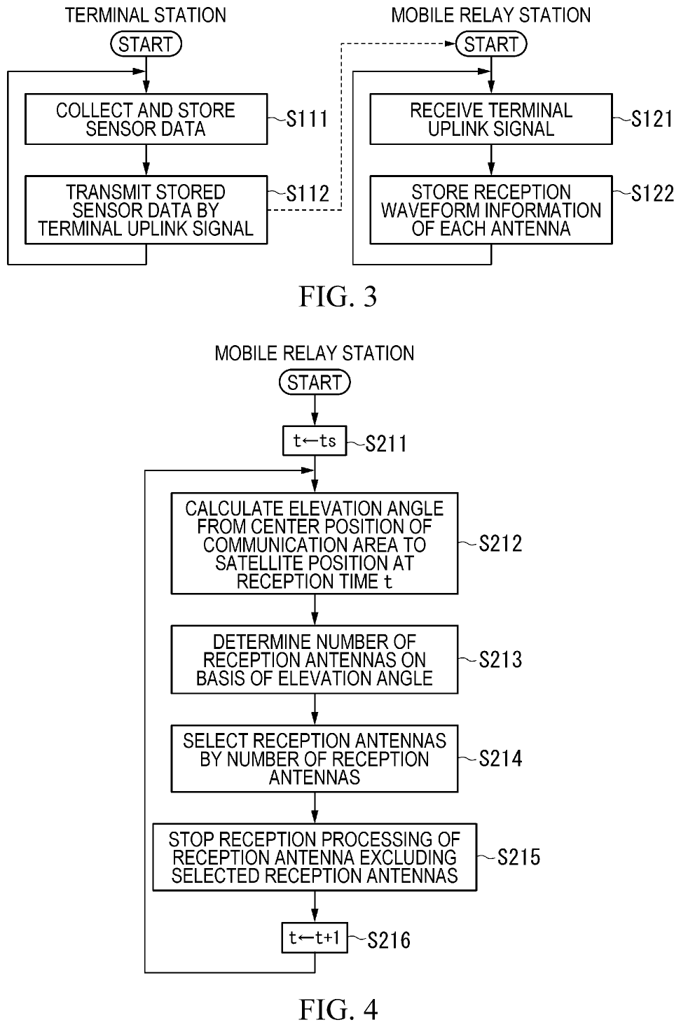

FIG. 3 is a flowchart illustrating processing of the wireless communication system 101 in a case where a terminal uplink signal is transmitted from the terminal station 301. The terminal station 301 acquires data detected by a sensor, which is not illustrated, provided outside or inside as needed, and writes the acquired data in the data storage 310 (step S111). The transmitter 320 reads the sensor data from the data storage 310 as the terminal transmission data. The transmitter 320 wirelessly transmits the terminal uplink signal in which the terminal transmission data is set from the antenna 330 at a transmission start timing obtained in advance on the basis of the orbit information of the LEO satellite equipped with the mobile relay station 201 (step S112). The terminal station 301 repeats the processing from step S111. Note that the terminal station 301 may perform transmission with another terminal station 301 by time division multiplexing, OFDM, MIMO, or the like.

The receiver 221 of the mobile relay station 201 receives the terminal uplink signal transmitted from the terminal station 301 (step S121). Depending on the wireless communication method of the transmission source terminal station 301, there are a case where the terminal uplink signal is received from only one terminal station 301 in a time division manner at the same frequency and a case where the terminal uplink signals are simultaneously received from a plurality of terminal stations 301 at the same frequency. The reception waveform recorder 222-n generates waveform data of the terminal uplink signal received by the receiver 221-n. The reception waveform recorder 222-n writes the reception waveform information in which the generated waveform data, the reception time, the antenna identification information of the antenna 210-n, and the quantization bit number are associated with each other in the data storage 230 (step S122). The mobile relay station 201 repeats the processing from step S121.

Note that, under control of the reception controller 244 illustrated in FIG. 4, the receiver 221-n and the reception waveform recorder 222-n corresponding to the antenna 210-n that is not the selected reception antenna at the current time do not perform the processing of steps S121 and S122.

FIG. 4 is a flowchart illustrating transmission data control processing by the mobile relay station 201. The antenna number determiner 242 of the mobile relay station 201 sets an initial value ts to a reception time t (step S211). The reception time t represents a reception time of the terminal uplink signal by the reception antenna. Here, the reception time t is represented by a count value of a unit time elapsed from the reference time. The initial value ts is the current time.

The antenna number determiner 242 acquires the position of the LEO satellite at the reception time t on the basis of the orbit information stored in the storage 241. Furthermore, the antenna number determiner 242 acquires information of the position of the communication area at the reception time t from the communication area information stored in the storage 241. The antenna number determiner 242 calculates the elevation angle from the center position of the communication area to the position at the reception time t of the LEO satellite equipped with the mobile relay station 201 (step S212).

The antenna number determiner 242 calculates the number of reception antennas by substituting the value of the elevation angle calculated in step S212 as a parameter value into the relational expression for calculating the number of reception antennas using the elevation angle as a parameter (step S213). The antenna selector 243 selects the antennas 210 by the number of reception antennas calculated in step S213 from the N antennas 210 (step S214). Note that, in a case where the number of reception antennas calculated in step S213 is the same as the number of reception antennas at the time (t−1), the antenna selector 243 may use the selected reception antennas at the time (t−1) as they are.

The reception controller 244 operates the receiver 221-n and the reception waveform recorder 222-n corresponding to the antenna 210-n of the selected reception antenna selected by the antenna selector 243 in step S214, and stops the operations of the receiver 221-n and the reception waveform recorder 222-n corresponding to the antenna 210-n other than the selected reception antennas (step S215). The antenna number determiner 242 adds 1 to the reception time t (step S216), and repeats the processing from step S212.

The transmission data controller 240 may perform the processing illustrated in FIG. 4 using a time later than the current time as the reception time t. Thus, the transmission data controller 240 can determine the selected reception antenna in advance before receiving the terminal uplink signal. In this case, in step S211, the antenna number determiner 242 uses a time later than the current time as the initial value ts. Then, in step S214, the antenna selector 243 further performs processing of storing the antenna selection information indicating the selected reception antenna at the reception time t in the storage 241. After step S214, the transmission data controller 240 proceeds to the processing of step S216 without performing the processing of step S215. The reception controller 244 reads the information of the selected reception antenna corresponding to the current time from the antenna selection information stored in the storage 241. The reception controller 244 operates the receiver 221-n and the reception waveform recorder 222-n corresponding to the antenna 210-n of the read selected reception antenna, and stops the operations of the receiver 221-n and the reception waveform recorder 222-n corresponding to the antenna 210-n other than the selected reception antennas.

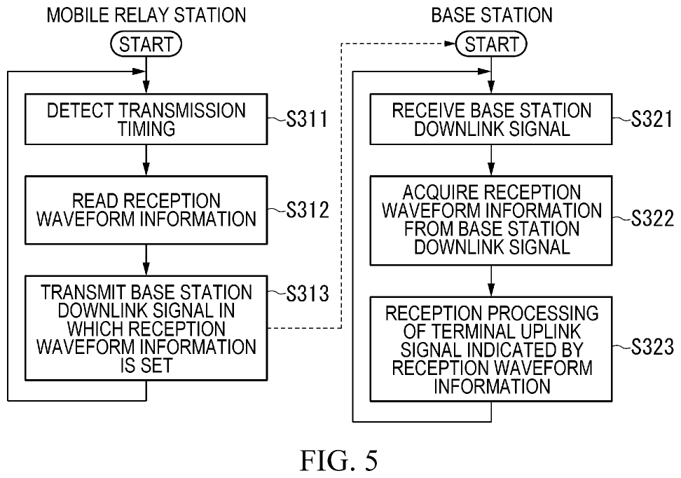

FIG. 5 is a flowchart illustrating processing of the wireless communication system 101 in a case where the base station downlink signal is transmitted from the mobile relay station 201. When detecting that it is the transmission start timing stored in the storage 261, the controller 262 included in the base station communicator 260 of the mobile relay station 201 instructs the transmission data modulator 263 and the transmitter 264 to transmit the reception waveform information (step S311).

The transmission data modulator 263 reads the reception waveform information accumulated in the data storage 230 as transmission data (step S312). Here, the reception waveform information read by the transmission data modulator 263 is reception waveform information in which the reception time after the reception time set in the reception waveform information transmitted to the base station 401 at last is set. The transmission data modulator 263 performs parallel conversion on the acquired transmission data and then modulates the transmission data.

The transmitter 264 weights the transmission data modulated by the transmission data modulator 263 by the weight instructed from the controller 262, and generates the base station downlink signal which is a transmission signal transmitted from each antenna 270. The transmitter 264 transmits each generated base station downlink signal from the antenna 270 by MIMO (step S313). The mobile relay station 201 repeats the processing from step S311.

Each antenna station 410 of the base station 401 receives the base station downlink signal from the mobile relay station 201 (step S321). Each antenna station 410 outputs a reception signal obtained by converting the received base station downlink signal into an electrical signal to the receiver 420. The receiver 420 synchronizes the timings of the reception signals received from the respective antenna stations 410. The receiver 420 multiplies the reception signal received by each antenna station 410 by a weight and adds the reception signals. The base station signal reception processor 430 demodulates the added reception signal and decodes the demodulated reception signal. Thus, the base station signal reception processor 430 obtains the reception waveform information (step S322). The base station signal reception processor 430 outputs the reception waveform information to the terminal signal reception processor 440.

The terminal signal reception processor 440 performs the reception processing of the terminal uplink signal indicated by the reception waveform information (step S323). Specifically, the distributor 441 reads the waveform data and the quantization bit number having the same reception time from the reception waveform information. The distributor 441 outputs the read waveform data and quantization bit number to the frequency convertors 442-1 to 442-N according to the antenna identification information associated with the waveform data. Among the frequency convertors 442-1 to 442-N, each of the frequency convertors 442 to which the waveform data has been input restores the signal waveform from the waveform data on the basis of the quantization bit number. The frequency convertor 442 frequency-converts the reception signal represented by the restored signal waveform from the RF signal into a baseband signal, and outputs the frequency-converted reception signal to the signal processor 443.

The signal processor 443 receives the reception signal of the baseband signal from each of the frequency convertors 442 to which the waveform data has been input. The signal processor 443 performs frame detection (terminal signal detection), Doppler shift compensation, and offline beam control on each of the input reception signals, and adds and combines the reception signals. By the addition and combination, the signal transmitted by the terminal station 301 is emphasized because of having a correlation, but the influence of the randomly added noise is reduced. Therefore, the diversity effect can be obtained for the terminal uplink signal simultaneously received by the mobile relay station 201 from only one terminal station 301. Further, the terminal uplink signals simultaneously received by the mobile relay station 201 from a plurality of terminal stations 301 correspond to performing MIMO communication. The signal processor 443 outputs the symbol of the reception signal added and combined to the terminal signal decoder 444. The terminal signal decoder 444 decodes the symbol input from signal processor 443 to obtain the terminal transmission data transmitted from terminal station 301.

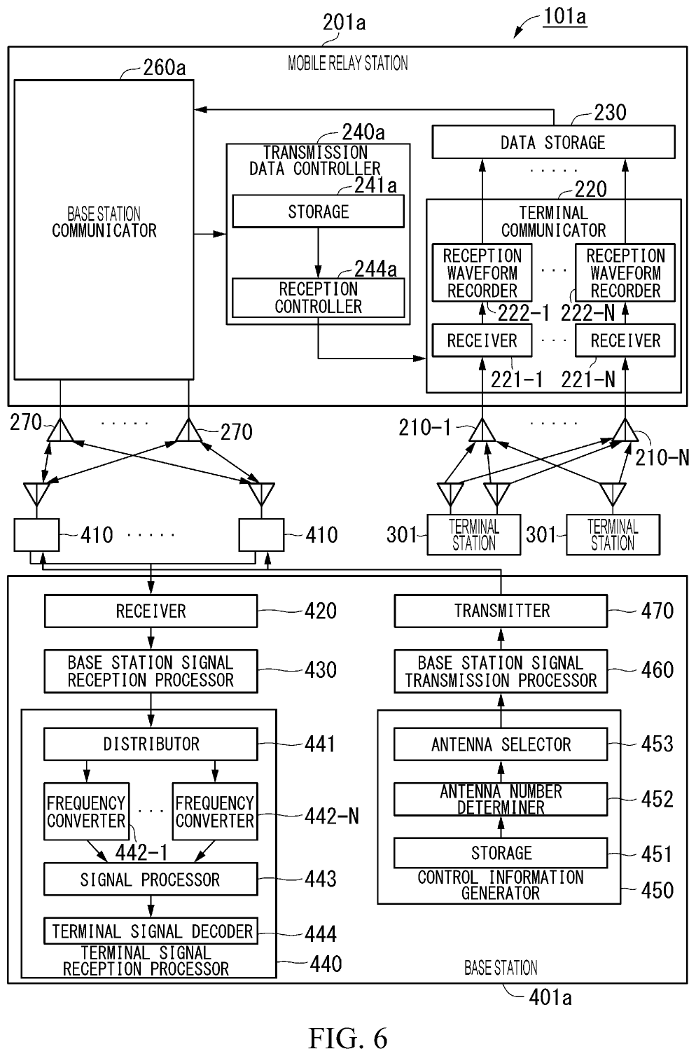

Note that, as illustrated in FIG. 6, the base station may have some of the functions of the transmission data controller 240 included in the mobile relay station 201. FIG. 6 is a configuration diagram of the wireless communication system 101a. In FIG. 6, the same components as those of the wireless communication system 101 illustrated in FIG. 2 are denoted by the same reference numerals, and the description thereof will be omitted. The wireless communication system 101a includes a mobile relay station 201a, the terminal station 301, and a base station 401a. The mobile relay station 201a is used as the mobile relay station 2 in FIG. 1, and the base station 401a is used as the base station 4 in FIG. 1.

The mobile relay station 201a illustrated in FIG. 6 is different from the mobile relay station 201 illustrated in FIG. 2 in that a transmission data controller 240a is included instead of the transmission data controller 240, and a base station communicator 260a is included instead of the base station communicator 260.

The transmission data controller 240a includes a storage 241a and a reception controller 244a. The storage 241a stores the antenna selection information. The antenna selection information is information indicating the selected reception antenna at each reception time. The reception controller 244a reads the information of the selected reception antenna corresponding to the current time from the antenna selection information stored in the storage 241a. The reception controller 244a performs control similar to that of the reception controller 244 illustrated in FIG. 2 on the basis of the read information of the selected reception antenna.

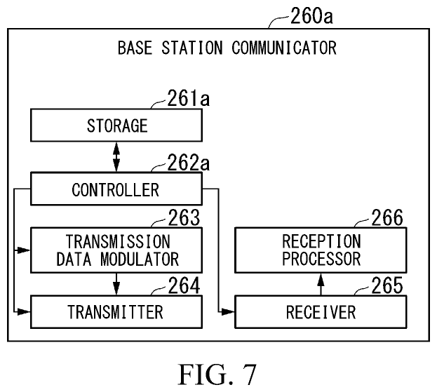

The base station communicator 260a transmits and receives radio signals to and from the base station 401a. Details of the base station communicator 260a will be described later with reference to FIG. 7.

The base station 401a illustrated in FIG. 6 is different from the base station 401 illustrated in FIG. 2 in further including a control information generator 450, a base station signal transmission processor 460, and a transmitter 470. Note that an external apparatus connected to the base station 401a may include the control information generator 450.

The control information generator 450 generates the antenna selection information of each mobile relay station 201a. The control information generator 450 includes a storage 451, an antenna number determiner 452, and an antenna selector 453.

The storage 451 stores, for each mobile relay station 201a, the orbit information and the communication area information of the LEO satellite on which the mobile relay station 201a is mounted. The antenna number determiner 452 performs processing similar to that of the antenna number determiner 242 illustrated in FIG. 2 for each mobile relay station 201a. Thus, the antenna number determiner 452 calculates the number of reception antennas at each reception time for each mobile relay station 201a. The antenna selector 453 performs processing similar to that of the antenna selector 243 illustrated in FIG. 2 for each mobile relay station 201a. Thus, the antenna selector 453 selects the antenna 210 by the number of reception antennas determined by the antenna number determiner 452 from the N antennas 210 included in the mobile relay station 201a for each mobile relay station 201a.

The base station signal transmission processor 460 converts the transmission data into a parallel signal transmitted from each antenna station 410 and then modulates the parallel signal. The transmitter 470 weights the parallel signal transmitted from each antenna station 410 with a transmission weight, and generates the base station uplink signal transmitted from each antenna station 410. The transmitter 470 outputs the generated base station uplink signal to the corresponding antenna station 410. The antenna station 410 wirelessly transmits the base station uplink signal.

FIG. 7 is a configuration diagram of the base station communicator 260a included in the mobile relay station 201a. The base station communicator 260a is different from the base station communicator 260 included in the mobile relay station 201 illustrated in FIG. 2 in that a storage 261a is included instead of the storage 261, a controller 262a is included instead of the controller 262, and a receiver 265 and a reception processor 266 are further included. The storage 261a stores, for each reception time, a reception weight to be applied to the base station uplink signal received by each antenna 270 from the base station 401a as a communication destination, in addition to information similar to that in the storage 261 illustrated in FIG. 2. The reception weight for each reception time is calculated on the basis of the orbit information of the LEO satellite and the position of each antenna station 401 of the communication destination base station 410a.

The controller 262a performs processing similar to that of the controller 262 illustrated in FIG. 2. Furthermore, the controller 262a reads the reception weight of each antenna 270 for each reception time from the storage 261a, and instructs the receiver 265 on the read reception weight. The receiver 265 receives the base station uplink signal by each antenna 270, multiplies the reception signal received by each antenna 270 by the reception weight instructed by the controller 262a, and then adds and combines the reception signals. The reception processor 266 demodulates and decodes the reception signal added and combined by the receiver 265 to obtain transmission data transmitted by the base station 401a.

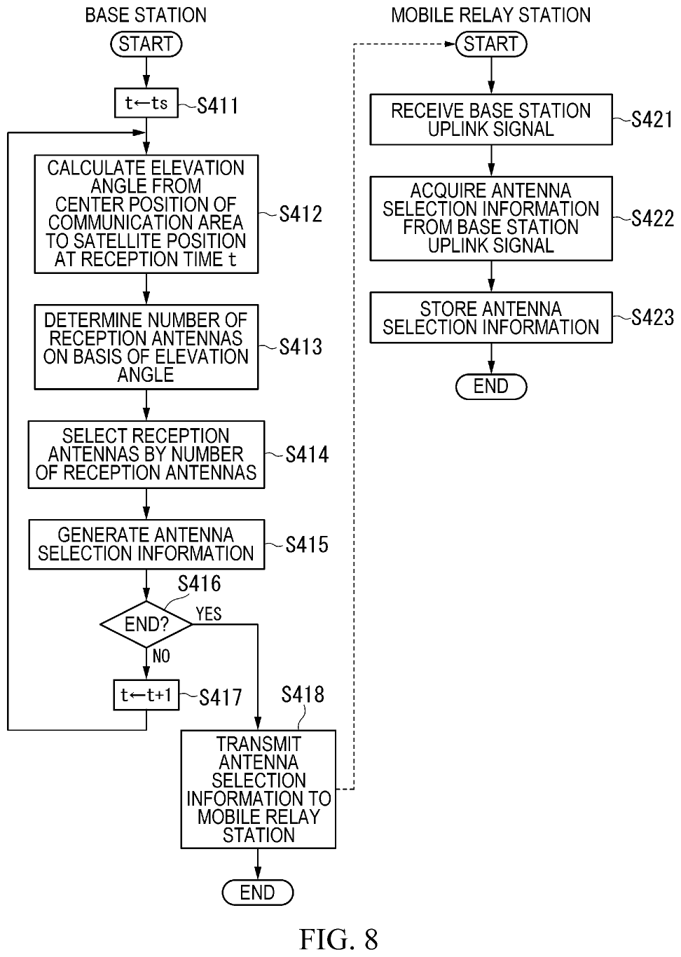

The wireless communication system 101a operates as in FIG. 3 for transmission and reception of the terminal uplink signal in which the terminal transmission data is set, and operates as in FIG. 5 for transmission and reception of the base station downlink signal in which the reception waveform information is set. Further, the wireless communication system 101a performs processing of FIG. 8 for each mobile relay station 201a in order to generate information used for transmission data control by each mobile relay station 201a.

FIG. 8 is a flowchart illustrating information generation processing by the wireless communication system 101a. The antenna number determiner 452 of the base station 401a sets the initial value ts to the reception time t (step S411). The initial value ts is a time later than the current time.

The antenna number determiner 452 refers to the orbit information and the communication area information stored in the storage 451, and performs processing similar to step S212 in FIG. 4. Thus, the antenna number determiner 452 calculates the elevation angle from the center position of the communication area at the reception time t to the position of the LEO satellite equipped with the mobile relay station 201a (step S412). The antenna number determiner 452 calculates the number of reception antennas based on the value of the elevation angle calculated in step S412 by processing similar to step S213 in FIG. 4 (step S413). The antenna selector 453 selects the antennas 210 by the number of reception antennas calculated in step S413 from the N antennas 210 of the mobile relay station 201a (step S414). The antenna selector 453 generates the antenna selection information in which the reception time t is associated with the antenna identification information of the antenna 210 selected in step S414 (step S415). The antenna identification information is information of the selected reception antenna.

The antenna number determiner 452 determines whether or not a predetermined end condition is satisfied (step S416). The end condition can be, for example, a case where the reception time t reaches a predetermined time, a case where a loop process from step S412 to step S417 is performed a predetermined number of times, or the like.

When determining that the end condition is not satisfied (step S416: NO), the antenna number determiner 452 adds 1 to the reception time t (step S417), and repeats the processing from step S412. When the antenna number determiner 452 determines that the end condition is satisfied (step S416: YES), the antenna selector 453 outputs the generated antenna selection information to the base station signal transmission processor 460.

The base station signal transmission processor 460 sets the antenna selection information input from the antenna selector 453 as transmission data. The base station signal transmission processor 460 converts the transmission data into a parallel signal and then modulates the parallel signal. The transmitter 470 weights the modulated parallel signal by a transmission weight to generate the base station uplink signal. The transmitter 470 outputs the generated base station uplink signal to the corresponding antenna station 410. The antenna station 410 wirelessly transmits the base station uplink signal (step S418).

Each antenna 270 of the mobile relay station 201a receives the base station uplink signal (step S421). The controller 262a reads the reception weight of each antenna 270 for each reception time from the storage 261a, and instructs the receiver 265 on the read reception weight. The receiver 265 multiplies the base station uplink signal received by each antenna 270 by the reception weight instructed from the controller 262a, and then adds and combines the signals. The reception processor 266 demodulates and decodes the reception signal added and combined by the receiver 265 to obtain the antenna selection information transmitted by the base station 401a (step S422). The reception processor 266 outputs the antenna selection information to the reception controller 244a. The reception controller 244a stores the antenna selection information in the storage 241a (step S423).

The transmission data controller 240a performs the transmission data control processing of FIG. 4 except for the following points. That is, instead of the processing of steps S212 to S214, the reception controller 244a performs processing of reading the antenna identification information of the selected reception antenna corresponding to the reception time t representing the current time from the antenna selection information stored in the storage 241a.

The transmission data controller 240a of the mobile relay station 201a illustrated in FIG. 6 may include the antenna selector 243, and the control information generator 450 of the base station 401a may not include the antenna selector 453. In this case, the base station 401a does not perform the processing of step S414 of FIG. 8, and in step S415, the antenna number determiner 452 generates antenna number information in which the reception time t and the number of reception antennas are associated with each other. Then, in step S418, the antenna number determiner 452 outputs the generated antenna number information to the base station signal transmission processor 460. Thus, the base station 401a wirelessly transmits the base station uplink signal in which the antenna number information is set.

In step S422, the base station communicator 260a of the mobile relay station 201a acquires the antenna number information from the base station uplink signal and outputs the antenna number information to the transmission data controller 240a. In step S423, the antenna selector 243 stores the antenna number information in the storage 241a. Then, the transmission data controller 240a performs the transmission data control processing of FIG. 4 except for the following points. That is, instead of the processing of steps S212 and S213, the transmission data controller 240a performs processing in which the antenna selector 243 reads information of the number of reception antennas corresponding to the reception time t representing the current time from the antenna number information stored in the storage 241a.

The mobile relay station 201 illustrated in FIG. 2 may include the base station communicator 260a illustrated in FIGS. 6 and 7 instead of the base station communicator 260. In this case, the base station 401 illustrated in FIG. 2 includes the base station signal transmission processor 460 and the transmitter 470 illustrated in FIG. 6. When the orbit information or the communication area information stored in the storage 241 of the mobile relay station 201 is updated, or when the relational expression or the relational data used in the antenna number determiner 242 is updated, the base station 401 may transmit the updated orbit information, communication area information, relational expression, or relational data to the mobile relay station 201. The mobile relay station 201 updates the stored orbit information, communication area information, relational expression, or relational data to the received orbit information, communication area information, relational expression, or relational data.

Further, in the present embodiment described above, the mobile relay station 201 and the base station 401, and the mobile relay station 201a and the base station 401a perform communication by MIMO, but the communication is not limited thereto. For example, the mobile relay stations 201 and 201a may communicate with the base station by one antenna 270. Similarly, the base stations 401 and 401a may transmit and receive signals to and from the mobile relay station using one antenna instead of the antenna station 410.

According to the first embodiment, when it is assumed that the elevation angle from the communication area is large and the communication quality of the uplink signal from the terminal station is good, the mobile relay station reduces the data amount of the waveform data to be transmitted to the base station. Therefore, the downlink band from the mobile relay station to the base station can be reduced. Furthermore, power consumption of the mobile relay station can be reduced.

### Second Embodiment

A wireless communication system of a second embodiment controls the number of reception antennas among the plurality of reception antennas of the mobile relay station according to the population density in the area where the mobile relay station communicates. The farther the LEO satellite is from a large city, the smaller the amount of interference from other on-ground IoT terminals or the like to be interference sources for on-ground IoT terminals communicating with mobile relay stations mounted on the LEO satellite. When the amount of interference is small, the required number of reception antennas is also small because the reception quality is good.

The arrangement distribution of the ground IoT terminals tends to be the same as the population distribution. That is, the area where the population concentrates tends to be more densely populated with the ground IoT terminals. Accordingly, the wireless communication system of the second embodiment determines the number of reception antennas on the basis of the data of the population density of the area where the mobile relay station collects data at each time, and transmits waveform data corresponding to the number of reception antennas from the mobile relay station to the base station. The fact that the arrangement distribution of the ground IoT terminals and the population distribution tend to be the same is described in the following reference documents, for example. In the reference document, an assumption that a terminal is used in proportion to population density is used in calculating the average number of simultaneous communication apparatuses for each area of LPWA.

(Reference Document) The Information and Communications Council, the Ministry of Internal Affairs and Communications, ““Technical condition related to advancement of 920 MHz band low power wireless system” in “technical condition necessary for advancement of low power wireless system””, pp. 40 to 44, January 2020

Further, there is a case where all the arrangement places of the ground IoT terminals are managed. In this case, instead of the information of the population density, information of installation density of the ground IoT terminals obtained from information of positions of the ground IoT terminals may be used. Here, a case where the population density is used will be described as an example. Further, the second embodiment will be described focusing on differences from the first embodiment.

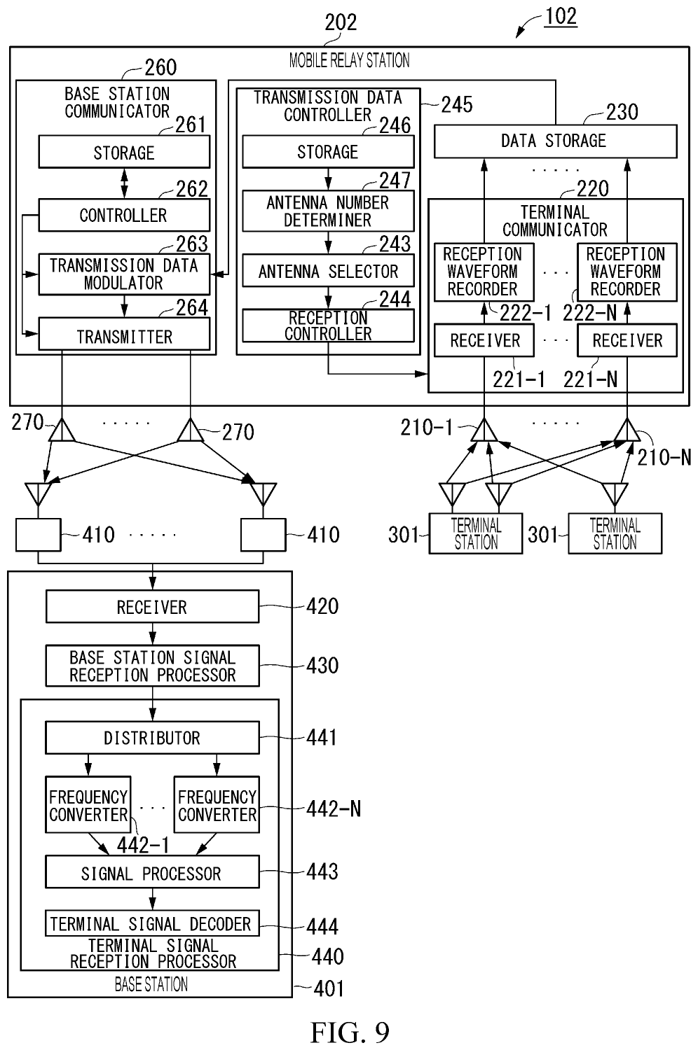

FIG. 9 is a configuration diagram of a wireless communication system 102 according to the second embodiment. In FIG. 9, the same components as those of the wireless communication system 101 according to the first embodiment illustrated in FIG. 2 are denoted by the same reference numerals, and the description thereof will be omitted. The wireless communication system 102 includes a mobile relay station 202, the terminal station 301, and the base station 401. The mobile relay station 202 is used as the mobile relay station 2 in FIG. 1.

The mobile relay station 202 is different from the mobile relay station 201 illustrated in FIG. 2 in that a transmission data controller 245 is provided instead of the transmission data controller 240. The transmission data controller 245 includes a storage 246, an antenna number determiner 247, the antenna selector 243, and the reception controller 244.

The storage 246 stores population density information. The population density information indicates the population density of the communication area at each time. The communication area is determined in advance on the basis of the orbit information of the LEO satellite equipped with the mobile relay station 202. The antenna number determiner 247 reads the value of the population density of the communication area at the reception time of the terminal uplink signal from the population density information stored in the storage 246. The antenna number determiner 247 calculates the number of reception antennas by substituting the acquired value of the population density as a parameter value into the relational expression for calculating the number of reception antennas using the population density as a parameter. This relational expression is predefined. Alternatively, relational data in which the range of the value of the population density is associated with the number of reception antennas may be stored in the storage 246. The antenna number determiner 247 reads the number of reception antennas corresponding to the value of the population density from the relational data.

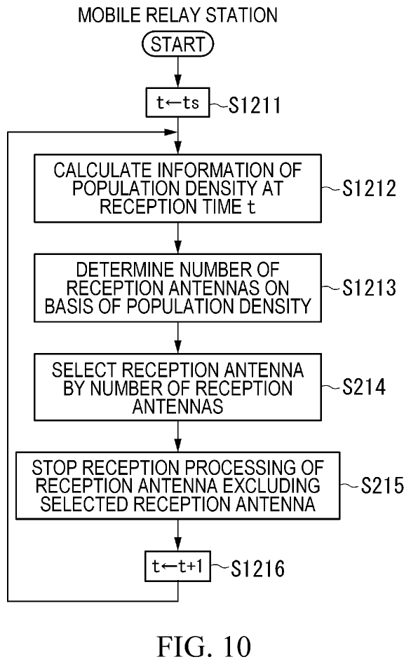

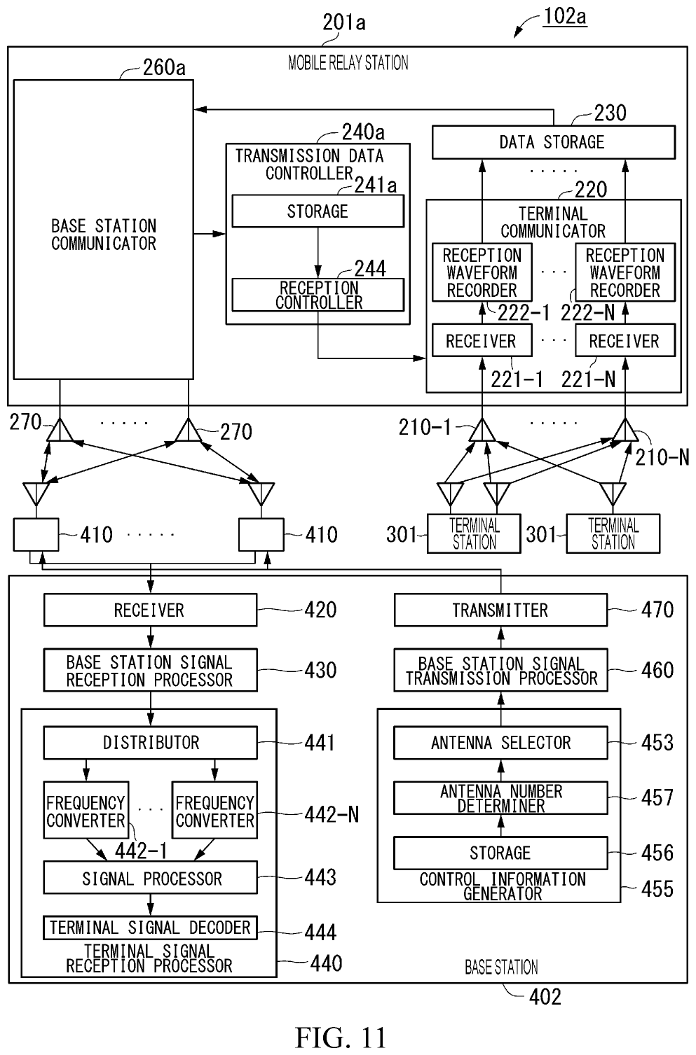

The wireless communication system 102 operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the mobile relay station 202 performs transmission data control processing illustrated in FIG. 10.

FIG. 10 is a flowchart illustrating transmission data control processing by the mobile relay station 202. In FIG. 10, the same processes as those of the transmission data control processing according to the first embodiment illustrated in FIG. 4 are denoted by the same reference numerals, and the description thereof will be omitted. The antenna number determiner 247 of the mobile relay station 202 sets the initial value is to the reception time t (step S1211). The reception time t represents a reception time of the terminal uplink signal in the mobile relay station 202. Here, the reception time t is represented by a count value of the unit time elapsed from the reference time. The initial value ts is the current time.

The antenna number determiner 247 acquires the value of the population density at the reception time t from the population density information stored in the storage 246 (step S1212). The antenna number determiner 247 calculates the number of reception antennas by substituting the value of the population density information acquired in step S1212 as a parameter value into the relational expression for calculating the number of reception antennas using the population density as the parameter (step S1213). The antenna selector 243 performs the processing of step S214 of FIG. 4, and the reception controller 244 performs the processing of step S215 of FIG. 4. The antenna number determiner 247 adds 1 to the reception time t (step S1216), and repeats the processing from step S1212.

In addition, the transmission data controller 245 may perform the processing illustrated in FIG. 10 using a time later than the current time as the reception time t. Thus, the transmission data controller 245 can determine the selected reception antenna in advance before receiving the terminal uplink signal. In this case, in step S1211, the antenna number determiner 247 uses a time later than the current time as the initial value ts. Then, in step S214, the antenna selector 243 further performs processing of storing the antenna selection information indicating the selected reception antenna at the reception time t in the storage 246. After step S214, the transmission data controller 245 proceeds to the processing of step S1216 without performing the processing of step S215. The reception controller 244 reads the information of the selected reception antenna corresponding to the current time from the antenna selection information stored in the storage 246. The reception controller 244 operates the receiver 221-n and the reception waveform recorder 222-n corresponding to the antenna 210-n indicated by the read selected reception antenna, and stops the operations of the receiver 221-n and the reception waveform recorder 222-n corresponding to the antenna 210-n other than the selected reception antennas.

In addition, as illustrated in FIG. 11, the base station may have some functions of the transmission data controller 245 included in the mobile relay station 202. FIG. 11 is a configuration diagram of the wireless communication system 102a. In FIG. 11, the same components as those of the wireless communication system 101a illustrated in FIG. 6 are denoted by the same reference numerals, and the description thereof will be omitted. The wireless communication system 102a includes the mobile relay station 201a, the terminal station 301, and a base station 402. The base station 402 is used as the base station 4 in FIG. 1.

The base station 402 illustrated in FIG. 11 is different from the base station 401a illustrated in FIG. 6 in that a control information generator 455 is provided instead of the control information generator 450. The control information generator 455 includes a storage 456, an antenna number determiner 457, and the antenna selector 453.

The storage 456 stores population density information for each mobile relay station 201a. The antenna number determiner 457 performs processing similar to that of the antenna number determiner 247 illustrated in FIG. 9 for each mobile relay station 201a. Thus, the antenna number determiner 457 calculates the number of reception antennas at each reception time for each mobile relay station 201a.

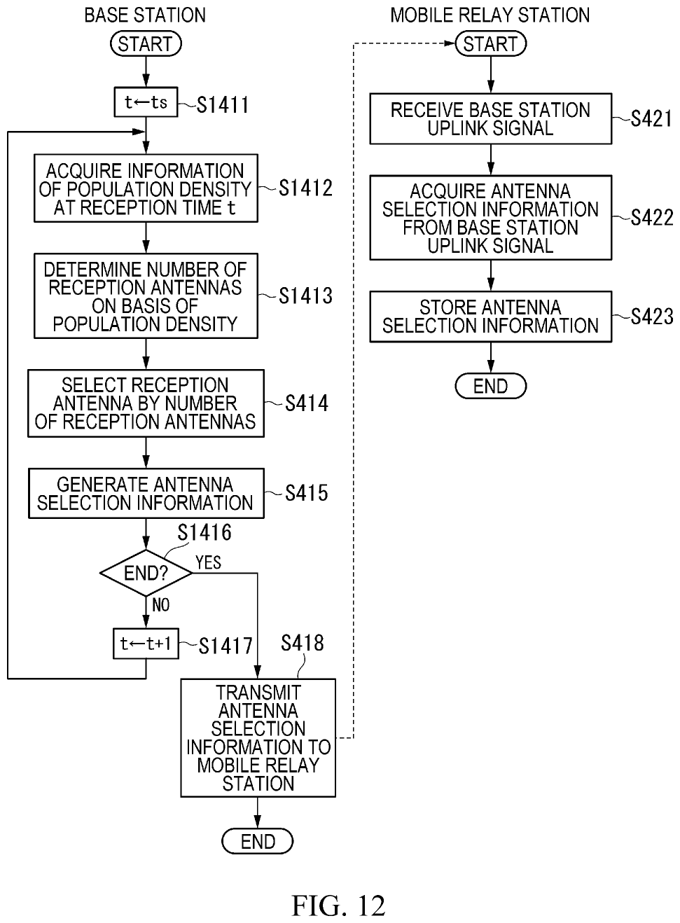

The wireless communication system 102a operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the wireless communication system 102a performs processing of FIG. 12 for each mobile relay station 201a in order to generate information used for transmission data control by each mobile relay station 201a. FIG. 12 is a flowchart illustrating information generation processing by the wireless communication system 102a. In FIG. 12, the same processes as those of the information generation processing according to the first embodiment illustrated in FIG. 8 are denoted by the same reference numerals, and the description thereof will be omitted.

The antenna number determiner 457 of the base station 402 sets the initial value ts to the reception time t (step S1411). The reception time ts is a time later than the current time. The antenna number determiner 457 acquires the value of the population density at the reception time t from the population density information stored in the storage 456 (step S1412). The antenna number determiner 457 calculates the number of reception antennas on the basis of the population density by processing similar to step S1213 in FIG. 10 (step S1413).

The antenna selector 453 performs the processing of step S414 and step S415 in FIG. 8. The antenna number determiner 457 determines whether or not a predetermined end condition is satisfied (step S1416). The end condition can be similar to that in step S416 in FIG. 8. When determining that the end condition is not satisfied (step S1416: NO), the antenna number determiner 457 adds 1 to the reception time t (step S1417), and repeats the processing from step S1412. When the antenna number determiner 457 determines that the end condition is satisfied (step S1416: YES), the base station 402 performs processing similar to step S418 in FIG. 8, and transmits the antenna selection information to the mobile relay station 201a. The mobile relay station 201a performs the processing of steps S421 to S423 of FIG. 8.

The transmission data controller 240a of the mobile relay station 201a illustrated in FIG. 11 may include the antenna selector 243, and the control information generator 455 of the base station 402 may not include the antenna selector 453. In this case, the base station 402 does not perform the processing of step S414 of FIG. 12, and in step S415, the antenna number determiner 457 generates the antenna number information in which the reception time t and the number of reception antennas are associated with each other. Then, in step S418, the antenna number determiner 457 outputs the generated antenna number information to the base station signal transmission processor 460. Thus, the base station 402 wirelessly transmits the base station uplink signal in which the antenna number information is set.

The mobile relay station 202 illustrated in FIG. 9 may include the base station communicator 260a illustrated in FIGS. 6 and 7 instead of the base station communicator 260, and the base station 401 illustrated in FIG. 9 may include the base station signal transmission processor 460 and the transmitter 470 illustrated in FIG. 6. When the population density information stored in the storage 246 of the mobile relay station 202 is updated or when the relational expression or the relational data used in the antenna number determiner 247 is updated, the base station 401 may transmit the updated population density information, relational expression, or relational data to the mobile relay station 202. The mobile relay station 202 updates the stored population density information, relational expression, or relational data to the received population density information, relational expression, or relational data.

The wireless communication systems 102 and 102a may use the density information of the ground IoT terminals instead of the population density information. The density of the terminal stations 301 can also be used as the density of the ground IoT terminals. Further, in the present embodiment described above, the mobile relay station 202 and the base station 401, and the mobile relay station 201a and the base station 402 perform communication by MIMO, but the communication is not limited thereto. For example, the mobile relay stations 202 and 201a may communicate with the base station by one antenna 270. Similarly, the base stations 401 and 402 may transmit and receive signals to and from the mobile relay station using one antenna instead of the antenna station 410.

According to the second embodiment, when it is assumed that the population density of the communication area is low and the communication quality of the uplink signal from the terminal station is good, the mobile relay station can reduce the data amount of the waveform data transmitted to the base station.

### Third Embodiment

A wireless communication system of a third embodiment determines the number of reception antennas necessary for each communication area on the basis of a past communication success rate in the same path. That is, the wireless communication system determines the required number of reception antennas on the basis of a decoding success rate of the terminal uplink signal received when the mobile relay station passed over each communication area in the past and the number of reception antennas at the time of performing decoding. The communication success rate such as the decoding success rate is an example of signal quality of the terminal uplink signal obtained when the base station performs the reception processing of the terminal uplink signal. A stage of collecting data for determining the required number of reception antennas and analyzing the collected data to determine the required number of antennas is referred to as an analysis phase, and a stage of performing communication with the required number of antennas determined in the analysis phase is referred to as a normal operation phase. The analysis phase continues for a time during which the mobile relay station passes through the same path a plurality of times. The third embodiment will be described focusing on differences from the first and second embodiments.

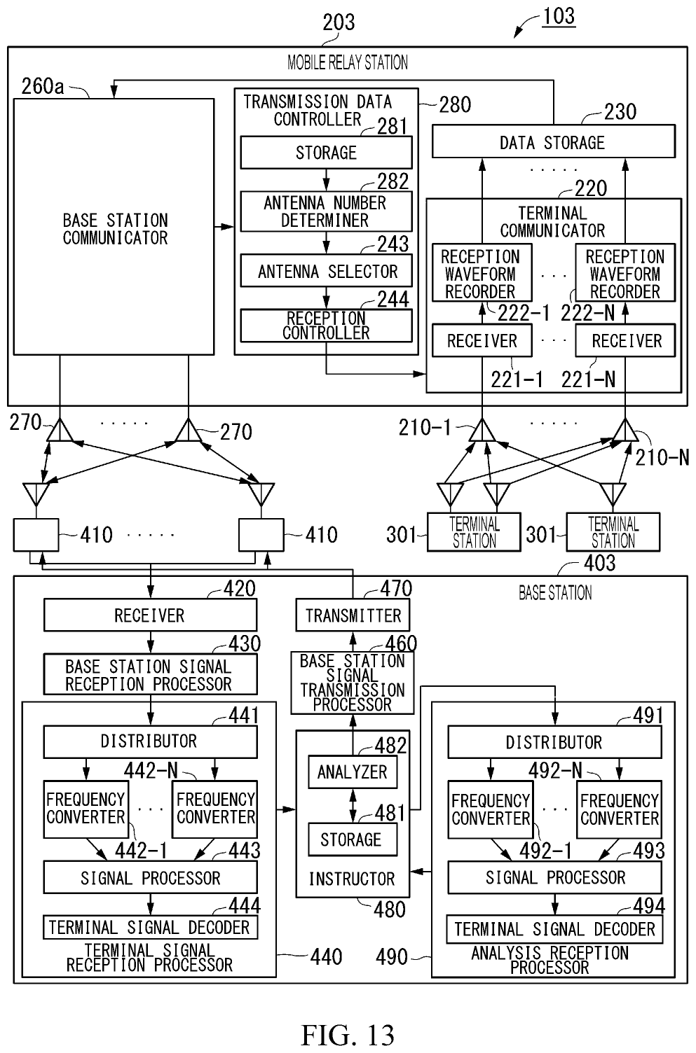

FIG. 13 is a configuration diagram of a wireless communication system 103 according to the third embodiment. In FIG. 13, the same components as those of the wireless communication system 101 according to the first embodiment illustrated in FIG. 2 and the wireless communication system 101a according to the first embodiment illustrated in FIG. 6 are denoted by the same reference numerals, and the description thereof will be omitted. The wireless communication system 103 includes a mobile relay station 203, the terminal station 301, and a base station 403. The mobile relay station 203 is used as the mobile relay station 2 in FIG. 1, and the base station 403 is used as the base station 4 in FIG. 1.

The mobile relay station 203 is different from the mobile relay station 201 illustrated in FIG. 2 in that a transmission data controller 280 is included instead of the transmission data controller 240 and the base station communicator 260a illustrated in FIGS. 6 and 7 is included instead of the base station communicator 260. The transmission data controller 280 includes a storage 281, an antenna number determiner 282, an antenna selector 243, and a reception controller 244.

The storage 281 stores communication area information and area-specific antenna number information. The area-specific antenna number information is information in which a communication area is associated with the number of reception antennas. The antenna number determiner 282 determines the number of reception antennas. In the analysis phase, the antenna number determiner 282 determines the number of reception antennas of a plurality of types for the same path at different timings. In the normal operation phase, the antenna number determiner 282 reads the communication area at each time from the communication area information stored in the storage 281, and reads information of the number of reception antennas corresponding to the communication area from the area-specific antenna number information stored in the storage 281. However, in the normal operation phase, the antenna number determiner 282 determines to use a larger number of reception antennas than the number of reception antennas indicated by the area-specific antenna number information each time the antenna passes through the same path a predetermined number of times. For example, the antenna number determiner 282 determines the number N of all the antennas 210 as the number of reception antennas. Further, the antenna number determiner 282 updates the area-specific antenna number information stored in the storage 281 with the communication area information transmitted from the base station 403. Further, the antenna number determiner 282 increases the number of reception antennas set in the area-specific antenna number information in accordance with an instruction from the base station 403.

The base station 403 illustrated in FIG. 13 is different from the base station 401 illustrated in FIG. 2 in further including the base station signal transmission processor 460 and the transmitter 470 illustrated in FIG. 6, an instructor 480, and an analysis reception processor 490. Note that an external apparatus connected to the base station 403 may include one or both of the instructor 480 and the analysis reception processor 490.

The instructor 480 includes a storage 481 and an analyzer 482. The storage 481 stores the communication area information of each mobile relay station 203. In the analysis phase, the analyzer 482 determines the required number of reception antennas in each communication area on the basis of the decoding success rate in the terminal signal reception processor 440 for each mobile relay station 203. The analyzer 482 generates the area-specific antenna number information in which the communication area is associated with the required number of reception antennas for each mobile relay station 203. The analyzer 482 notifies each mobile relay station 203 of the area-specific antenna number information generated for the mobile relay station. Further, in the normal operation phase, when the decoding success rate in the terminal signal reception processor 440 becomes lower than a predetermined value, the analyzer 482 instructs the mobile relay station 203 to increase the number of reception antennas. Further, the analyzer 482 analyzes the required number of reception antennas using the waveform data of all the antennas 210 periodically transmitted from the mobile relay station 203 in the normal operation phase. For this analysis, the analyzer 482 outputs waveform data corresponding to the number of reception antennas to the analysis reception processor 490 while changing the number of reception antennas, and causes the analysis reception processor 490 to execute reception processing to obtain the decoding success rate. The analyzer 482 determines the required number of reception antennas of the mobile relay station 203 on the basis of the relationship between the number of reception antennas and the decoding success rate.

The analysis reception processor 490 includes a distributor 491, N frequency convertors 492, a signal processor 493, and a terminal signal decoder 494. The N frequency convertors 492 are respectively referred to as frequency convertors 492-1 to 492-N. The distributor 491 receives the waveform data from the analyzer 482 and outputs each piece of the received waveform data to the different frequency convertors 492. The frequency convertors 492-1 to 492-N, the signal processor 493, and the terminal signal decoder 494 respectively have functions similar to those of the frequency convertors 442-1 to 442-N, the signal processor 443, and the terminal signal decoder 444, respectively. Note that the terminal signal reception processor 440 may also serve as the analysis reception processor 490.

The processing of the analysis phase will be described. In the analysis phase, the wireless communication system 103 performs transmission and reception of the terminal uplink signal in which the terminal transmission data is set by processing similar to that of the first embodiment illustrated in FIG. 3.

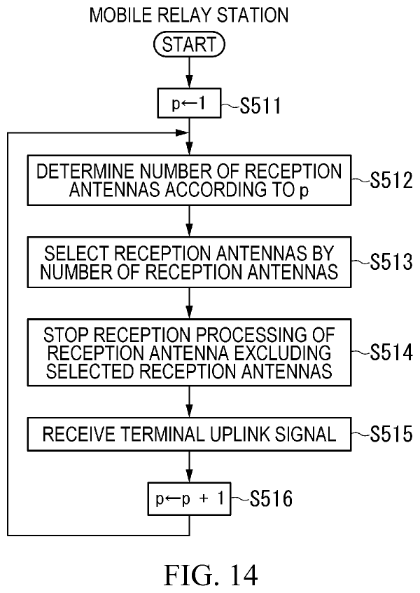

FIG. 14 is a flowchart illustrating transmission data control processing in the analysis phase of the mobile relay station 203. First, the antenna number determiner 282 of the mobile relay station 203 sets an initial value 1 to the number of times p of passing the same path (step S511). The antenna number determiner 282 determines the number of reception antennas according to the number of times p of passing the same path (step S512). For example, the antenna number determiner 282 determines the number of reception antennas of which the number of times determined in the past in the same path as the current path is less than the threshold. The threshold is an integer of 1 or more. The antenna number determiner 282 may change the number of reception antennas each time the mobile relay station passes through the same path, or may change the number of reception antennas each time the mobile relay station passes through the same path a predetermined plurality of times. The antenna selector 243 selects the antennas 210 by the number of reception antennas determined in step S512 from the N antennas 210 (step S513).

The reception controller 244 operates the receiver 221-n and the reception waveform recorder 222-n corresponding to the antenna 210-n of the selected reception antenna selected by the antenna selector 243 in step S514, and stops the operations of the receiver 221-n and the reception waveform recorder 222-n corresponding to the antenna 210-n other than the selected reception antennas (step S514). The terminal communicator 220 performs the processing of steps S121 and S122 of FIG. 3, and writes the reception waveform information of the selected reception antenna in the data storage 230 (step S515). The antenna number determiner 282 adds 1 to the number of times p of passing the same path (step S516). The mobile relay station 203 repeats the processing from step S512.

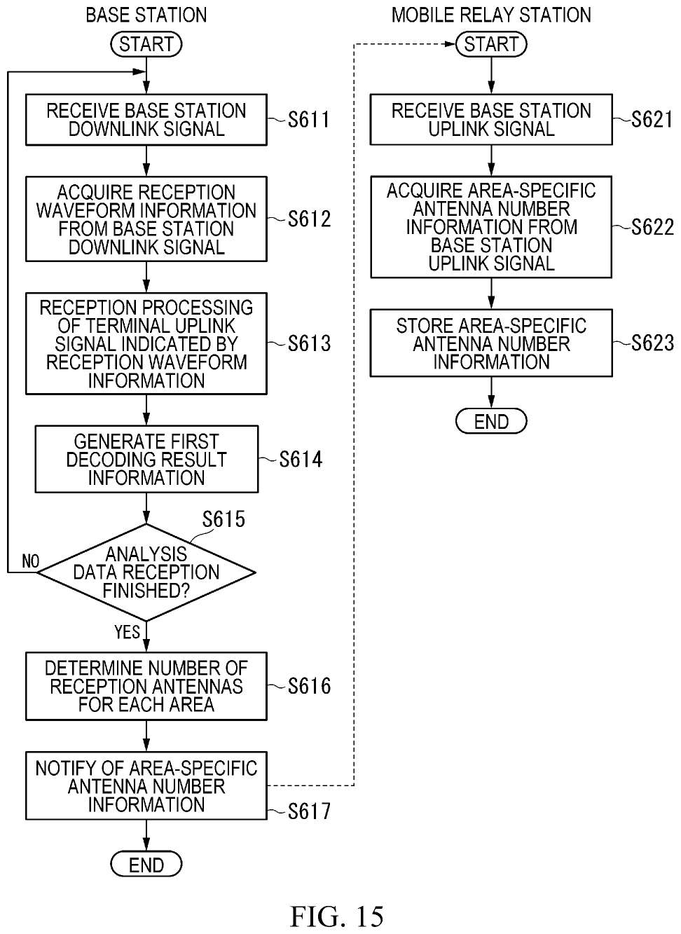

In the analysis phase, the mobile relay station 203 performs the processing illustrated in steps S311 to S313 of FIG. 5 and transmits the base station downlink signal in which the reception waveform information is set by MIMO. The wireless communication system 103 performs processing illustrated in FIG. 15 in the analysis phase.

FIG. 15 is a flowchart illustrating information generation processing of the wireless communication system 103 in the analysis phase. The base station 403 receives the base station downlink signal from the mobile relay station 203, and performs processing similar to steps S321 to S323 of FIG. 5 (steps S611 to S613).

The analyzer 482 acquires identification information of the mobile relay station 203 read from the base station downlink signal from the base station signal reception processor 430. Furthermore, the analyzer 482 receives, from the terminal signal reception processor 440, information of the reception time added to the reception waveform information obtained from the base station downlink signal, information of the number of reception antennas at the reception time, and information of the decoding success rate of the waveform data obtained from the reception waveform information at the reception time. For example, the information of the number of reception antennas is obtained as the number of pieces of reception waveform information to which the same reception time is added. The analyzer 482 reads information of the communication area corresponding to the reception time from the communication area information stored in the storage 481 in association with the identification information of the mobile relay station 203. The analyzer 482 generates first decoding result information in which the identification information of the mobile relay station 203, the information of the reception time, the information of the communication area, the information of the number of reception antennas, and the decoding success rate are associated with each other, and writes the generated first decoding result information in the storage 481 (step S614).

When reception of analysis data is not finished (step S615: NO), the base station 403 repeats the processing from step S611. When the reception of the analysis data is finished (step S615: YES), the base station 403 performs processing of step S616.

The analyzer 482 analyzes the relationship between the number of reception antennas and the decoding success rate for each communication area by using the first decoding result information generated in step S614, and determines the required number of reception antennas for each communication area (step S616). Specifically, it is assumed that, in a certain communication area, the average of the number of reception antennas for which the decoding success rate equal to or higher than a predetermined value is obtained is Na, and the maximum value is Nmax. The analyzer 482 may set the required number of reception antennas to Na or Nmax, a number obtained by adding a predetermined number to Na or Nmax, or a number obtained by increasing Na or Nmax by a predetermined ratio. The analyzer 482 generates the area-specific antenna number information in which the communication area is associated with the required number of reception antennas determined for the communication area.

The mobile relay station 203 communicates with the same communication area while moving. Therefore, the analyzer 482 determines the required number of reception antennas by using not only the result of the reception processing of the reception waveform information when the mobile relay station 203 is located at a specific position but also the result of the reception processing of the reception waveform information when the mobile relay station is located in the vicinity thereof. The result of the reception processing as to whether or not the decoding is successful indicates the communication quality between the mobile relay station 203 and the terminal station 301.

The analyzer 482 outputs the area-specific antenna number information of the mobile relay station 203 to the base station signal transmission processor 460. Thus, the base station 403 transmits the base station uplink signal in which the area-specific antenna number information is set to the mobile relay station 203 (step S617).

Each antenna 270 of the mobile relay station 203 receives the base station uplink signal (step S621). The base station communicator 260a performs reception processing similar to step S422 in FIG. 8 and acquires the area-specific antenna number information (step S622). The base station communicator 260a outputs the acquired area-specific antenna number information to the transmission data controller 280. The antenna number determiner 282 of the transmission data controller 280 writes the area-specific antenna number information in the storage 281 (step S623).

After the analysis phase, the wireless communication system 103 starts the normal operation phase. In the normal operation phase, the wireless communication system 103 transmits and receives the terminal uplink signal in which the terminal transmission data is set by processing similar to that of the first embodiment illustrated in FIG. 3.

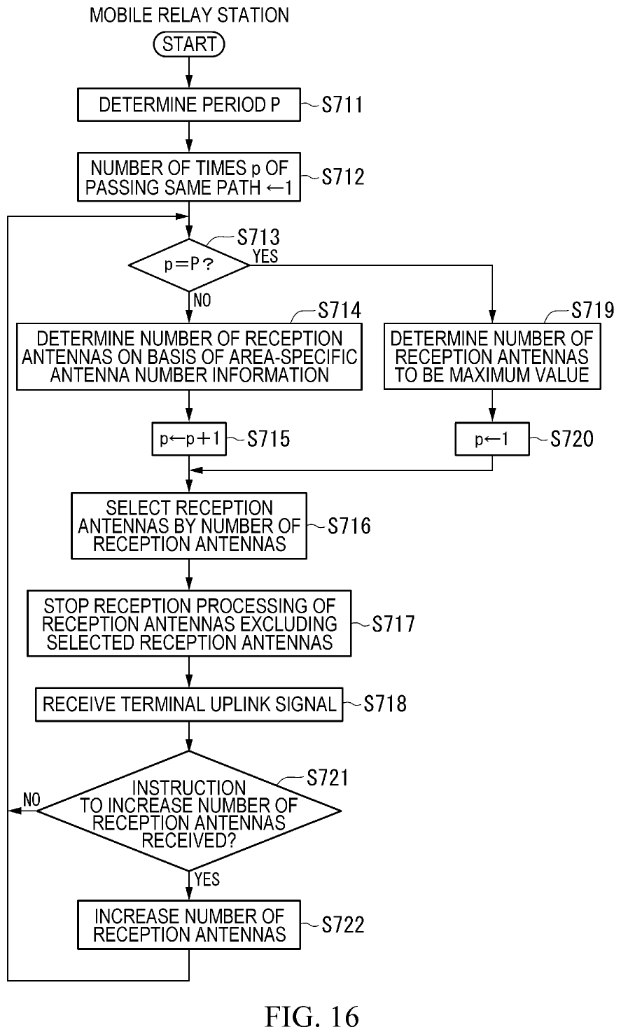

FIG. 16 is a flowchart illustrating transmission data control processing in the normal operation phase of the mobile relay station 203. The antenna number determiner 282 of the mobile relay station 203 determines a period P for updating the required number of reception antennas (step S711). The period P can be arbitrarily determined. The antenna number determiner 282 sets the initial value 1 to the number of times p of passing the same path (step S712).

When determining that the number of times p of passing the same path has not reached the period P (step S713: NO), the antenna number determiner 282 determines the number of reception antennas on the basis of the area-specific antenna number information (step S714). That is, the antenna number determiner 282 acquires the information of the communication area at the current time from the area information stored in storage 281. Furthermore, the antenna number determiner 282 reads the number of reception antennas in the read communication area from the area-specific antenna number information stored in the storage 281. The antenna number determiner 282 adds 1 to the number of times p of passing the same path (step S715).

The antenna selector 243 selects the antennas 210 by the number of reception antennas determined in step S714 from the N antennas 210 (step S716). The reception controller 244 operates the receiver 221-n and the reception waveform recorder 222-n corresponding to the antenna 210-n of the selected reception antenna selected by the antenna selector 243 in step S716, and stops the operations of the receiver 221-n and the reception waveform recorder 222-n corresponding to the antenna 210-n other than the selected reception antennas (step S717). The terminal communicator 220 performs the processing of steps S121 and S122 in FIG. 3 (step S718).

On the other hand, when determining that the number of times p of passing the same path has reached the period P (step S713: YES), the antenna number determiner 282 determines the number of reception antennas to be the maximum value (step S719). Here, the maximum value is set to the number N of all antennas 210. The antenna number determiner 282 sets the number of times p of passing the same path to 1 (step S720). The antenna selector 243 selects the antennas 210-1 to 210-N (step S716). The reception controller 244 operates the receivers 221-1 to 221-N and the reception waveform recorders 222-1 to 222-N (step S717). The terminal communicator 220 performs the processing of steps S121 and S122 in FIG. 3 (step S718).

When receiving an instruction to increase the number of reception antennas from the base station 403 (step S721: YES), the mobile relay station 203 increases the number of reception antennas stored in the area-specific antenna number information corresponding to the communication area set in the instruction to increase the number of reception antennas (step S722). When not receiving the instruction to increase the number of reception antennas from the base station 403 (step S721: NO), or after the processing of step S722, the mobile relay station 203 repeats the processing from step S713.

The mobile relay station 203 performs the processing of steps S311 to S313 of FIG. 5 in the normal operation phase, and transmits the base station downlink signal in which the reception waveform information is set to the base station 403.

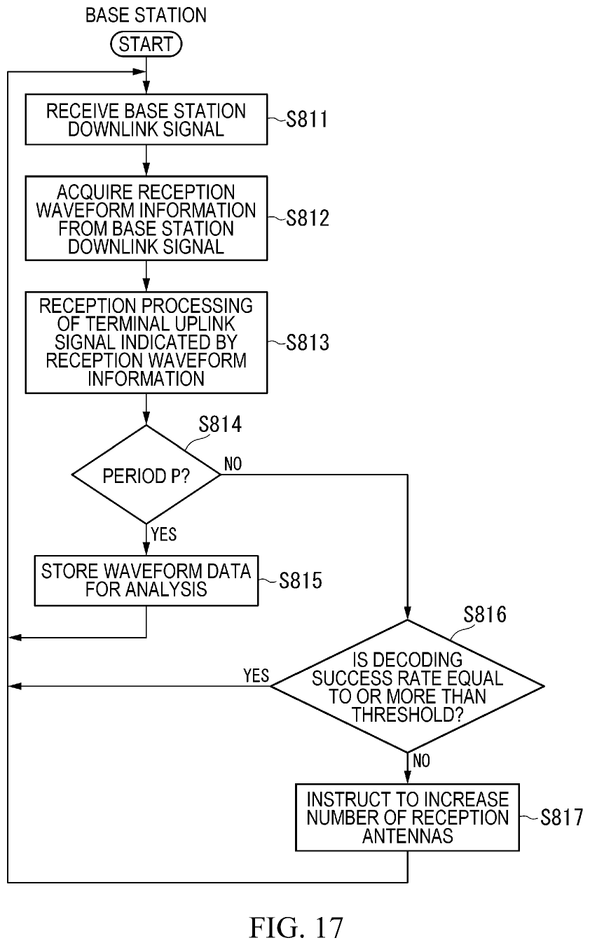

FIG. 17 is a flowchart illustrating base station downlink signal reception processing in the normal operation phase of the base station 403. The base station 403 receives the base station downlink signal from the mobile relay station 203, and performs processing similar to steps S611 to S613 of FIG. 15 (steps S811 to S813).

The analyzer 482 determines whether or not the current period is the period P (step S814). When determining that it is the period P (step S814: YES), the analyzer 482 writes the analysis waveform data in the storage 481 (step S815). The analyzer 482 may determine that the period is the period P when the number of reception antennas is the number N of all antennas 210. The analysis waveform data is information in which the identification information of the mobile relay station 203, the reception time added to the waveform data, the antenna identification information of each antenna 210, reception waveform data of each antenna 210, the quantization bit number, and the communication area are associated with each other. The analyzer 482 reads the identification information of the mobile relay station 203, the reception time, the antenna identification information of each antenna 210, the reception waveform data of each antenna 210, and the quantization bit number from the base station downlink signal. Further, the analyzer 482 reads the information of the communication area corresponding to the reception time from the communication area information of the mobile relay station 203. When the quantization bit number is fixed, the analysis waveform data may not include the quantization bit number. The base station 403 repeats the processing from step S811.

On the other hand, when determining that it is not the period P (step S814: NO), the analyzer 482 determines whether or not the decoding success rate is equal to or more than the threshold (step S816). When determining that the decoding success rate is equal to or more than the threshold (step S816: YES), the analyzer 482 repeats the processing from step S811.

When determining that the decoding success rate is less than the threshold (step S816: NO), the analyzer 482 reads, from the communication area information stored in the storage 481, the information of the communication area corresponding to the information of the reception time when the decoding success rate is obtained. The analyzer 482 outputs the instruction to increase the number of reception antennas in which the read communication area information is set to the base station signal transmission processor 460. The analyzer 482 increases the data amount of the waveform data generated by the mobile relay station 203 in accordance with a quantization bit number increase instruction. Thus, the base station 403 transmits the base station uplink signal in which the instruction to increase the number of reception antennas is set to the mobile relay station 203 (step S817), and repeats the processing from step S811.

The mobile relay station 203 receives the base station uplink signal transmitted in step S817 (step S721 in FIG. 16: YES). The base station communicator 260a of the mobile relay station 203 performs reception processing of the base station uplink signal and acquires the instruction to increase the number of reception antennas. The base station communicator 260a outputs the acquired instruction to increase the number of reception antennas to the transmission data controller 280. In step S722 of FIG. 16, the antenna number determiner 282 of the transmission data controller 280 increases the number of reception antennas stored in the area-specific antenna number information by a predetermined number or a predetermined ratio corresponding to the communication area set in the instruction to increase the number of reception antennas. The analyzer 482 of the base station 403 may set information of the number or the ratio for increasing the number of reception antennas in the instruction to increase the number of reception antennas. In addition, the analyzer 482 may transmit the instruction to increase the number of reception antennas when the number of times the decoding success rate has not reached the threshold for the same communication area reaches a predetermined number of times.

As described above, in order to accurately grasp the required number of antennas, the mobile relay station 203 periodically transmits the waveform data of all the reception antennas to the base station 403 once a month or the like even in the normal operation phase. The base station 403 or the analysis apparatus on the ground performs reception processing while changing the number of reception antennas of the waveform data to be used among the received waveform data of all the reception antennas, and analyzes the required number of antennas. In a case where analysis is performed once a month, the period P is the number of passing paths in one month.

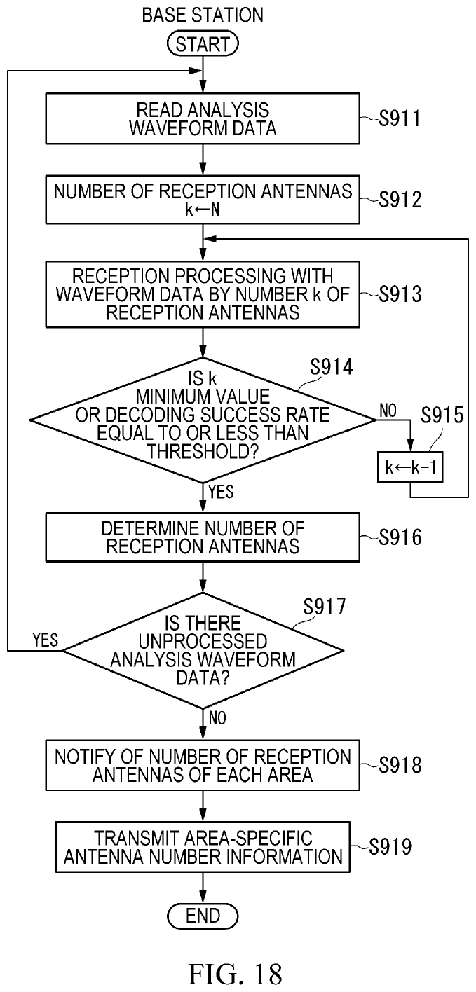

FIG. 18 is a flowchart illustrating analysis processing of the number of reception antennas by the base station 403. The base station 403 performs analysis processing of the number of reception antennas by using the decoding result in the period P. The base station 403 performs the processing of FIG. 18 for each mobile relay station 203. The analyzer 482 reads the analysis waveform data from the storage 481 (step S911). The analyzer 482 reads the waveform data of each reception antenna from the analysis waveform data. The analyzer 482 sets an initial value N to the number of reception antennas k (step S912).

The analyzer 482 selects the waveform data for the number of reception antennas k from the waveform data for the number of reception antennas N read from the analysis waveform data. The analyzer 482 outputs the selected waveform data and the information of the quantization bit number read from the analysis waveform data to the analysis reception processor 490. The analyzer 482 may add antenna identification information of the antenna 210 from which the waveform data is obtained to the selected waveform data. The analysis reception processor 490 executes reception processing using the waveform data and the quantization bit number input from the analyzer 482 (step S913). That is, the distributor 491 outputs each piece of the waveform data received from the analyzer 482 to the k different frequency convertors 492. In a case where the antenna identification information is added to the waveform data, the distributor 491 outputs the waveform data to which the antenna identification information of the antenna 210-n is added and the quantization bit number to the frequency convertor 492-n. Each of the frequency convertors 492 to which the waveform data has been input from the distributor 491 restores the signal waveform from the waveform data on the basis of the quantization bit number. The frequency convertor 442 frequency-converts the reception signal represented by the restored signal waveform from the RF signal into a baseband signal, and outputs the frequency-converted reception signal to the signal processor 493. To the signal processor 493, the reception signal of the baseband signal is input from each of the frequency convertors 492 to which the waveform data is input among the frequency convertors 492-1 to 492-N. The signal processor 493 performs frame detection (terminal signal detection), Doppler shift compensation, and offline beam control on each of the input reception signals to add and combine the signals, and outputs symbols of the added and combined reception signals to the terminal signal decoder 494. The terminal signal decoder 494 decodes the symbol input from the signal processor 493 to obtain the terminal transmission data. The terminal signal decoder 494 notifies the analyzer 482 of the decoding success rate.

The analyzer 482 determines whether or not at least one of a condition that the number of reception antennas k has reached a predetermined minimum value or a condition that the decoding success rate is equal to or less than a threshold is satisfied (step S914). When determining that none of the conditions is satisfied (step S914: NO), the analyzer 482 subtracts 1 from the value of the number of reception antennas k (step S915). The analyzer 482 repeats the processing from step S913.

When determining in step S914 that one or both of the condition that the number of reception antennas k has reached the predetermined minimum value and the condition that the decoding success rate is equal to or less than the threshold are satisfied (step S914: YES), the analyzer 482 determines the number of reception antennas for the analysis waveform data read in step S911 (step S916). For example, the analyzer 482 sets k+1 as the number of reception antennas when the decoding success rate is less than the threshold, and sets the current k as the number of reception antennas when the decoding success rate is equal to or more than the threshold. The analyzer 482 adds information of the determined number of reception antennas to the analysis waveform data.

The analyzer 482 determines whether or not there is unprocessed data in the analysis waveform data stored in the storage 481 (step S917). When determining that there is unprocessed analysis waveform data (step S917: YES), the analyzer 482 performs the processing from step S911. Then, when determining that there is no unprocessed analysis waveform data (step S917: NO), the analyzer 482 performs processing of step S918.

The analyzer 482 determines the number of reception antennas in the communication area on the basis of the number of reception antennas determined for the analysis waveform data for which the same communication area is set (step S918). For example, the analyzer 482 may determine an average, a maximum value, a number obtained by adding a predetermined number to the average, a number obtained by adding a predetermined number to the maximum value, a number obtained by increasing the average by a predetermined ratio, a number obtained by increasing the maximum value by a predetermined ratio, or the like of the number of reception antennas determined for the analysis waveform data for which the same communication area is set.

The analyzer 482 generates the area-specific antenna number information indicating the number of reception antennas determined for each communication area. The analyzer 482 outputs the area-specific antenna number information of the mobile relay station 203 to the base station signal transmission processor 460. Thus, the base station 403 transmits the base station uplink signal in which the area-specific antenna number information is set to the mobile relay station 203 (step S919).

The mobile relay station 203 performs the processing of steps S621 to S623 of FIG. 15. That is, the base station communicator 260a performs reception processing of the base station uplink signal and acquires the area-specific antenna number information. The antenna number determiner 282 of the transmission data controller 280 writes the area-specific antenna number information acquired by the base station communicator 260a into the storage 281.

According to the third embodiment, the wireless communication system can determine the number of reception antennas for each communication area of the mobile relay station on the basis of the past actual communication quality.

### Fourth Embodiment

In a fourth embodiment, before the mobile relay station transmits the waveform data by the base station downlink signal, a generation status of the ground IoT interference signal is analyzed from the waveform data acquired by the waveform sampling apparatus installed at multiple points on the ground to calculate the required number of reception antennas, and the mobile relay station is notified of the required number of reception antennas. The mobile relay station transmits the waveform data of the antenna by the notified required number of reception antennas by the base station downlink signal. The fourth embodiment will be described focusing on differences from the above-described embodiment.

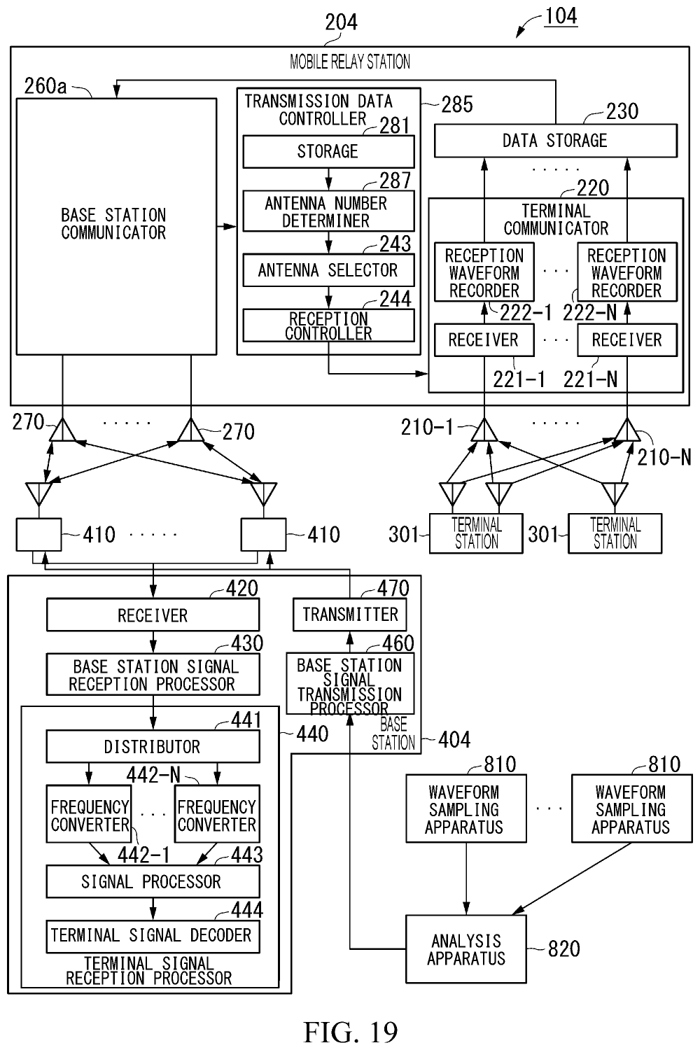

FIG. 19 is a configuration diagram of a wireless communication system 104 according to the fourth embodiment. In FIG. 19, the same components as those of the wireless communication system 101 according to the first embodiment illustrated in FIG. 2 and the wireless communication system 103 according to the third embodiment illustrated in FIG. 13 are denoted by the same reference numerals, and the description thereof will be omitted. The wireless communication system 104 includes a mobile relay station 204, the terminal station 301, a base station 404, a waveform sampling apparatus 810, and an analysis apparatus 820. The mobile relay station 204 is used as the mobile relay station 2 in FIG. 1, and the base station 404 is used as the base station 4 in FIG. 1.

The mobile relay station 204 is different from the mobile relay station 203 illustrated in FIG. 13 in that a transmission data controller 285 is provided instead of the transmission data controller 280. The transmission data controller 285 is different from the transmission data controller 280 in that an antenna number determiner 287 is provided instead of the antenna number determiner 282. The antenna number determiner 287 reads the communication area at each time from the communication area information stored in the storage 281, and reads information of the number of reception antennas corresponding to the communication area from the area-specific antenna number information stored in the storage 281.

The base station 404 includes the receiver 420, the base station signal reception processor 430, the terminal signal reception processor 440, the base station signal transmission processor 460, and the transmitter 470. The plurality of waveform sampling apparatuses 810 is set at multiple points on the ground. The waveform sampling apparatus 810 receives a radio of a band used for the terminal uplink signal, and notifies the analysis apparatus 820 of a sampling result of the received radio.

The analysis apparatus 820 detects interference generated in the communication area on the basis of the waveform data received from the waveform sampling apparatus 810 installed in the communication area of the mobile relay station 204 or around the communication area. The analysis apparatus 820 stores in advance a calculation formula or relational data indicating the relationship between the intensity of interference and the number of reception antennas. The analysis apparatus 820 determines the number of reception antennas on the basis of the detected interference and the stored calculation formula or relational data. The analysis apparatus 820 notifies the base station 404 of antenna number information in which the communication area and the number of reception antennas determined for the communication area are set. The base station 404 transmits the base station uplink signal in which the antenna number information received from the analysis apparatus 820 is set to the mobile relay station 204.

The mobile relay station 204 performs the processing of steps S621 to S622 of FIG. 15. That is, the base station communicator 260a performs reception processing of the base station uplink signal and acquires the antenna number information. The antenna number determiner 287 updates the area-specific antenna number information stored in the storage 281 on the basis of the antenna number information acquired from the base station uplink signal by the base station communicator 260a.

The wireless communication system 104 operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the mobile relay station 204 performs transmission data control processing similar to that in FIG. 4 of the first embodiment except for the following points. That is, in the mobile relay station 204, the antenna number determiner 287 performs processing of determining the number of reception antennas by processing similar to step S714 of FIG. 16 instead of the processes of steps S212 and S213. Specifically, the antenna number determiner 287 acquires the information of the communication area at the current time from the area information stored in storage 281. Furthermore, the antenna number determiner 287 reads the number of reception antennas in the read communication area from the area-specific antenna number information stored in the storage 281.

According to the fourth embodiment, the required number of reception antennas of the mobile relay station can be determined on the basis of an actual observation result on the ground.

### Fifth Embodiment

In a fifth embodiment, in the wireless communication system, the mobile relay station performs arrival direction estimation processing, and controls the transmission data amount to the ground, that is, the number of reception antennas, on the basis of a rough estimation result of the number and direction of incoming signals. The fifth embodiment will be described focusing on differences from the above-described embodiment.

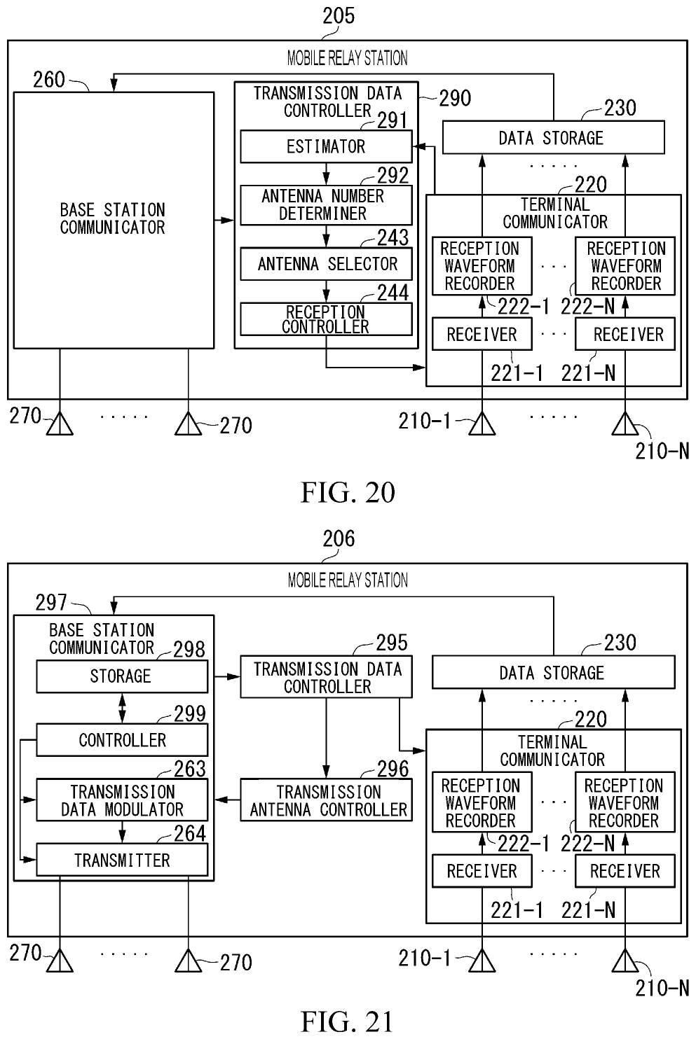

FIG. 20 is a configuration diagram of the mobile relay station 205 of the fifth embodiment. In FIG. 20, the same components as those of the mobile relay station 201 according to the first embodiment illustrated in FIG. 2 are denoted by the same reference numerals, and the description thereof will be omitted. The mobile relay station 205 is used as the mobile relay station 2 in FIG. 1.

The mobile relay station 205 is different from the mobile relay station 201 illustrated in FIG. 2 in that a transmission data controller 290 is provided instead of the transmission data controller 240. The transmission data controller 290 includes an estimator 291, an antenna number determiner 292, the antenna selector 243, and the reception controller 244.

The estimator 291 estimates an arrival direction of a signal and the number of terminals that have transmitted the signal on the basis of the terminal uplink signal received by each of the receivers 221-1 to 221-N. Any existing technology is used for estimation. The antenna number determiner 292 determines the number of reception antennas on the basis of an estimation result by the estimator 291. The antenna number determiner 292 determines the number of reception antennas by substituting the estimation result into a calculation formula for calculating the number of reception antennas using the signal arrival direction and the number of terminals as parameters. The calculation formula is predefined. As the number of terminals increases, the reception quality in the mobile relay station 205 decreases, and thus the number of reception antennas increases. In addition, the larger the elevation angle represented by the arrival direction, the better the reception quality in the mobile relay station 205, and thus the smaller the number of reception antennas may be.

The wireless communication system of the fifth embodiment operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the mobile relay station 205 of the fifth embodiment performs transmission data control processing similar to that of FIG. 4 of the first embodiment except for the following points. That is, the mobile relay station 205 performs the following processing instead of the processing of steps S212 and S213. The estimator 291 estimates an arrival direction of a signal and the number of terminals that have transmitted the signal on the basis of the terminal uplink signal received by each of the receivers 221-1 to 221-N. The antenna number determiner 292 determines the number of reception antennas on the basis of an estimation result by the estimator 291.

According to the fifth embodiment, the number of reception antennas can be controlled on the basis of the reception state estimated in the mobile relay station.

### Sixth Embodiment

In a sixth embodiment, the number of transmission antennas used by a mobile relay station to transmit the base station downlink signal in which the reception waveform information is set is controlled.

FIG. 21 is a diagram illustrating a mobile relay station 206 of the sixth embodiment. The mobile relay station 206 includes antennas 210-1 to 210-N, the terminal communicator 220, the data storage 230, a transmission data controller 295, a transmission antenna controller 296, a base station communicator 297, and the M antennas 270.

The transmission data controller 295 is the transmission data controllers 240, 240a, 245, 280, 285, and 290 of the first to fifth embodiments described above. The transmission antenna controller 296 determines the number of transmission antennas corresponding to the number of reception antennas determined by the transmission data controller 295. The base station communicator 297 is the base station communicator 260 or the base station communicator 260a. The base station communicator 297 includes a storage 298, a controller 299, the transmission data modulator 263, and the transmitter 264. The storage 298 and the controller 299 correspond to the storage 261 and the controller 262, or correspond to the storage 261a and the controller 262a.

The antenna number determiner 242, 247, 282, 287, and 292 of the transmission data controllers 240, 240a, 245, 280, 285, and 290, respectively, used as the transmission data controller 295 determine the number of transmission antennas at the reception time t in addition to the number of reception antennas at the reception time t. The antenna number determiners 242, 247, 282, 287, and 292 may determine the number of transmission antennas by processing as in a case of determining the number of reception antennas in the above-described embodiment. Alternatively, the antenna number determiners 242, 247, 282, 287, and 292 may determine the number of transmission antennas corresponding to the number of reception antennas at each reception time t on the basis of a correspondence between the number of reception antennas and the number of transmission antennas determined in advance.

The antenna selector 243 of each of the transmission data controllers 240, 240a, 245, 280, 285, and 290 used as the transmission data controller 295 selects the antennas 270 by the number of transmission antennas determined by the antenna number determiners 242, 247, 282, 287, and 292 from the M antennas 270. For example, the antenna selector 243 performs this selection by processing similar to that in a case of selecting the antennas 210 by the number of reception antennas. The selected antenna 270 is referred to as a selected transmission antenna. The transmission antenna controller 296 notifies the base station communicator 297 of the number m of transmission antennas (m is an integer of M or less) and the selected transmission antenna at the reception time t.

The transmission data modulator 263 reads the reception waveform information at the reception time t from the data storage 230 as transmission data. The transmission data modulator 263 converts the transmission data into parallel signals to be transmitted by the m selected transmission antennas. The transmission data modulator 263 modulates the generated parallel signal. Thus, the base station downlink signal to be transmitted by each of the m selected transmission antennas is generated.

The transmitter 264 includes a power amplifier corresponding to each antenna 270. When transmitting the base station downlink signal generated by the transmission data modulator 263 from each of the m selected transmission antennas, the transmission antenna controller 296 supplies power to the power amplifier corresponding to the selected transmission antenna and turns off power supply to the power amplifier corresponding to the antenna 270 other than the selected transmission antenna. Thus, the base station downlink signal is transmitted from the selected transmission antenna.

Note that, in a case where the transmitter 264 multiplies the base station downlink signal transmitted by each antenna 270 by a weight, an appropriate weight varies depending on the number of transmission antennas. Accordingly, information in which the number of transmission antennas is associated with the transmission weight for each time of each selected transmission antenna is stored in advance in the storage 298. When transmitting the base station downlink signal from each selected transmission antenna of the number m of transmission antennas, the controller 299 reads the transmission time and the transmission weight of each selected transmission antenna corresponding to the number of transmission antennas m from the storage 298. The controller 299 instructs the transmitter 264 to weight each parallel signal modulated by the transmission data modulator 263 with the transmission weight of the selected transmission antenna that transmits the parallel signal. The transmitter 264 weights the parallel signal generated by the transmission data modulator 263 by the weight instructed from the controller 299, and generates the base station downlink signal transmitted from each selected transmission antenna.

In addition, when the mobile relay station 206 communicates with the base station 401a illustrated in FIG. 6 or the base station 402 illustrated in FIG. 11, the antenna number determiner 452 of the base station 401a or the antenna number determiner 457 of the base station 402 may determine the number of transmission antennas at each reception time t by processing similar to that in a case of determining the number of reception antennas. Alternatively, the antenna number determiner 452 or the antenna number determiner 457 may determine the number of transmission antennas corresponding to the number of reception antennas at each reception time t on the basis of a correspondence between the number of reception antennas and the number of transmission antennas determined in advance. The antenna selector 453 selects transmission antennas by the number of transmission antennas from the M antennas 270 by processing similar to that in a case of selecting the antennas 210 by the number of reception antennas. The antenna selector 453 further sets the antenna identification information of the selected transmission antenna at the reception time t in the antenna selection information to be transmitted to the mobile relay station. Alternatively, the antenna number determiners 452 and 457 further set the number of transmission antennas at each reception time t in the antenna number information to be transmitted to the mobile relay station 206. When the base station communicator 297 transmits the reception waveform information at the reception time t by the base station downlink signal, the transmission antenna controller 296 reads the number of transmission antennas at the reception time t from the antenna number information or reads the selected transmission antenna at the reception time t from the antenna selection information. When reading the number of transmission antennas, the transmission antenna controller 296 determines a selected transmission antenna for the number of transmission antennas. The transmission antenna controller 296 notifies the base station communicator 297 of the number of transmission antennas and the selected transmission antenna at the reception time t.

In addition, when the mobile relay station 206 communicates with the base station 403 illustrated in FIG. 13, the analyzer 482 of the base station 403 may set the information of the number of transmission antennas determined according to the number of reception antennas as the area-specific antenna number information. In addition, when the mobile relay station 206 communicates with the base station 404 illustrated in FIG. 19, the analysis apparatus 820 of the base station 404 may set the information of the number of transmission antennas determined according to the number of reception antennas as the antenna number information. When the base station communicator 297 transmits the reception waveform information at the reception time t by the base station downlink signal, the transmission antenna controller 296 reads the number of transmission antennas corresponding to the communication area at the reception time t from the area-specific antenna number information. The transmission antenna controller 296 determines a selected transmission antenna of the read number of transmission antennas. The transmission antenna controller 296 notifies the base station communicator 297 of the number of transmission antennas and the selected transmission antenna at the reception time t.

According to the sixth embodiment, since the power supply of the MIMO transmission system that is unnecessary when the mobile relay station transmits the base station downlink signal is turned off, the power consumption can be further suppressed.

### Seventh Embodiment

A wireless communication system of a seventh embodiment determines the quantization bit number according to the elevation angle with respect to the mobile relay station from a predetermined position in the area on the earth, which is a communication destination of the mobile relay station. The predetermined position is, for example, the center of the area. The seventh embodiment is described by focusing on differences from the first embodiment.

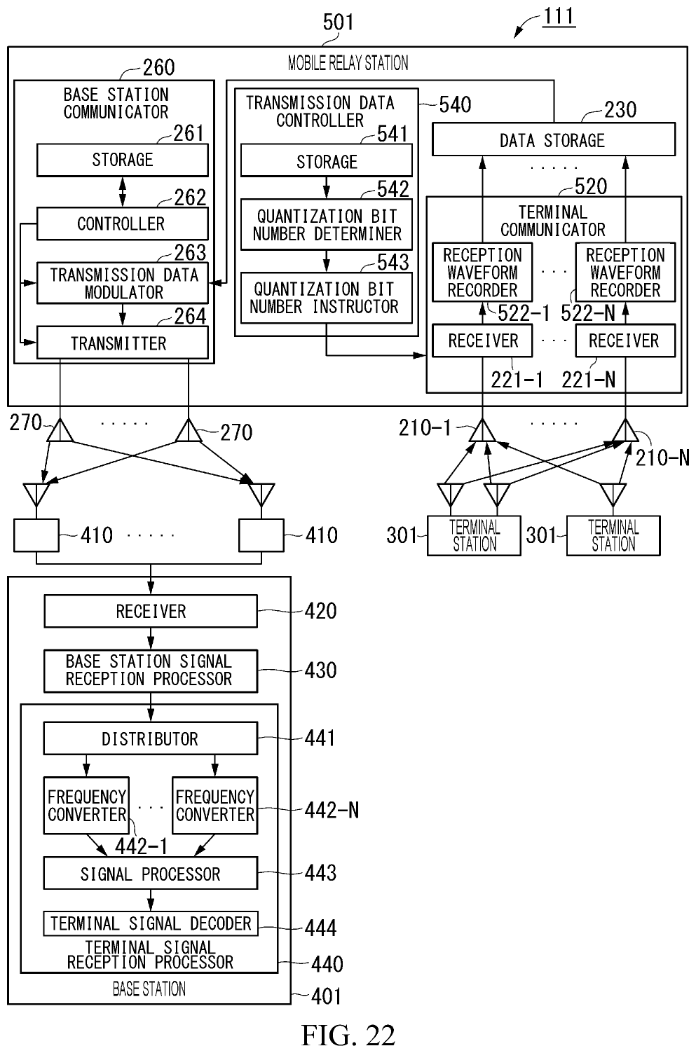

FIG. 22 is a configuration diagram of a wireless communication system 111 according to the seventh embodiment. In FIG. 22, the same parts as those of the wireless communication system 101 according to the first embodiment illustrated in FIG. 2 are denoted by the same reference numerals, and the description thereof will be omitted. The wireless communication system 111 includes a mobile relay station 501, the terminal station 301, and the base station 401. The mobile relay station 501 is used as the mobile relay station 2 in FIG. 1.

The mobile relay station 501 is different from the mobile relay station 201 illustrated in FIG. 2 in that a terminal communicator 520 and a transmission data controller 540 are provided instead of the terminal communicator 220 and the transmission data controller 240.

The terminal communicator 520 includes the N receivers 221 and N reception waveform recorders 522 (N is an integer of 1 or more). The N reception waveform recorders 522 are referred to as reception waveform recorders 522-1 to 522-N. The reception waveform recorder 522-n performs processing similar to that of the reception waveform recorder 222-n illustrated in FIG. 2. However, the reception waveform recorder 522-n samples the reception waveform of the terminal uplink signal received by the receiver 221-n as an RF signal as it is by the quantization bit number instructed from the transmission data controller 540, and generates waveform data indicating a value obtained by the sampling. The reception waveform recorder 522-n writes the reception waveform information in which the antenna identification information of the antenna 210-n, the reception time of the terminal uplink signal at the antenna 210-n, the generated waveform data, and the quantization bit number used for generating the waveform data are set to the data storage 230.

The transmission data controller 540 includes a storage 541, a quantization bit number determiner 542, and a quantization bit number instructor 543. The storage 541 stores orbit information and communication area information as does the storage 241 of the first embodiment. The quantization bit number determiner 542 calculates the elevation angle from the center position of the communication area to the LEO satellite using the position of the LEO satellite and the information of the position of the communication area at each time. The quantization bit number determiner 542 acquires the position of the LEO satellite at each time on the basis of the orbit information stored in the storage 541. Further, the quantization bit number determiner 542 also acquires information on the position of the communication area at each time from the area information stored in the storage 541. The quantization bit number determiner 542 calculates the quantization bit number by substituting the calculated value of the elevation angle as a parameter value into a relational expression for calculating the quantization bit number using the elevation angle as a parameter. This relational expression is predefined. Alternatively, relational data in which the range of the elevation angle is associated with the quantization bit number may be stored in the storage 541, and the quantization bit number determiner 542 may read the quantization bit number corresponding to the calculated value of the elevation angle from the relational data. As the elevation angle is closer to 90 degrees, the quantization bit number is smaller.

The quantization bit number instructor 543 instructs the reception waveform recorder 522 of the terminal communicator 520 to sample waveform data according to the quantization bit number determined by the quantization bit number determiner 542.

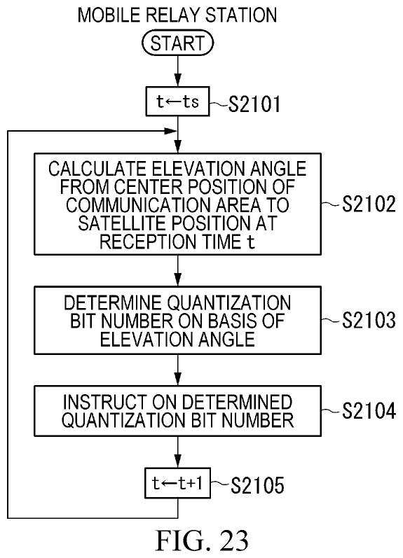

The wireless communication system 111 operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. However, in step S122 of FIG. 3, all the reception waveform recorders 522-n sample the terminal uplink signal received by the receiver 221-n by the quantization bit number instructed from the quantization bit number instructor 543, and generate waveform data. The same applies to the following embodiments. The reception waveform recorder 522-n writes the reception waveform information in which the generated waveform data, the reception time, the antenna identification information of the antenna 210-n, and the quantization bit number are associated with each other in the data storage 230. Further, the mobile relay station 501 performs transmission data control processing illustrated in FIG. 23 in order to control the quantization bit number.

FIG. 23 is a flowchart illustrating transmission data control processing by the mobile relay station 501. The quantization bit number determiner 542 of the mobile relay station 501 sets the initial value ts to the reception time t (step S2101). The reception time t represents a reception time of the terminal uplink signal in the mobile relay station 501. The reception time t is represented by a count value of the unit time elapsed from the reference time. The initial value ts is the current time.

The quantization bit number determiner 542 acquires the position of the LEO satellite at the reception time t on the basis of the orbit information stored in the storage 541. Furthermore, the quantization bit number determiner 542 acquires information on the position of the communication area at the reception time t from the communication area information stored in the storage 541. The quantization bit number determiner 542 calculates the elevation angle from the center position of the communication area to the position at the reception time t of the LEO satellite equipped with the mobile relay station 501 (step S2102).

The quantization bit number determiner 542 calculates the quantization bit number by substituting the value of the elevation angle calculated in step S2102 as a parameter value into the relational expression for calculating the quantization bit number using the elevation angle as a parameter (step S2103). The quantization bit number instructor 543 instructs the reception waveform recorder 522 on the quantization bit number calculated by the quantization bit number determiner 542 in step S2103 (step S2104). Accordingly, in step S122 of FIG. 3, the reception waveform recorder 522 of the mobile relay station 501 samples the terminal uplink signal by the quantization bit number instructed by the quantization bit number instructor 543 to generate waveform data. The quantization bit number determiner 542 adds 1 to the reception time t (step S2105) and repeats the processing from step S2102.

The transmission data controller 540 may perform the processing illustrated in FIG. 23 using a time later than the current time as the reception time t. Thus, the transmission data controller 540 can determine the quantization bit number in advance before receiving the terminal uplink signal. In this case, in step S2101, the quantization bit number determiner 542 uses a time later than the current time as the initial value ts. Then, in step S2103, the quantization bit number determiner 542 further performs processing of storing quantization bit number control information indicating the quantization bit number at the reception time t in the storage 541. After step S2103, the transmission data controller 540 proceeds to the processing of step S2105 without performing the processing of step S2104. The quantization bit number instructor 543 reads the information of the quantization bit number corresponding to the current time from the quantization bit number control information stored in the storage 541. The quantization bit number instructor 543 instructs the reception waveform recorder 522 on the read quantization bit number.

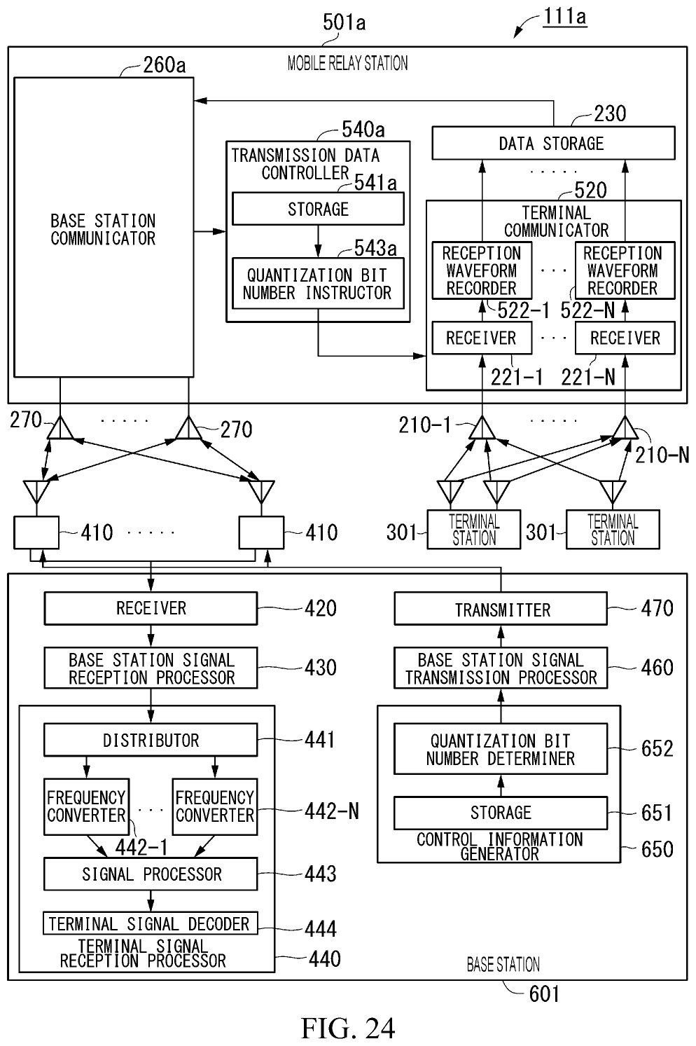

Note that, as illustrated in FIG. 24, the base station may have some of the functions of the transmission data controller 540 included in the mobile relay station 501. FIG. 24 is a configuration diagram of a wireless communication system 111a. In FIG. 24, the same components as those of the wireless communication system 111 illustrated in FIG. 22 are denoted by the same reference numerals, and the description thereof will be omitted. The wireless communication system 111a includes a mobile relay station 501a, the terminal station 301, and a base station 601. The mobile relay station 501a is used as the mobile relay station 2 in FIG. 1, and the base station 601 is used as the base station 4 in FIG. 1.

The mobile relay station 501a illustrated in FIG. 24 is different from the mobile relay station 501 illustrated in FIG. 22 in that a transmission data controller 540a is included instead of the transmission data controller 540, and the base station communicator 260a illustrated in FIGS. 6 and 7 is included instead of the base station communicator 260.

The transmission data controller 540a includes a storage 541a and a quantization bit number instructor 543a. The storage 541a stores the quantization bit number control information. The quantization bit number control information is information indicating the quantization bit number at each reception time. The quantization bit number instructor 543a reads the information of the quantization bit number corresponding to the current time from the quantization bit number control information stored in the storage 541a. The quantization bit number instructor 543a instructs the reception waveform recorder 522 to sample waveform data according to the read quantization bit number.

The base station 601 illustrated in FIG. 24 is different from the base station 401 illustrated in FIG. 22 in further including a control information generator 650, and the base station signal transmission processor 460 and the transmitter 470 illustrated in FIG. 6. Note that an external apparatus connected to the base station 601 may include the control information generator 650.

The control information generator 650 generates the quantization bit number control information of each mobile relay station 501a. The control information generator 650 includes a storage 651 and a quantization bit number determiner 652.

The storage 651 stores, for each mobile relay station 501a, the orbit information and the communication area information of the LEO satellite on which the mobile relay station 501a is mounted. The quantization bit number determiner 652 performs processing similar to that of the quantization bit number determiner 542 illustrated in FIG. 22 for each mobile relay station 501a. Thus, the quantization bit number determiner 652 calculates the quantization bit number at each reception time for each mobile relay station 501a. The quantization bit number determiner 652 generates the quantization bit number control information indicating the quantization bit number at each reception time for each mobile relay station 501a.

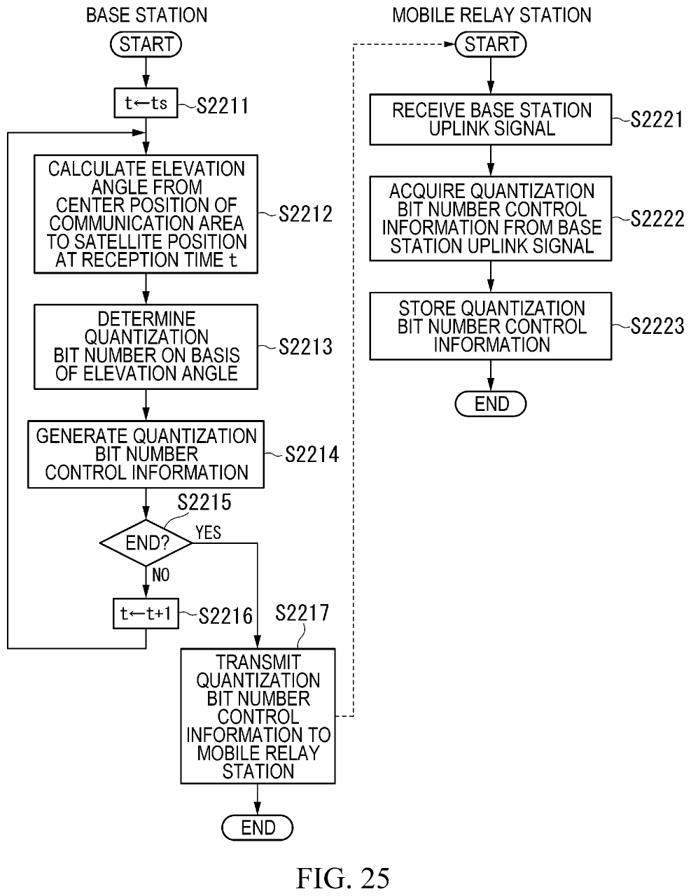

The wireless communication system 111a operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the wireless communication system 111a performs processing of FIG. 25 for each mobile relay station 501a in order to generate information used for transmission data control by each mobile relay station 501a.

FIG. 25 is a flowchart illustrating information generation processing by the wireless communication system 111a. The quantization bit number determiner 652 of the base station 601 sets the initial value ts to the reception time t (step S2211). The initial value ts is a time later than the current time.

The quantization bit number determiner 652 refers to the orbit information and the communication area information stored in the storage 651 and performs processing similar to step S2102 in FIG. 23. Thus, the quantization bit number determiner 652 calculates the elevation angle from the center position of the communication area at the reception time t to the position of the LEO satellite equipped with the mobile relay station 501a (step S2212). The quantization bit number determiner 652 refers to the orbit information and the communication area information stored in the storage 651, and calculates the quantization bit number based on the value of the elevation angle calculated in step S2212 by processing similar to step S2103 in FIG. 22 (step S2213). The quantization bit number determiner 652 generates the quantization bit number control information in which the reception time t is associated with the quantization bit number calculated in step S2213 (step S2214).

The quantization bit number determiner 652 determines whether or not a predetermined end condition is satisfied (step S2215). The end condition can be, for example, a case where the reception time t reaches a predetermined time, a case where a loop process from step S2212 to step S2216 is performed a predetermined number of times, or the like.

When determining that the end condition is not satisfied (step S2215: NO), the quantization bit number determiner 652 adds 1 to the reception time t (step S2216) and repeats the processing from step S2212. When determining that the end condition is satisfied (step S2215: YES), the quantization bit number determiner 652 outputs the generated quantization bit number control information to the base station signal transmission processor 460. The base station signal transmission processor 460 outputs the base station uplink signal in which the quantization bit number control information input from the antenna selector 453 is set as transmission data to the antenna station 410. The antenna station 410 wirelessly transmits the base station uplink signal (step S2217).

Each antenna 270 of the mobile relay station 501a receives the base station uplink signal (step S2221). The base station communicator 260a of the mobile relay station 501a performs processing similar to step S422 of FIG. 8 to obtain the quantization bit number control information transmitted by the base station 601 (step S2222). The reception processor 266 outputs the quantization bit number control information to the quantization bit number instructor 543a. The quantization bit number instructor 543a stores the quantization bit number control information in the storage 541a (step S2223).

The transmission data controller 540a performs the transmission data control processing in FIG. 23 except for the following points. That is, instead of the processing of steps S2102 and S2103, the quantization bit number instructor 543a performs processing of reading the information of the quantization bit number corresponding to the reception time t representing the current time from the quantization bit number control information stored in the storage 541a.

The mobile relay station 501 illustrated in FIG. 22 may include the base station communicator 260a illustrated in FIGS. 6 and 7 instead of the base station communicator 260. In this case, the base station 401 illustrated in FIG. 22 includes the base station signal transmission processor 460 and the transmitter 470 illustrated in FIG. 6. When the orbit information or the communication area information stored in the storage 541 of the mobile relay station 501 is updated, or when the relational expression or the relational data used in the quantization bit number determiner 542 is updated, the base station 401 may transmit the updated orbit information, communication area information, relational expression or relational data to the mobile relay station 501. The mobile relay station 501 updates the stored orbit information, communication area information, relational expression, or relational data to the received orbit information, communication area information, relational expression, or relational data.

Further, in the present embodiment described above, the mobile relay station 501 and the base station 401, and the mobile relay station 501a and the base station 601 perform communication by MIMO, but the communication is not limited thereto. For example, the mobile relay stations 501 and 501a may communicate with the base station by one antenna 270. Similarly, the base stations 401 and 601 may transmit and receive signals to and from the mobile relay station using one antenna instead of the antenna station 410.

According to the seventh embodiment, when it is assumed that the elevation angle of the mobile relay station from the communication area is large and the communication quality of the uplink signal from the terminal station is good, the quantization bit number is reduced. Thus, the data amount of the waveform data can be reduced. Therefore, the downlink band from the mobile relay station to the base station can be reduced. Furthermore, power consumption of the mobile relay station can be reduced.

### Eighth Embodiment

A wireless communication system of an eighth embodiment controls the quantization bit number according to the population density in the area in which the mobile relay station communicates. Note that, instead of the information of the population density, information of installation density of the ground IoT terminals obtained from information of positions of the ground IoT terminals may be used. Here, a case where the population density is used will be described as an example. Further, the eighth embodiment is described by focusing on differences from the seventh embodiment.

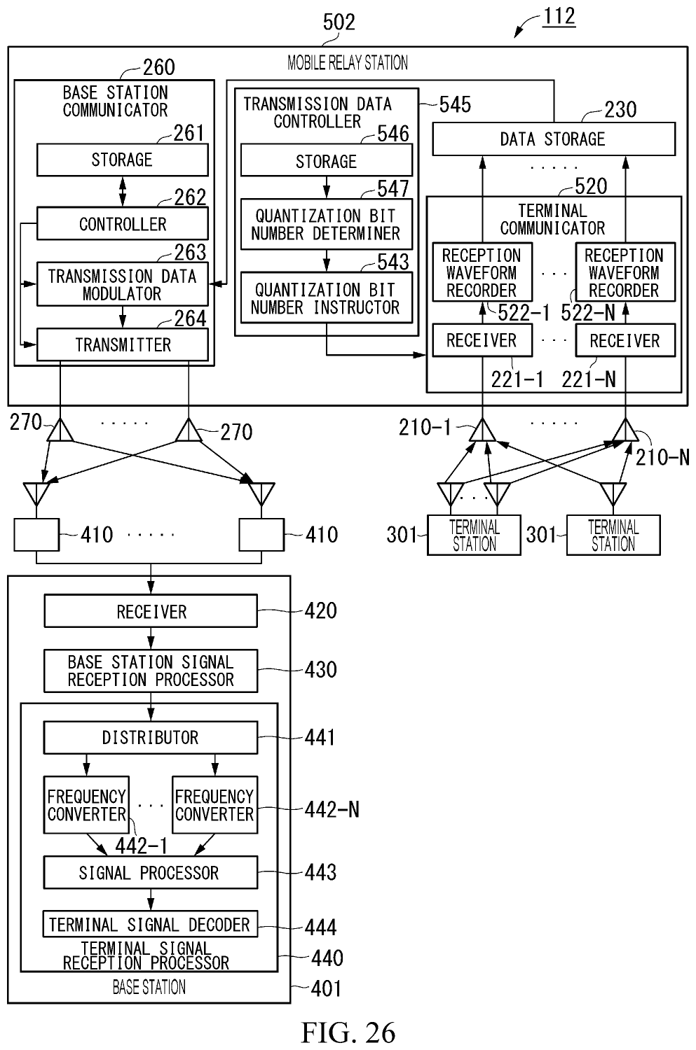

FIG. 26 is a configuration diagram of a wireless communication system 112 according to the eighth embodiment. In FIG. 26, the same parts as those of the wireless communication system 111 according to the seventh embodiment illustrated in FIG. 22 are denoted by the same reference numerals, and the description thereof will be omitted. The wireless communication system 112 includes a mobile relay station 502, the terminal station 301, and the base station 401. The mobile relay station 502 is used as the mobile relay station 2 in FIG. 1.

The mobile relay station 502 is different from the mobile relay station 501 illustrated in FIG. 22 in that a transmission data controller 545 is provided instead of the transmission data controller 540. The transmission data controller 545 includes a storage 546, a quantization bit number determiner 547, and the quantization bit number instructor 543.

The storage 546 stores population density information as does the storage 246 of the second embodiment. The quantization bit number determiner 547 reads the value of the population density of the communication area at the reception time of the terminal uplink signal from the population density information stored in the storage 546. The quantization bit number determiner 547 calculates the quantization bit number by substituting the acquired value of the population density as a parameter value into a relational expression for calculating the quantization bit number using the population density as a parameter. This relational expression is predefined. Alternatively, relational data in which the range of the value of the population density is associated with the quantization bit number may be stored in the storage 546. The quantization bit number determiner 547 reads the quantization bit number corresponding to the value of the population density from the relational data.

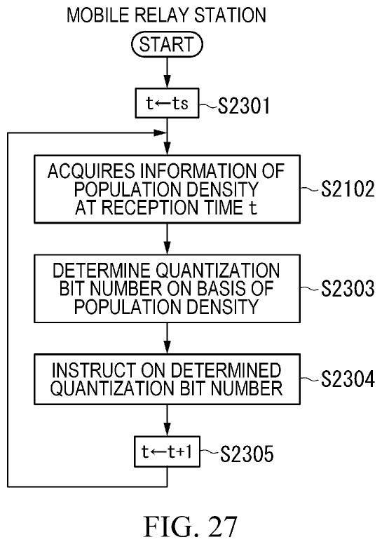

The wireless communication system 112 operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the mobile relay station 502 performs transmission data control processing illustrated in FIG. 27.

FIG. 27 is a flowchart illustrating transmission data control processing by the mobile relay station 502. The quantization bit number determiner 547 of the mobile relay station 502 sets the initial value ts to the reception time t (step S2301). The reception time t represents a reception time of the terminal uplink signal in the mobile relay station 502. The reception time t is represented by a count value of the unit time elapsed from the reference time. The initial value ts is the current time.

The quantization bit number determiner 547 acquires the value of the population density at the reception time t from the population density information stored in the storage 546 (step S2302). The quantization bit number determiner 547 calculates the quantization bit number by substituting the value of the population density information acquired in step S2302 as a parameter value into a relational expression for calculating the quantization bit number using the population density as a parameter (step S2303). The quantization bit number instructor 543 instructs the reception waveform recorder 522 on the quantization bit number calculated by the quantization bit number determiner 547 in step S2303 (step S2304). The quantization bit number determiner 547 adds 1 to the reception time t (step S2305) and repeats the processing from step S2302.

Note that the transmission data controller 545 may perform the processing illustrated in FIG. 27 using a time later than the current time as the reception time t. Thus, the transmission data controller 545 can determine the quantization bit number in advance before receiving the terminal uplink signal. In this case, in step S2301, the quantization bit number determiner 547 uses a time later than the current time as the initial value ts. Then, in step S2303, the quantization bit number determiner 547 further performs processing of storing the quantization bit number control information indicating the quantization bit number at the reception time t in the storage 546. After step S2303, the transmission data controller 545 proceeds to the processing of step S2305 without performing the processing of step S2304. The quantization bit number instructor 543 reads the information of the quantization bit number corresponding to the current time from the quantization bit number control information stored in the storage 546. The quantization bit number instructor 543 instructs the reception waveform recorder 522 on the read quantization bit number.

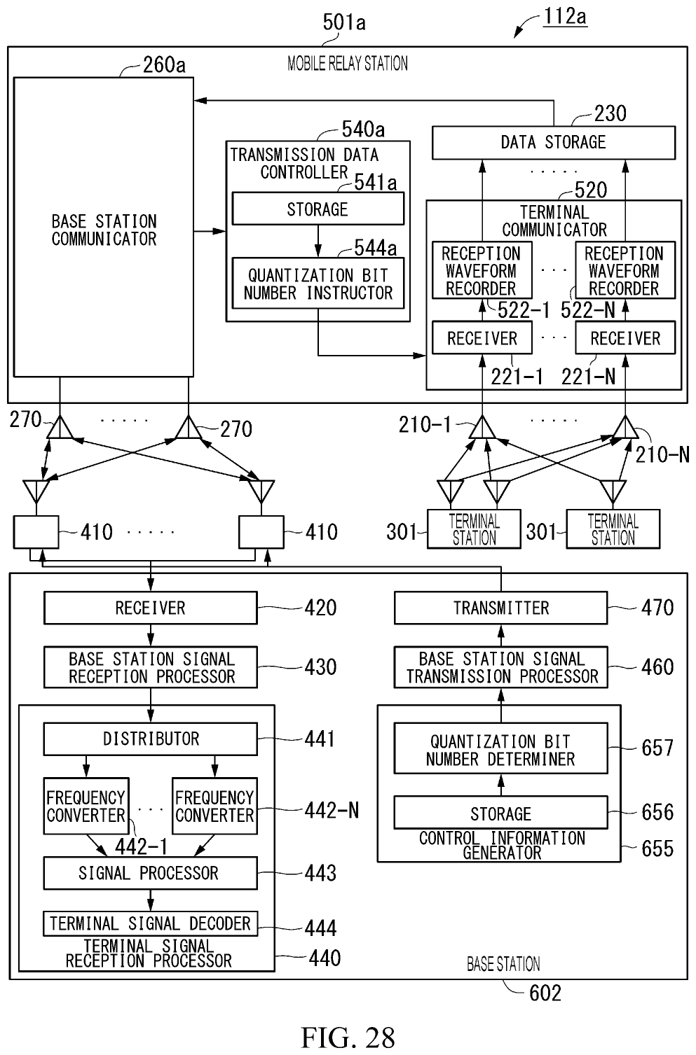

In addition, as illustrated in FIG. 28, the base station may have some functions of the transmission data controller 545 included in the mobile relay station 502. FIG. 28 is a configuration diagram of the wireless communication system 112a. In FIG. 28, the same components as those of the wireless communication system 111a illustrated in FIG. 24 are denoted by the same reference numerals, and the description thereof will be omitted. The wireless communication system 112a includes the mobile relay station 501a, the terminal station 301, and a base station 602. The base station 602 is used as the base station 4 in FIG. 1.

The base station 602 illustrated in FIG. 28 is different from the base station 601 illustrated in FIG. 24 in that a control information generator 655 is provided instead of the control information generator 650. The control information generator 655 includes a storage 656 and a quantization bit number determiner 657.

The storage 656 stores population density information for each mobile relay station 501a. The quantization bit number determiner 657 performs processing similar to that of the quantization bit number determiner 547 illustrated in FIG. 26 for each mobile relay station 501a. Thus, the quantization bit number determiner 657 calculates the quantization bit number at each reception time for each mobile relay station 501a.

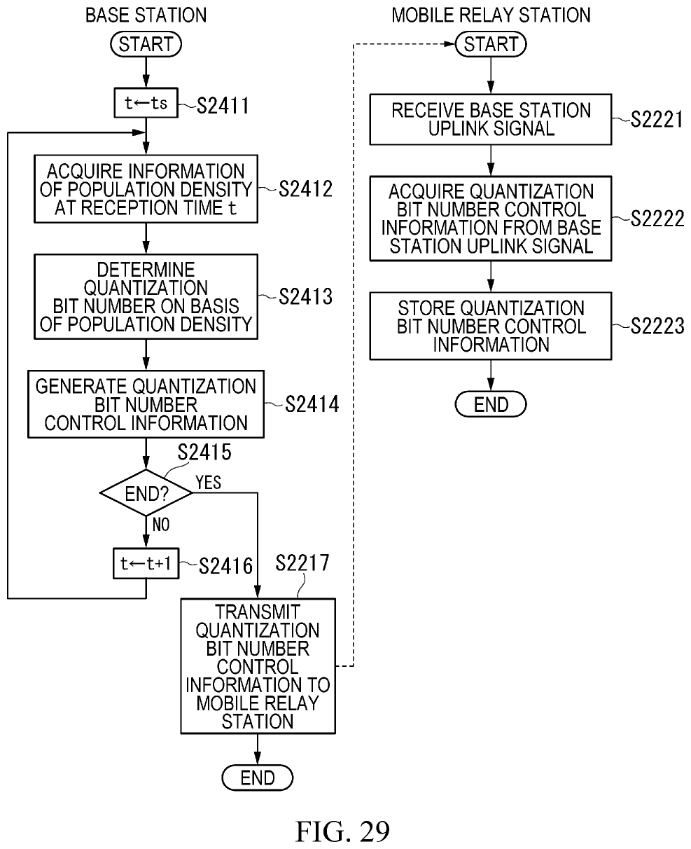

The wireless communication system 112a operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the wireless communication system 112a performs processing of FIG. 29 for each mobile relay station 501a in order to generate information used for transmission data control by each mobile relay station 501a. FIG. 29 is a flowchart illustrating information generation processing by the wireless communication system 112a. In FIG. 29, the same processes as those of the information generation processing according to the seventh embodiment illustrated in FIG. 25 are denoted by the same reference numerals, and the description thereof will be omitted.

The quantization bit number determiner 657 of the base station 602 sets the initial value ts to the reception time t (step S2411). The reception time ts is a time later than the current time. The quantization bit number determiner 657 acquires the value of the population density at the reception time t from the population density information stored in the storage 656 (step S2412). The quantization bit number determiner 657 calculates the quantization bit number on the basis of the population density by processing similar to step S2303 in FIG. 27 (step S2413). The quantization bit number determiner 657 generates quantization bit number control information in which the reception time t is associated with the quantization bit number calculated in step S2413 (step S2414).

The quantization bit number determiner 657 determines whether or not a predetermined end condition is satisfied (step S2415). The end condition can be similar to that in step S2215 in FIG. 25. When determining that the end condition is not satisfied (step S2415: NO), the quantization bit number determiner 657 adds 1 to the reception time t (step S2416) and repeats the processing from step S2412. When determining that the end condition is satisfied (step S2415: YES), the quantization bit number determiner 657 outputs the generated quantization bit number control information to the base station signal transmission processor 460. The base station 602 performs processing similar to step S2217 in FIG. 25, and transmits the quantization bit number control information to the mobile relay station 501a. The mobile relay station 501a performs the processing of steps S2221 to S2223 in FIG. 25.

The mobile relay station 502 illustrated in FIG. 26 may include the base station communicator 260a illustrated in FIGS. 6 and 7 instead of the base station communicator 260, and the base station 401 illustrated in FIG. 26 may include the base station signal transmission processor 460 and the transmitter 470 illustrated in FIG. 6. When the population density information stored in the storage 546 of the mobile relay station 502 is updated or when the relational expression or the relational data used in the quantization bit number determiner 547 is updated, the base station 401 may transmit the updated population density information, relational expression, or relational data to the mobile relay station 502. The mobile relay station 502 updates the stored population density information, relational expression, or relational data to the received population density information, relational expression, or relational data.

The wireless communication systems 112 and 112a may use the density information of the ground IoT terminals instead of the population density information. The density of the terminal stations 301 can also be used as the density of the ground IoT terminals. Further, in the present embodiment described above, the mobile relay station 502 and the base station 401, and the mobile relay station 501a and the base station 602 perform communication by MIMO, but the communication is not limited thereto. For example, the mobile relay stations 502 and 501a may communicate with the base station by one antenna 270. Similarly, the base stations 401 and 602 may transmit and receive signals to and from the mobile relay station using one antenna instead of the antenna station 410.

According to the eighth embodiment, in a case where it is assumed that the population density of the communication area is low and the communication quality of the uplink signal from the terminal station is good, the mobile relay station can reduce the data amount of the waveform data transmitted to the base station by reducing the quantization bit number.

### Ninth Embodiment

A wireless communication system of a ninth embodiment determines a required quantization bit number for each communication area on the basis of the past communication success rate in the same path. That is, the wireless communication system determines the required quantization bit number on the basis of the decoding success rate of the terminal uplink signal received when the mobile relay station passed over each communication area in the past and the quantization bit number when decoding is performed. A stage of collecting data for determining the required quantization bit number and analyzing the collected data to determine the required quantization bit number is referred to as an analysis phase, and a stage of performing communication with the required quantization bit number determined in the analysis phase is referred to as a normal operation phase. The analysis phase continues for a time during which the mobile relay station passes through the same path a plurality of times. The ninth embodiment will be described focusing on differences from the seventh and eighth embodiments.

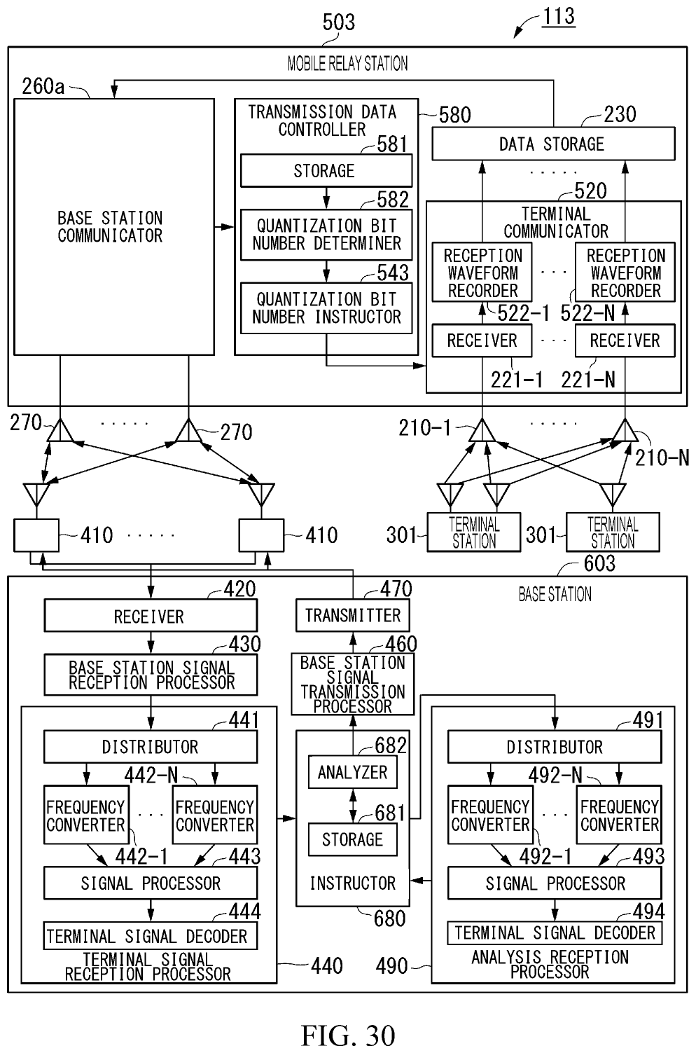

FIG. 30 is a configuration diagram of a wireless communication system 113 according to the ninth embodiment. In FIG. 30, the same components as those of the wireless communication system 111 according to the seventh embodiment illustrated in FIG. 22 and the wireless communication system 111a according to the seventh embodiment illustrated in FIG. 24 are denoted by the same reference numerals, and the description thereof will be omitted. The wireless communication system 113 includes a mobile relay station 503, the terminal station 301, and a base station 603. The mobile relay station 503 is used as the mobile relay station 2 in FIG. 1, and the base station 603 is used as the base station 4 in FIG. 1.

The mobile relay station 503 is different from the mobile relay station 501 illustrated in FIG. 22 in that a transmission data controller 580 is provided instead of the transmission data controller 540 and the base station communicator 260a is provided instead of the base station communicator 260. The transmission data controller 580 includes a storage 581, a quantization bit number determiner 582, and the quantization bit number instructor 543.

The storage 581 stores the communication area information and area-specific quantization bit number information. The area-specific quantization bit number information is information in which a communication area is associated with the quantization bit number. The quantization bit number determiner 582 determines the quantization bit number. In the analysis phase, the quantization bit number determiner 582 determines a plurality of types of quantization bit numbers for the same path at different timings. In the normal operation phase, the quantization bit number determiner 582 reads the communication area at each time from the communication area information stored in the storage 581, and reads the information of the quantization bit number corresponding to the communication area from the area-specific quantization bit number information stored in the storage 581. However, in the normal operation phase, the quantization bit number determiner 582 determines to use the quantization bit number larger than the quantization bit number indicated by the communication area information every time the same path is passed a predetermined number of times. For example, the quantization bit number determiner 582 determines the maximum possible quantization bit number. Further, the quantization bit number determiner 582 updates the area-specific quantization bit number information stored in the storage 581 based on the communication area information transmitted from the base station 603. Furthermore, the quantization bit number determiner 582 increases the quantization bit number set in the area-specific quantization bit number information in accordance with an instruction from the base station 603.

The base station 603 illustrated in FIG. 30 is different from the base station 401 illustrated in FIG. 22 in further including the base station signal transmission processor 460 and the transmitter 470 illustrated in FIG. 6, an instructor 680, and the analysis reception processor 490 illustrated in FIG. 13. Note that an external apparatus connected to the base station 603 may include one or both of the instructor 680 and the analysis reception processor 490.

The instructor 680 includes a storage 681 and an analyzer 682. The storage 681 stores the communication area information of each mobile relay station 503. In the analysis phase, the analyzer 682 determines the required quantization bit number in each communication area on the basis of the decoding success rate in the terminal signal reception processor 440 for each mobile relay station 503. The analyzer 682 generates, for each mobile relay station 503, the area-specific quantization bit number information in which the communication area is associated with the required quantization bit number. The analyzer 682 notifies each mobile relay station 503 of the area-specific quantization bit number information generated for the mobile relay station. In addition, in the normal operation phase, when the decoding success rate in the terminal signal reception processor 440 becomes lower than a predetermined value, the analyzer 682 instructs the mobile relay station 503 to increase the quantization bit number. Further, the analyzer 682 analyzes the required quantization bit number using the waveform data periodically transmitted from the mobile relay station 503 in the normal operation phase. For this analysis, the analyzer 682 outputs the waveform data of the terminal uplink signal sampled by the quantization bit number to the analysis reception processor 490 while changing the quantization bit number, and causes the analysis reception processor 490 to execute reception processing to obtain the decoding success rate. The analyzer 682 determines the required quantization bit number of the mobile relay station 503 on the basis of the relationship between the quantization bit number and the decoding success rate.

The processing of the analysis phase will be described. In the analysis phase, the wireless communication system 113 performs transmission and reception of the terminal uplink signal in which the terminal transmission data is set by processing similar to that of the first embodiment illustrated in FIG. 3.

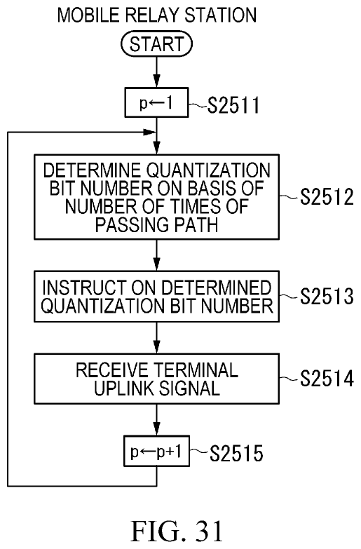

FIG. 31 is a flowchart illustrating transmission data control processing in the analysis phase of the mobile relay station 503. First, the quantization bit number determiner 582 of the mobile relay station 503 sets an initial value 1 to the number of times p of passing the same path (step S2511). The quantization bit number determiner 582 determines the quantization bit number according to the number of times p of passing the same path (step S2512). For example, the quantization bit number determiner 582 determines a quantization bit number of which the number of times determined in the past in the same path as the current path is less than the threshold. The threshold is an integer of 1 or more. The quantization bit number determiner 582 may change the quantization bit number every time the same path is passed or may change the quantization bit number every time the same path is passed a predetermined plurality of times. The quantization bit number instructor 543 instructs the reception waveform recorder 522 on the quantization bit number determined in step S2512 (step S2513). The terminal communicator 520 performs the processing of steps S121 and S122 of FIG. 3, and writes the reception waveform information of each antenna 210 in the data storage 230 (step S2514). The quantization bit number determiner 582 adds 1 to the number of times p of passing the same path (step S2515). The mobile relay station 503 repeats the processing from step S2512.

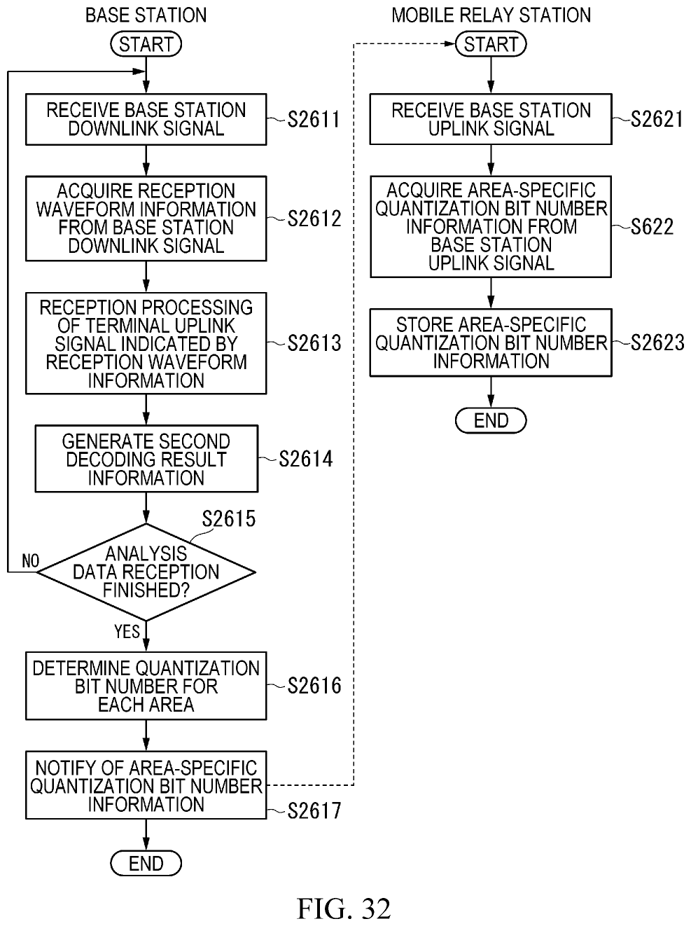

In the analysis phase, the mobile relay station 503 performs the processing illustrated in steps S311 to S313 of FIG. 5 and transmits the base station downlink signal in which the reception waveform information is set by MIMO. The wireless communication system 113 performs processing illustrated in FIG. 32 in the analysis phase.

FIG. 32 is a flowchart illustrating information generation processing of the wireless communication system 113 in the analysis phase. The base station 603 receives the base station downlink signal from the mobile relay station 503, and performs processing similar to steps S321 to S323 of FIG. 5 (steps S2611 to S2613).

The analyzer 682 acquires the identification information of the mobile relay station 503 read from the base station downlink signal from the base station signal reception processor 430. Furthermore, the analyzer 682 receives, from the terminal signal reception processor 440, the information of the reception time and the information of the quantization bit number added to the reception waveform information obtained from the base station downlink signal, and the information of the decoding success rate of the waveform data obtained from the reception waveform information at the reception time. The analyzer 682 reads information of the communication area corresponding to the reception time from the communication area information stored in the storage 681 in association with the identification information of the mobile relay station 503. The analyzer 682 generates second decoding result information in which the identification information of the mobile relay station 503, the information of the reception time, the information of the communication area, the information of the quantization bit number, and the decoding success rate are associated with each other, and writes the generated second decoding result information in the storage 681 (step S2614).

When reception of the analysis data is not finished (step S2615: NO), the base station 603 repeats the processing from step S2611. When the reception of the analysis data is finished (step S2615: YES), the base station 603 performs processing of step S2616.

The analyzer 682 analyzes the relationship between the quantization bit number and the decoding success rate for each communication area using the second decoding result information generated in step S2614, and determines the required quantization bit number for each communication area (step S2616). Specifically, it is assumed that, in a certain communication area, the average of the quantization bit numbers at which a predetermined decoding success rate or more is obtained is Na, and the maximum value is Nmax. The analyzer 682 may set the required quantization bit number to Na or Nmax, may set the required quantization bit number to a value obtained by adding a predetermined number to Na or Nmax, or may set the required quantization bit number to a value obtained by increasing Na or Nmax by a predetermined ratio. In a case where the quantization bit number takes a stepwise value, the analyzer 682 sets a stepwise value that exceeds the value calculated as described above and is closest to the calculated value as the quantization bit number. The analyzer 682 generates the area-specific quantization bit number information in which the communication area is associated with the required quantization bit number determined for the communication area.

The mobile relay station 503 communicates with the same communication area while moving. Therefore, the analyzer 682 determines the required quantization bit number by using not only a result of the reception processing of the reception waveform information when the mobile relay station 503 is located at a specific position but also a result of the reception processing of the reception waveform information when the mobile relay station is located in the vicinity thereof. The result of the reception processing as to whether or not the decoding is successful indicates the communication quality between the mobile relay station 503 and the terminal station 301.

The analyzer 682 outputs the area-specific quantization bit number information of the mobile relay station 503 to the base station signal transmission processor 460. Thus, the base station 603 transmits the base station uplink signal in which the area-specific quantization bit number information is set to the mobile relay station 503 (step S2617).

Each antenna 270 of the mobile relay station 503 receives the base station uplink signal (step S2621). The base station communicator 260a of the mobile relay station 503 performs processing similar to step S422 of FIG. 8 to obtain the area-specific quantization bit number information transmitted by the base station 603 (step S2622). The reception processor 266 outputs the area-specific quantization bit number information to the quantization bit number determiner 582. The quantization bit number determiner 582 stores the area-specific quantization bit number information in the storage 581 (step S2623).

After the analysis phase, the wireless communication system 113 starts the normal operation phase. In the normal operation phase, the wireless communication system 113 transmits and receives the terminal uplink signal in which the terminal transmission data is set by processing similar to that of the first embodiment illustrated in FIG. 3.

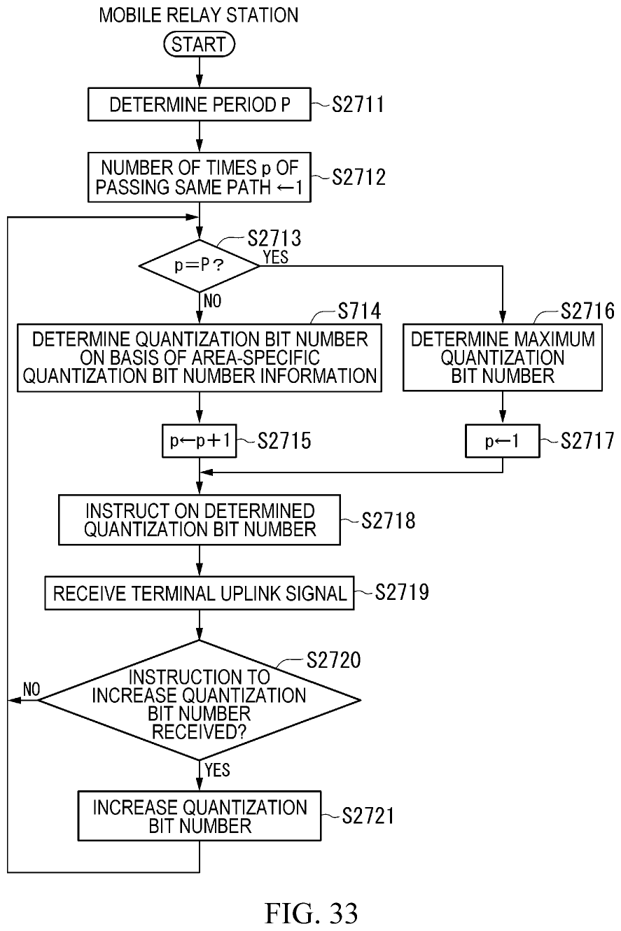

FIG. 33 is a flowchart illustrating transmission data control processing in the normal operation phase of the mobile relay station 503. The quantization bit number determiner 582 of the mobile relay station 503 determines a period P in which the required quantization bit number is updated (step S2711). The period P can be arbitrarily determined. The quantization bit number determiner 582 sets an initial value 1 to the number of times p of passing the same path (step S2712).

When determining that the number of times p of passing the same path has not reached the period P (step S2713: NO), the quantization bit number determiner 582 determines the quantization bit number on the basis of the area-specific quantization bit number information (step S2714). That is, the quantization bit number determiner 582 acquires the information of the communication area at the current time from the area information stored in the storage 581. Furthermore, the quantization bit number determiner 582 reads the quantization bit number in the read communication area from the area-specific quantization bit number information stored in the storage 581. The quantization bit number determiner 582 adds 1 to the number of times p of passing the same path (step S2715).

On the other hand, when determining that the number of times p of passing the same path has reached the period P (step S2713: YES), the quantization bit number determiner 582 determines the quantization bit number as the maximum value (step S2716). The quantization bit number determiner 582 sets 1 to the number of times p of passing the same path (step S2717).

The quantization bit number instructor 543 instructs the quantization bit number determined by the quantization bit number determiner 582 in step S2714 or step S2717 to the reception waveform recorder 522 (step S2718). The terminal communicator 520 performs the processing of steps S121 and S122 in FIG. 3 (step S2719).

When receiving the quantization bit number increase instruction from the base station 603 (step S2720: YES), the mobile relay station 503 increases the quantization bit number stored in the area-specific quantization bit number information corresponding to the communication area set in the quantization bit number increase instruction (step S2721). When not receiving the quantization bit number increase instruction from the base station 603 (step S2720: NO), or after the processing of step S2721, the mobile relay station 503 repeats the processing from step S2713.

The mobile relay station 503 performs the processing of steps S311 to S313 of FIG. 5 in the normal operation phase, and transmits the base station downlink signal in which the reception waveform information is set to the base station 603.

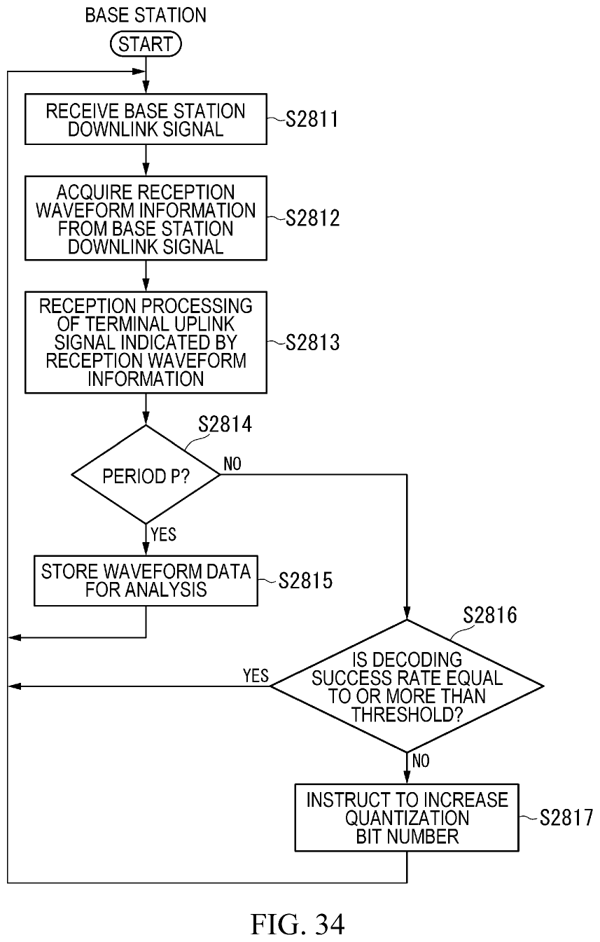

FIG. 34 is a flowchart illustrating base station downlink signal reception processing in the normal operation phase of the base station 603. The base station 603 receives the base station downlink signal in which the waveform data is set from the mobile relay station 503. The quantization bit number of the waveform data set in the base station downlink signal is controlled by the processing of FIG. 33. The base station 603 performs processing similar to steps S2611 to S2613 in FIG. 32 (steps S2811 to S2813).

The analyzer 682 determines whether or not the current period is the period P (step S2814). When determining that it is the period P (step S2814: YES), the analyzer 682 writes the analysis waveform data in the storage 681 (step S2815). The analyzer 682 may determine that it is the period P in a case where the quantization bit number is the maximum value. The analysis waveform data is information in which the identification information of the mobile relay station 503, the reception time added to the waveform data, the antenna identification information of each antenna 210, the reception waveform data of each antenna 210, the quantization bit number, and the communication area are associated with each other. The analyzer 682 reads the identification information of the mobile relay station 503, the reception time, the antenna identification information of each antenna 210, the reception waveform data of each antenna 210, and the quantization bit number from the base station downlink signal. Further, the analyzer 682 reads the information of the communication area corresponding to the reception time from the communication area information of the mobile relay station 503. The base station 603 repeats the processing from step S2811.

On the other hand, when determining that it is not the period P (step S2814: NO), the analyzer 682 determines whether or not the decoding success rate is equal to or more than the threshold (step S2816). When determining that the decoding success rate is equal to or more than the threshold (step S2816: YES), the analyzer 682 repeats the processing from step S2811.

When determining that the decoding success rate is less than the threshold (step S2816: NO), the analyzer 682 reads, from the communication area information stored in the storage 681, the information of the communication area corresponding to the information of the reception time when the decoding success rate is obtained. The analyzer 682 outputs the quantization bit number increase instruction in which the read communication area information is set to the base station signal transmission processor 460. The analyzer 682 increases the data amount of the waveform data generated by the mobile relay station 503 in accordance with the quantization bit number increase instruction. Thus, the base station 603 transmits the base station uplink signal in which the quantization bit number increase instruction is set to the mobile relay station 503 (step S2817), and repeats the processing from step S2811.

The mobile relay station 503 receives the base station uplink signal transmitted in step S2817 (step S2720 in FIG. 33: YES). The base station communicator 260a of the mobile relay station 503 performs reception processing of the base station uplink signal and acquires the quantization bit number increase instruction. The base station communicator 260a outputs the acquired quantization bit number increase instruction to the transmission data controller 580. In step S2721 of FIG. 33, the quantization bit number determiner 582 of the transmission data controller 580 increases, by a predetermined number or a predetermined ratio, the quantization bit number stored in the area-specific quantization bit number information corresponding to the communication area set in the quantization bit number increase instruction. The analyzer 682 of the base station 603 may set information of the number or the ratio for increasing the quantization bit number in the quantization bit number increase instruction. In a case where the quantization bit number takes a stepwise value, the analyzer 682 increases the quantization bit number to a quantization bit number larger than the current stage by a predetermined step. In addition, the analyzer 682 may transmit the quantization bit number increase instruction when the number of times the decoding success rate has not reached the threshold for the same communication area reaches a predetermined number of times.

As described above, in order to grasp the accurate required quantization bit number, the mobile relay station 503 transmits, to the base station 603, waveform data sampled by the maximum quantization bit number periodically, such as once a month, even in the normal operation phase. The base station 603 or the analysis apparatus on the ground restores the received waveform data to a signal and generates waveform data of the restored signal while changing the quantization bit number. The base station 603 performs reception processing using the waveform data of each quantization bit number and analyzes the required quantization bit number. In a case where analysis is performed once a month, the period P is the number of passing paths in one month.

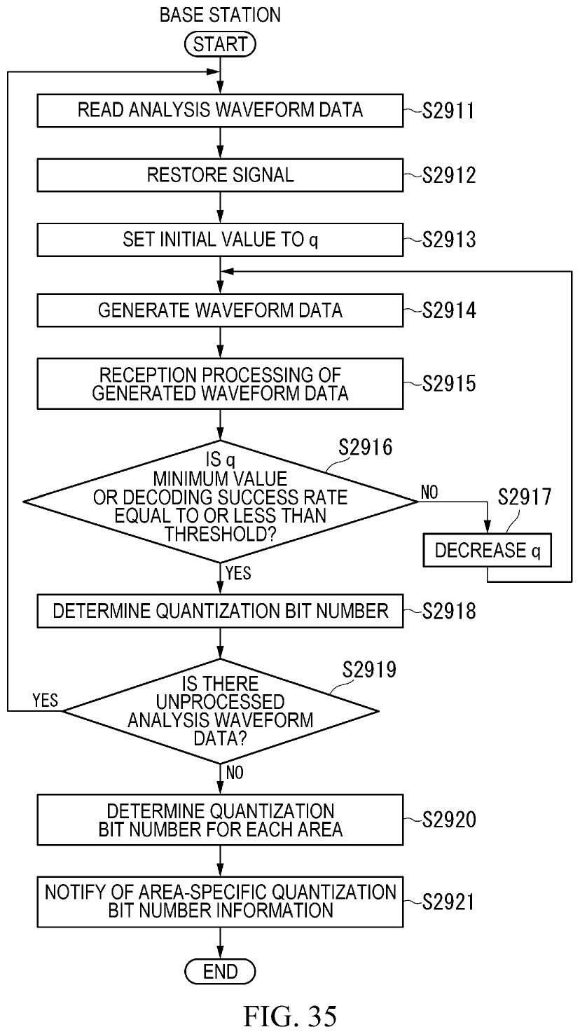

FIG. 35 is a flowchart illustrating analysis processing of the quantization bit number by the base station 603. The base station 603 performs analysis processing of the quantization bit number by using the decoding result in the period P. The base station 603 performs processing of FIG. 35 for each mobile relay station 503. The analyzer 682 reads the analysis waveform data from the storage 681 (step S2911). The analyzer 682 reads the waveform data and the quantization bit number of each reception antenna from the analysis waveform data. The analyzer 682 restores the signal waveform from the waveform data of each reception antenna on the basis of the quantization bit number (step S2912). The analyzer 682 sets an initial value to the quantization bit number q (step S2913).

The analyzer 682 samples each signal waveform restored in step S2912 by the quantization bit number q to generate waveform data (step S2914). The analyzer 682 outputs the generated waveform data and the quantization bit number to the analysis reception processor 490. The analyzer 682 may add, to the waveform data, the antenna identification information of the antenna 210 from which the waveform data is obtained. The analysis reception processor 490 executes reception processing using the waveform data and the quantization bit number input from the analyzer 682 (step S2915). That is, the distributor 491 outputs each piece of the waveform data received from the analyzer 682 to the frequency convertors 492-1 to 492-N. In a case where the antenna identification information is added to the waveform data, the distributor 491 outputs the waveform data to which the antenna identification information of the antenna 210-n is added to the frequency convertor 492-n. Each of the frequency convertors 492 restores the signal waveform from the waveform data on the basis of the quantization bit number. The frequency convertor 492 frequency-converts the signal represented by the restored signal waveform from the RF signal into a baseband signal, and outputs the frequency-converted reception signal to the signal processor 493. The signal processor 493 performs processing such as frame detection (terminal signal detection), Doppler shift compensation, and offline beam control on the reception signal input from each of the frequency convertors 492-1 to 492-N, and adds and combines the reception signals. The signal processor 443 outputs the symbol of the reception signal added and combined to the terminal signal decoder 494. The terminal signal decoder 494 decodes the symbol input from the signal processor 493 to obtain the terminal transmission data. The terminal signal decoder 494 notifies the analyzer 682 of the decoding success rate.

The analyzer 682 determines whether or not at least one of a condition that the quantization bit number q has reached a predetermined minimum value or a condition that the decoding success rate is equal to or less than a threshold is satisfied (step S2916). When determining that none of the conditions is satisfied (step S2916: NO), the analyzer 682 updates the value of quantization bit number q to a smaller value than the current value (step S2917). The analyzer 682 repeats the processing from step S2914.

In step S2916, when determining that one or both of the condition that the quantization bit number q has reached the predetermined minimum value and the condition that the decoding success rate is equal to or less than the threshold are satisfied (step S2916: YES), the analyzer 682 determines the quantization bit number for the analysis waveform data read in step S2911 (step S918). For example, the analyzer 682 sets the value of q used immediately before the current q as the quantization bit number when the decoding success rate is less than the threshold, and sets the current q as the quantization bit number when the decoding success rate is equal to or more than the threshold. The analyzer 682 adds information of the determined quantization bit number to the analysis waveform data.

The analyzer 682 determines whether or not there is unprocessed data in the analysis waveform data stored in the storage 681 (step S2919). When determining that there is unprocessed analysis waveform data (step S2919: YES), the analyzer 682 performs the processing from step S2911. Then, when determining that there is no unprocessed analysis waveform data for analysis (step S2919: NO), the analyzer 682 performs processing of step S2920.

The analyzer 682 determines the quantization bit number of the communication area on the basis of the quantization bit number determined for the analysis waveform data for which the same communication area is set (step S2920). For example, the analyzer 682 may determine an average, a maximum value, a number obtained by adding a predetermined number to the average, a number obtained by adding a predetermined number to the maximum value, a number obtained by increasing the average by a predetermined ratio, a number obtained by increasing the maximum value by a predetermined ratio, or the like of the quantization bit numbers determined for the analysis waveform data for which the same communication area is set. In a case where the quantization bit number takes a stepwise value, the analyzer 682 sets a stepwise value that exceeds the value calculated as described above and is closest to the calculated value as the quantization bit number.

The analyzer 682 generates area-specific quantization bit control number information indicating the quantization bit number determined for each communication area. The analyzer 682 outputs the area-specific quantization bit number information of the mobile relay station 503 to the base station signal transmission processor 460. Thus, the base station 603 transmits the base station uplink signal in which the area-specific quantization bit number information is set to the mobile relay station 503 (step S2921).

The mobile relay station 503 performs the processing of steps S2621 to S2623 of FIG. 32. That is, the base station communicator 260a performs reception processing of the base station uplink signal and acquires the area-specific quantization bit number information. The quantization bit number determiner 582 of the transmission data controller 580 writes the area-specific quantization bit number information acquired by the base station communicator 260a in the storage 581.

According to the ninth embodiment, the wireless communication system can determine the quantization bit number for each communication area of the mobile relay station on the basis of the past actual communication quality.

### Tenth Embodiment

In a tenth embodiment, before the mobile relay station transmits the waveform data by the base station downlink signal, a generation status of the ground IoT interference signal is analyzed from the waveform data acquired by the waveform sampling apparatus installed at multiple points on the ground to calculate the required quantization bit number, and the mobile relay station is notified of the required quantization bit number. The mobile relay station transmits the waveform data of the terminal uplink signal sampled by the notified required quantization bit number by the base station downlink signal. The tenth embodiment will be described focusing on differences from the seventh to ninth embodiments.

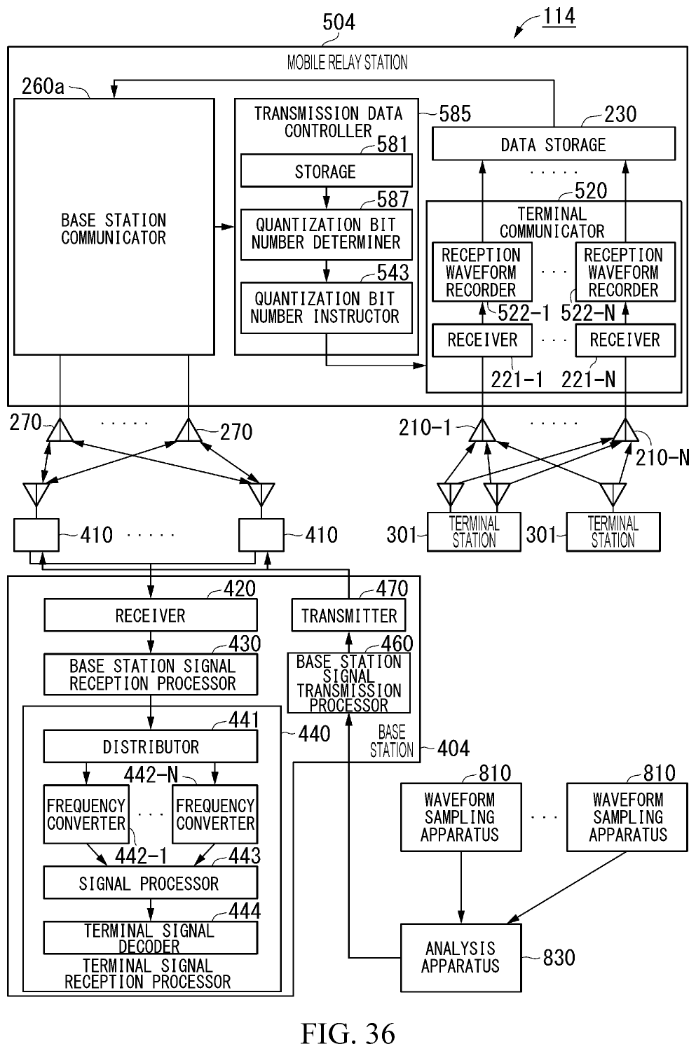

FIG. 36 is a configuration diagram of a wireless communication system 114 according to the tenth embodiment. In FIG. 36, the same components as those of the wireless communication system 104 according to the fourth embodiment illustrated in FIG. 19 and the wireless communication system 113 according to the ninth embodiment illustrated in FIG. 30 are denoted by the same reference numerals, and description thereof is omitted. The wireless communication system 114 includes a mobile relay station 504, the terminal station 301, the base station 404, the waveform sampling apparatus 810, and an analysis apparatus 830. The mobile relay station 504 is used as the mobile relay station 2 in FIG. 1.

The mobile relay station 504 is different from the mobile relay station 503 illustrated in FIG. 30 in that a transmission data controller 585 is provided instead of the transmission data controller 580. The transmission data controller 585 is different from the transmission data controller 580 in that a quantization bit number determiner 587 is provided instead of the quantization bit number determiner 582. The quantization bit number determiner 587 reads the communication area at each time from the communication area information stored in the storage 581, and reads the information of the quantization bit number corresponding to the communication area from the area-specific quantization bit number information stored in the storage 581.

The analysis apparatus 830 detects interference generated in the communication area on the basis of the waveform data received from the waveform sampling apparatus 810 installed in the communication area of the mobile relay station 504 or around the communication area. The analysis apparatus 830 stores in advance a calculation formula or relational data indicating the relationship between the intensity of interference and the quantization bit number. The analysis apparatus 830 determines the quantization bit number on the basis of the detected interference and the stored calculation formula or relational data. The analysis apparatus 830 notifies the base station 404 of quantization bit number notification information in which the communication area and the quantization bit number determined for the communication area are set. The base station 404 transmits, to the mobile relay station 504, the base station uplink signal in which the quantization bit number notification information received from the analysis apparatus 830 is set.

The mobile relay station 504 performs the processing of steps S2621 and S2622 of FIG. 32. That is, the base station communicator 260a performs reception processing of the base station uplink signal and acquires the quantization bit number notification information. The quantization bit number determiner 587 updates the area-specific quantization bit number information stored in the storage 581 on the basis of the quantization bit number notification information acquired from the base station uplink signal by the base station communicator 260a.

The wireless communication system 114 operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the wireless communication system 114 performs transmission data control processing similar to that in FIG. 23 of the seventh embodiment except for the following points. That is, instead of the processing of steps S2102 and S2103, the quantization bit number determiner 587 performs processing of determining the quantization bit number by processing similar to step S2714 of FIG. 33. Specifically, the quantization bit number determiner 587 acquires the information of the communication area at the current time from the area information stored in the storage 581. Furthermore, the quantization bit number determiner 587 reads the quantization bit number in the read communication area from the area-specific quantization bit number information stored in the storage 581.

According to the tenth embodiment, the required quantization bit number of the mobile relay station can be determined on the basis of an actual observation result on the ground.

### Eleventh Embodiment

In an eleventh embodiment, in the wireless communication system, the mobile relay station performs arrival direction estimation processing, and controls the quantization bit number on the basis of a rough estimation result of the number and direction of arrival signals. The eleventh embodiment will be described focusing on differences from the seventh to tenth embodiments.

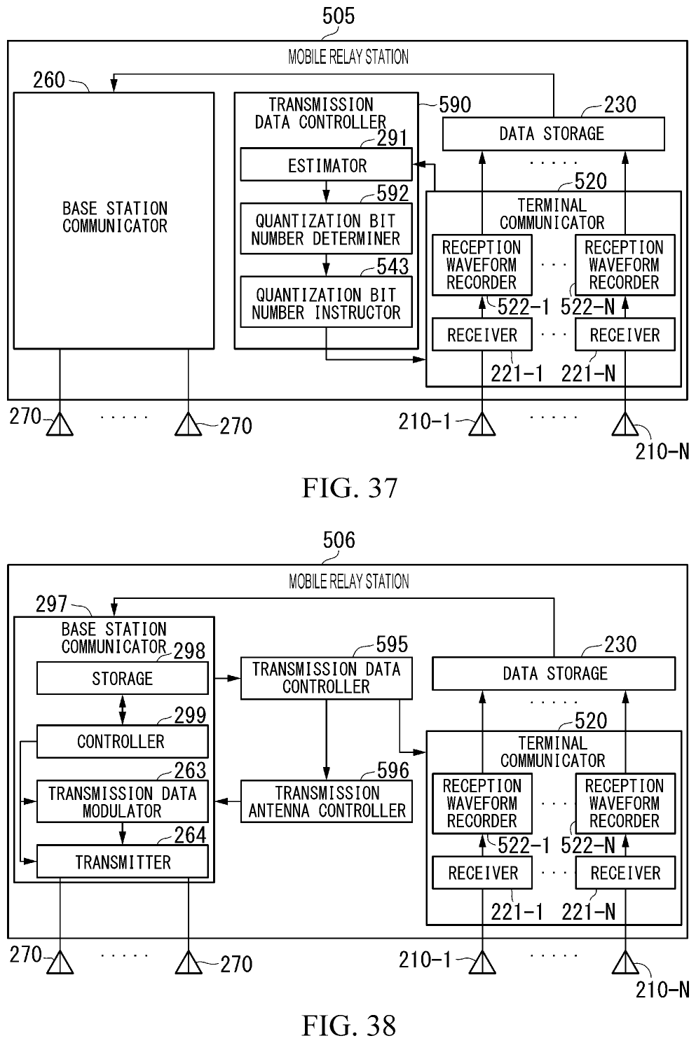

FIG. 37 is a configuration diagram of a mobile relay station 505 of the eleventh embodiment. In FIG. 37, the same components as those of the mobile relay station 205 according to the fifth embodiment illustrated in FIG. 20 and the mobile relay station 501 according to the seventh embodiment illustrated in FIG. 22 are denoted by the same reference numerals, and the description thereof will be omitted. The mobile relay station 505 is used as the mobile relay station 2 in FIG. 1.

The mobile relay station 505 is different from the mobile relay station 501 illustrated in FIG. 22 in that a transmission data controller 590 is provided instead of the transmission data controller 540. Further, the number N of the antennas 210 is an integer of 2 or more. The transmission data controller 590 includes the estimator 291, a quantization bit number determiner 592, and a quantization bit number instructor 543.

The estimator 291 estimates an arrival direction of a signal and the number of terminals that have transmitted the signal on the basis of the terminal uplink signal received by each of the receivers 221-1 to 221-N. The quantization bit number determiner 592 determines the quantization bit number on the basis of the estimation result by the estimator 291. The quantization bit number determiner 592 determines the quantization bit number by substituting the estimation result into a calculation formula for calculating the quantization bit number using the arrival direction of the signal and the number of terminals as parameters. The calculation formula is predefined. As the number of terminals increases, the reception quality in the mobile relay station 505 decreases, and thus the quantization bit number increases. In addition, the larger the elevation angle represented by the arrival direction, the better the reception quality in the mobile relay station 505, and thus the smaller the quantization bit number may be.

The wireless communication system of the eleventh embodiment operates as in FIG. 3 of the first embodiment for transmission and reception of the terminal uplink signal in which the terminal transmission data is set, and operates as in FIG. 5 of the first embodiment for transmission and reception of the base station downlink signal in which the reception waveform information is set. Further, the wireless communication system of the eleventh embodiment performs transmission data control processing similar to that of FIG. 23 of the seventh embodiment except for the following points. That is, the following processing is performed instead of the processing of steps S2102 and S2103. The estimator 291 estimates an arrival direction of a signal and the number of terminals that have transmitted the signal on the basis of the terminal uplink signal received by each of the receivers 221-1 to 221-N. The quantization bit number determiner 592 determines the number of reception antennas on the basis of the estimation result by the estimator 291.

According to the eleventh embodiment, the quantization bit number can be controlled on the basis of the reception state estimated in the mobile relay station.

### Twelfth Embodiment

In a twelfth embodiment, the number of transmission antennas that is used for transmitting, by the base station downlink signal, the reception waveform information generated by controlling the quantization bit number by the mobile relay station is controlled. The twelfth embodiment will be described focusing on a difference from the above-described seventh to eleventh embodiments.

FIG. 38 is a diagram illustrating a mobile relay station 506 of the twelfth embodiment. The mobile relay station 506 includes the antennas 210-1 to 210-N, the terminal communicator 520, the data storage 230, a transmission data controller 595, a transmission antenna controller 596, the base station communicator 297, and the M antennas 270.

The transmission data controller 595 is the transmission data controllers 540, 540a, 545, 580, 585, and 590 of the seventh to eleventh embodiments described above. The transmission antenna controller 596 determines the number of transmission antennas corresponding to the quantization bit number determined by the transmission data controller 595. The base station communicator 297 is the base station communicator 260 or the base station communicator 260a.

For example, the transmission antenna controller 596 determines the number of transmission antennas corresponding to the quantization bit number at the reception time t determined by the transmission data controller 540 on the basis of a correspondence between a predetermined quantization bit number and the number of transmission antennas. The transmission antenna controller 596 selects the antennas 270 by the determined number of transmission antennas from the M antennas 270. The selected antenna 270 is referred to as a selected transmission antenna. For example, the transmission antenna controller 596 selects the antennas 270 by the number of transmission antennas so that the area formed by the selected transmission antennas is as wide as possible and the density of the selected transmission antennas in the area is close to uniform. When the base station communicator 297 transmits the reception waveform information at the reception time t by the base station downlink signal, the transmission antenna controller 596 notifies the base station communicator 297 of the number m of transmission antennas (m is an integer of 1 or more and M or less) and the selected transmission antennas at the reception time t. The base station communicator 297 operates as in the sixth embodiment, and transmits a base station downlink signal from the antennas 270 of the selected transmission antennas.

In addition, when the mobile relay station 506 communicates with the base station 601 illustrated in FIG. 24 or the base station 602 illustrated in FIG. 28, the quantization bit number determiner 652 of the base station 601 or the quantization bit number determiner 657 of the base station 602 may determine the number of transmission antennas corresponding to the quantization bit number at each reception time t on the basis of a correspondence between a predetermined quantization bit number and the number of transmission antennas. Alternatively, the quantization bit number determiner 652 or the quantization bit number determiner 657 may determine the number of transmission antennas corresponding to the quantization bit number at each reception time t and determine the selected transmission antennas by the determined number of transmission antennas. The quantization bit number determiners 652 and 657 further set the number of transmission antennas or the selected transmission antennas at each reception time t in the quantization bit number control information to be transmitted to the mobile relay station 506. When the base station communicator 297 transmits the reception waveform information at the reception time t by the base station downlink signal, the transmission antenna controller 596 reads the number of transmission antennas or the selected transmission antennas at the reception time t from the quantization bit number control information. When reading the number of transmission antennas, the transmission antenna controller 596 determines the selected transmission antennas by the number of transmission antennas. The transmission antenna controller 596 notifies the base station communicator 297 of the number of transmission antennas and the selected transmission antennas at the reception time t.

In addition, when the mobile relay station 506 and the base station 603 illustrated in FIG. 30 communicate with each other, the analyzer 682 of the base station 603 may determine the number of transmission antennas corresponding to the quantization bit number for each area, or may determine the selected transmission antenna of the number of transmission antennas corresponding to the quantization bit number. The analyzer 682 may set the information of the number of transmission antennas or the selected transmission antenna determined according to the quantization bit number to the area-specific quantization bit number information.

In addition, in a case where the mobile relay station 506 and the base station 404 illustrated in FIG. 36 communicate with each other, the analysis apparatus 830 may determine the number of transmission antennas corresponding to the quantization bit number, or may determine the selected transmission antennas by the number of transmission antennas corresponding to the quantization bit number. The analysis apparatus 830 may set the information of the number of transmission antennas or the selected transmission antennas determined according to the quantization bit number as the quantization bit number notification information. When the base station communicator 297 transmits the reception waveform information at the reception time t by the base station downlink signal, the transmission antenna controller 596 reads the number of transmission antennas or the selected transmission antennas corresponding to the communication area at the reception time t from the area-specific quantization bit number information. When reading the number of transmission antennas, the transmission antenna controller 596 determines the selected transmission antennas by the number of transmission antennas. The transmission antenna controller 596 notifies the base station communicator 297 of the number of transmission antennas and the selected transmission antennas at the reception time t.

According to the twelfth embodiment, since the power supply of the MIMO transmission system that is unnecessary when the mobile relay station transmits the base station downlink signal is turned off, the power consumption can be further suppressed.

### Thirteenth Embodiment

In the foregoing embodiment, frequency conversion of the terminal uplink signal is performed at the base station. In the present embodiment, frequency conversion is performed in the mobile relay station. The mobile relay station sends the waveform data of the frequency-converted terminal uplink signal to the base station.

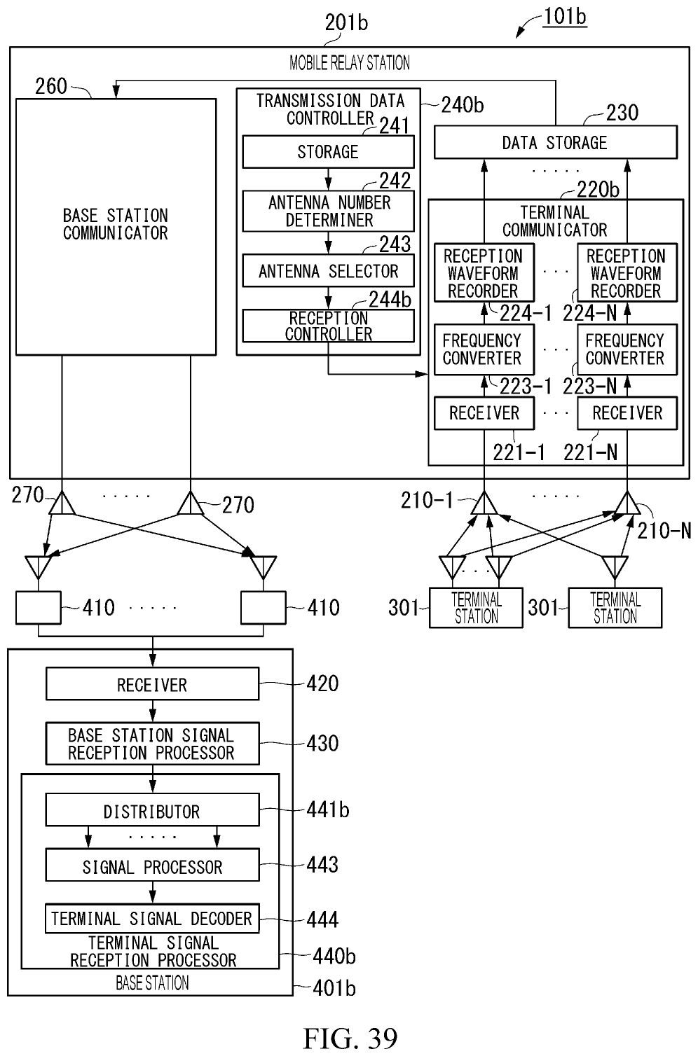

FIG. 39 is a configuration diagram of a wireless communication system 101b. Here, a difference between the wireless communication system 101b and the wireless communication system 101 of the first embodiment will be described, but similar differences can be applied to the wireless communication system 101a of the first embodiment and the wireless communication systems of the second to sixth embodiments. In FIG. 39, the same components as those of the wireless communication system 101 illustrated in FIG. 2 are denoted by the same reference numerals, and the description thereof will be omitted. The wireless communication system 101b includes a mobile relay station 201b, the terminal station 301, and a base station 401b. The mobile relay station 201b is used as the mobile relay station 2 in FIG. 1, and the base station 401b is used as the base station 4 in FIG. 1.

The mobile relay station 201b illustrated in FIG. 39 is different from the mobile relay station 201 illustrated in FIG. 2 in that a terminal communicator 220b is provided instead of the terminal communicator 220, and a transmission data controller 240b is provided instead of the transmission data controller 240. The terminal communicator 220b includes the N receivers 221, N frequency convertors 223, and N reception waveform recorders 224. The frequency convertor 223 connected to the receiver 221-n is referred to as a frequency convertor 223-n, and the reception waveform recorder 224 connected to the frequency convertor 223-n is referred to as a reception waveform recorder 224-n.

The frequency convertor 223-n frequency-converts the terminal uplink signal received by the receiver 221-n from an RF signal to a baseband signal. The reception waveform recorder 224-n samples the waveform of the terminal uplink signal subjected to the frequency conversion by the frequency convertor 223-n, and generates waveform data indicating a value obtained by the sampling. The reception waveform recorder 224-n writes the reception waveform information in which the antenna identification information of the antenna 210-n, the reception time of the terminal uplink signal at the antenna 210-n, and the generated waveform data are set to the data storage 230.

The transmission data controller 240b and the transmission data controller 240 are different in that a reception controller 244b is provided instead of the reception controller 244. The reception controller 244b stops the operations of the receiver 221-n, the frequency convertor 223-n, and the reception waveform recorder 224-n corresponding to the antenna 210-n other than the selected reception antennas.

The base station 401b is different from the base station 401 illustrated in FIG. 2 in that a terminal signal reception processor 440b is included instead of the terminal signal reception processor 440. The terminal signal reception processor 440b includes a distributor 441b, the signal processor 443, and the terminal signal decoder 444. The distributor 441b reads the waveform data of each reception antenna at the same reception time from the reception waveform information, and outputs a reception signal represented by the read waveform data to the signal processor 443.

In step S122 of FIG. 3, the frequency convertor 223-n of the mobile relay station 201b frequency-converts the terminal uplink signal received by the receiver 221-n from the RF signal into the baseband signal. The reception waveform recorder 224-n samples the waveform of the terminal uplink signal subjected to the frequency conversion by the frequency convertor 223-n, and generates waveform data indicating a value obtained by the sampling. The reception waveform recorder 224-n writes the reception waveform information in which the antenna identification information of the antenna 210-n, the reception time of the terminal uplink signal at the antenna 210-n, and the generated waveform data are set to the data storage 230.

Further, in step S323 of FIG. 5, the distributor 441b of the base station 401b reads waveform data having the same reception time from the reception waveform information. The distributor 441b adds antenna identification information associated with the read waveform data, and outputs the waveform data to the signal processor 443. Processing after the reception signal is input to the signal processor 443 is similar to that in the above-described embodiment.

Note that, in a case where the base station 403 of the third embodiment illustrated in FIG. 13 includes the terminal signal reception processor 440b instead of the terminal signal reception processor 440, the analysis reception processor 490 does not include the frequency convertor 492. The distributor 491 outputs the waveform data received from the analyzer 482 to the signal processor 493.

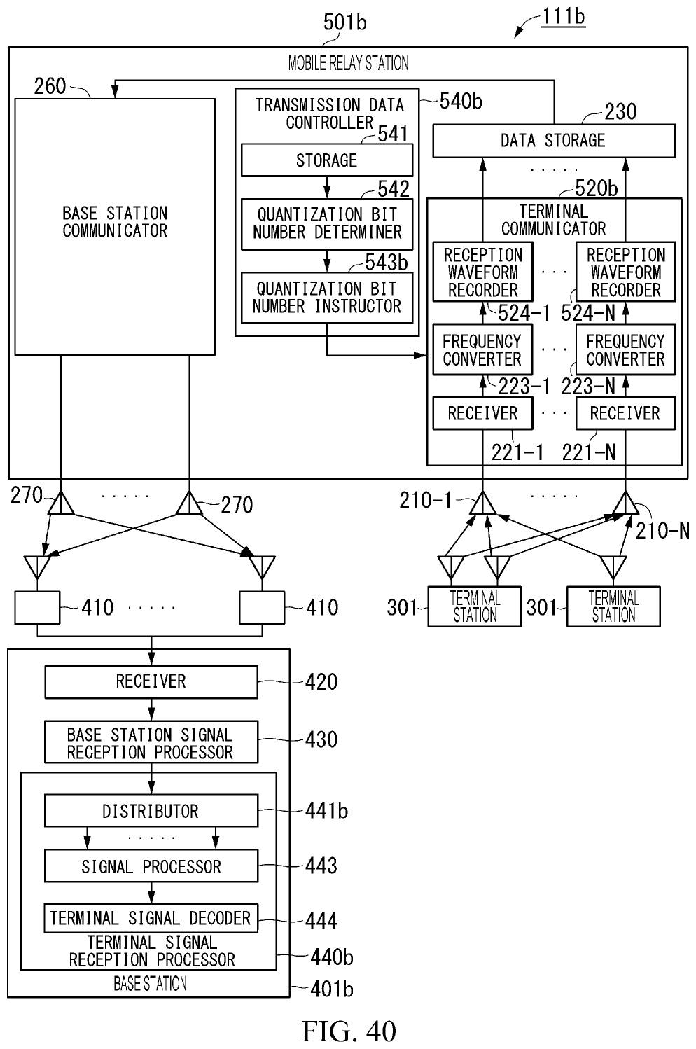

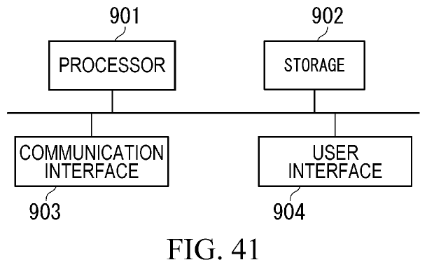

FIG. 40 is a configuration diagram of the wireless communication system 111b. Here, a difference between the wireless communication system 111b and the wireless communication system 111 of the seventh embodiment will be described, but similar differences can be applied to the wireless communication system 111a of the seventh embodiment and the wireless communication systems of the eighth to twelfth embodiments. In FIG. 40, the same components as those of the wireless communication system 111 illustrated in FIG. 22 and the wireless communication system 101b illustrated in FIG. 39 are denoted by the same reference numerals, and the description thereof will be omitted. The wireless communication system 111b includes a mobile relay station 501b, the terminal station 301, and the base station 401b. The mobile relay station 501b is used as the mobile relay station 2 in FIG. 1.

The mobile relay station 501b includes antennas 210-1 to 210-N, a terminal communicator 520b, the data storage 230, a transmission data controller 540b, the base station communicator 260, and the M antennas 270.

The terminal communicator 520b includes the N receivers 221, the N frequency convertors 223, and N reception waveform recorders 524. The frequency convertor 223 connected to the receiver 221-n is referred to as a frequency convertor 223-n, and the reception waveform recorder 524 connected to the frequency convertor 223-n is referred to as a reception waveform recorder 524-n.

The reception waveform recorder 524-n samples the waveform of the terminal uplink signal subjected to the frequency conversion by the frequency convertor 223-n by the quantization bit number instructed from the transmission data controller 540b, and generates waveform data indicating a value obtained by the sampling. The reception waveform recorder 524-n writes the reception waveform information in which the antenna identification information of the antenna 210-n, the reception time of the terminal uplink signal at the antenna 210-n, and the generated waveform data are set to the data storage 230.

The transmission data controller 540b and the transmission data controller 540 are different in that a quantization bit number instructor 543b is provided instead of the quantization bit number instructor 543. The quantization bit number instructor 543b instructs the reception waveform recorder 524 of the terminal communicator 520b to sample waveform data according to the quantization bit number determined by the quantization bit number determiner 542. The reception waveform recorder 524-n samples the terminal uplink signal subjected to the frequency conversion by the frequency convertor 223-n by the quantization bit number instructed by the quantization bit number instructor 543b to generate waveform data.

In step S122 of FIG. 3, the frequency convertor 223-n of the mobile relay station 501b frequency-converts the terminal uplink signal received by the receiver 221-n from the RF signal into the baseband signal. The reception waveform recorder 224-n samples the waveform of the terminal uplink signal subjected to the frequency conversion by the frequency convertor 223-n, and generates waveform data indicating a value obtained by the sampling. The reception waveform recorder 524-n writes the reception waveform information in which the antenna identification information of the antenna 210-n, the reception time of the terminal uplink signal at the antenna 210-n, and the generated waveform data are set to the data storage 230.

Note that, in a case where the base station 603 of the ninth embodiment illustrated in FIG. 30 includes the terminal signal reception processor 440b instead of the terminal signal reception processor 440, the analysis reception processor 490 does not include the frequency convertor 492. The distributor 491 outputs the waveform data received from the analyzer 482 to the signal processor 493.

According to the present embodiment, since the mobile relay station records the waveform data of the terminal uplink signal after the frequency conversion, the data amount of the waveform data can be reduced. Therefore, compared with the first to twelfth embodiments, a data amount of the base station downlink signal can be reduced.

A hardware configuration example of the mobile relay stations 201, 201a, 201b, 202, 203, 204, 205, 206, 501, 501a, 501b, 502, 503, 504, 505, and 506 will be described. FIG. 41 is a apparatus configuration diagram illustrating a hardware configuration example of the mobile relay stations 201, 201a, 201b, 202, 203, 204, 205, 206, 501, 501a, 501b, 502, 503, 504, 505, and 506. The mobile relay stations 201, 201a, 201b, 202, 203, 204, 205, 206, 501, 501a, 501b, 502, 503, 504, 505, and 506 include a processor 901, a storage 902, a communication interface 903, and a user interface 904.

The processor 901 is a central processing unit that performs calculation and control. The processor 901 is, for example, a central processing unit (CPU). The storage 902 is a storage apparatus such as various memories and a hard disk. The processor 901 reads and executes the program from the storage 902, thereby implementing the transmission data controllers 240, 240a, 240b, 245, 280, 285, 290, 540, 540a, 540b, 545, 580, 585, 590, and 595, and the transmission antenna controller 596. Some of the functions of the transmission data controllers 240, 240a, 240b, 245, 280, 285, 290, 540, 540a, 540b, 545, 580, 585, 590, and 595, and the transmission antenna controller 596 may be implemented by using hardware such as an application specific integrated circuit (ASIC), a programmable logic apparatus (PLD), or a field programmable gate array (FPGA). The storage 902 further includes a work area and the like when the processor 901 executes various programs. The communication interface 903 is communicably connected to another apparatus. The communication interface 903 corresponds to the terminal communicators 220, 220b, 520, and 520b and the base station communicators 260, 260a, and 297. The user interface 904 is an input apparatus such as a keyboard, a pointing apparatus (a mouse, a tablet, or the like), a button, or a touch panel, or a display apparatus such as a display. An artificial operation is input by the user interface 904.

The hardware configuration of the base stations 401, 401a, 401b, 402, 403, 404, 601, 602, and 603 is also similar to that in FIG. 41. The processor 901 reads and executes the program from the storage 902, thereby implementing the control information generators 450, 455, and 655 and the instructors 480 and 680. The communication interface 903 corresponds to the receiver 420, the base station signal reception processor 430, the terminal signal reception processors 440 and 440b, the base station signal transmission processor 460, and the transmitter 470.

Further, the hardware configurations of the analysis apparatuses 820 and 830 are also similar to those in FIG. 41. The communication interface 903 communicates with the waveform sampling apparatus 810 and the base station 404.

According to the embodiment described above, it is possible to reduce the data amount when the relay apparatus relays received data while moving. Note that, in the above embodiment, the case where the mobile object on which the mobile relay station is mounted is an LEO satellite has been described, but the mobile object may be another flying object flying above, such as a geostationary satellite, a drone, or a HAPS.

According to the above-described embodiment, the wireless communication system includes a first communication apparatus, a second communication apparatus, and a moving relay apparatus. For example, the first communication apparatus is the terminal stations 3 and 301, the second communication apparatus is the base stations 4, 401, 401a, 401b, 402, 403, 404, 601, 602, and 603, and the relay apparatus is the mobile relay stations 201, 201a, 201b, 202, 203, 204, 205, 206, 501, 501a, 501b, 502, 503, 504, 505, and 506.

The relay apparatus includes a first signal receiver, a second signal transmitter, and a transmission data controller. For example, the first signal receiver is the terminal communicators 220, 220b, 520, and 520b, the second signal transmitter is the base station communicators 260, 260a, and 297, and the transmission data controller is the transmission data controllers 240, 240a, 240b, 245, 280, 285, 290, 295, 540, 540a, 540b, 545, 580, 585, 590, and 595. The first signal receiver receives a wireless first signal transmitted by the first communication apparatus by a reception antenna, and acquires waveform data of the first signal received by the reception antenna. The second signal transmitter transmits the waveform data acquired by the first signal receiver to the second communication apparatus by a second signal. The transmission data controller controls the data amount of the waveform data generated by the first signal receiver on the basis of information regarding communication quality between the relay apparatus and the first communication apparatus at a relay apparatus position where the first signal has been received.

The second communication apparatus includes a second signal receiver, a second signal reception processor, and a first signal reception processor. For example, the second signal receiver is the receiver 420, the second signal reception processor is the base station signal reception processor 430, and the first signal reception processor is the terminal signal reception processors 440 and 440b. The second signal receiver receives the second signal transmitted from the relay apparatus. The second signal reception processor performs reception processing of the second signal received by the second signal receiver and acquires waveform data. The first signal reception processor performs reception processing of the first signal indicated by the waveform data acquired by the second signal reception processor, and acquires data set to the first signal by the first communication apparatus.

The transmission data controller may control the data amount of the waveform data generated by the first signal receiver by changing a quantization bit number used for generating the waveform data.

In addition, the transmission data controller may control the data amount of the waveform data generated by the first signal receiver by increasing or decreasing a number of the reception antennas from which the waveform data is obtained among a plurality of the reception antennas. In this case, the transmission data controller selects the reception antenna from which the waveform data of the first signal is obtained in such a manner that a distance between selected reception antennas increases.

The information regarding the communication quality may be information of an elevation angle from a predetermined position in an area where the first communication apparatus that communicates with the relay apparatus is installed to the relay apparatus position, or may be information of a population density of an area where the first communication apparatus that communicates with the relay apparatus is installed. In addition, the information regarding the communication quality may be information of reception quality of a first signal obtained when the first signal received by the reception antenna in the past is subjected to the reception processing in the first signal reception processor. Further, the information regarding the communication quality may be information of an interference signal measured by a measurement apparatus. The information regarding the communication quality may be one or both of the number of the first communication apparatuses estimated on the basis of the first signal received by each of the plurality of reception antennas and an arrival direction of the first signal.

The second communication apparatus may further include an instructor. The instructor instructs the relay apparatus to increase the data amount of the waveform data when a decrease in the communication quality is detected during the reception processing in the first signal reception processor. For example, the instructors are the analyzers 482 and 682, and the instruction to increase the data amount of the waveform data is the instruction to increase the number of reception antennas or the quantization bit number increase instruction.

The wireless communication system may further include a controlled variable determiner. For example, the controlled variable determiner is the antenna number determiners 242, 247, 282, 287, 292, 452, and 457, the analyzers 482 and 682, the quantization bit number determiners 542, 547, 582, 587, 592, 652, and 657, and the analysis apparatuses 820 and 830. The controlled variable determiner determines a control value for the transmission data controller to control the data amount of the waveform data generated by the first signal receiver at the relay apparatus position on the basis of information of the communication quality between the relay apparatus and the first communication apparatus at the relay apparatus position. The controlled variable is the number of antennas or the quantization bit number.

The transmission data controller controls the first signal receiver to generate, at a predetermined timing, waveform data of a waveform data amount larger than a waveform data amount corresponding to the information regarding the communication quality between the relay apparatus and the first communication apparatus at the relay apparatus position at the predetermined timing. The controlled variable determiner determines the control value corresponding to the relay apparatus position at the predetermined timing on the basis of the waveform data at the predetermined timing obtained by the second signal reception processor performing the reception processing of the second signal. The controlled variable determiner is, for example, the analyzers 482 and 682.

The second signal transmitter may transmit the wireless second signal using a plurality of transmission antennas. In this case, the relay apparatus may further include a transmission antenna controller. The transmission antenna controller controls the second signal transmitter to transmit the second signal using the transmission antennas of the number of transmission antennas corresponding to the data amount of the waveform data transmitted by the second signal.

Note that the relay apparatus may be provided in a flying object such as a low earth orbit satellite. The first communication apparatus and the second communication apparatus may be installed on the earth.

Although the embodiments of the present invention have been described in detail with reference to the drawings, specific configurations are not limited to the embodiments, and include design and the like within the scope of the present invention without departing from the gist of the present invention.

### REFERENCE SIGNS LIST

1, 101, 101a, 101b, 102, 102a, 103, 104, 111, 111a, 111b, 112, 112a, 113, 114 Wireless communication system
2, 201, 201a, 201b, 202, 203, 204, 205, 206, 501, 501a, 501b, 502, 503, 504, 505, 506 Mobile relay station
3, 301 Terminal station
4, 401, 401a, 401b, 402, 403, 404, 601, 602, 603 Base station
210-1 to 210-N, 270, 330 Antenna
220, 220b, 520, 520b Communication terminal communicator
221-1 to 221-N, 265, 420 Receiver
222-1 to 222-N, 224-1 to 224-N, 522-1 to 522-N, 524-1 to
524-N Reception waveform recorder
223-1 to 223-N, 442-1 to 442-N, 492-1 to 492-N Frequency convertor
230, 310 Data storage
240, 240a, 240b, 245, 280, 285, 290, 295, 540, 540a, 540b,
545, 580, 585, 590, 595 Transmission data controller
241, 241a, 246, 261, 261a, 281, 298, 451, 456, 481, 541,
541a, 546, 581, 651, 656, 681, 902 Storage
242, 247, 282, 287, 292, 452, 457 Antenna number determiner
243, 453 Antenna selector
244, 244a, 244b Reception controller
260, 260a, 297 Base station communicator
262, 262a, 299 Controller
263 Transmission data modulator
264, 320, 470 Transmitter
266 Reception processor
281 Storage
291 Estimator
296, 596 Transmission antenna controller
410 Antenna station
430 Base station signal reception processor
440, 440b Terminal signal reception processor
441, 441b, 491 Distributor
443, 493 Signal processor
444, 494 Terminal signal decoder
450, 455, 650, 655 Control information generator
460 Base station signal transmission processor
480, 680 Instructor
482, 682 Analyzer
490 Analysis reception processor
542, 547, 582, 587, 592, 652, 657 Quantization bit number determiner
543, 543a, 543b Quantization bit number instructor
810 Waveform sampling apparatus
820, 830 Analysis apparatus
901 Processor
903 Communication interface
904 User interface

1. A wireless communication system comprising a first communication apparatus, a second communication apparatus, and a moving relay apparatus, wherein
the relay apparatus includes
a first signal receiver that receives a wireless first signal transmitted by the first communication apparatus by a reception antenna, and acquires waveform data of the first signal received by the reception antenna,
a second signal transmitter that transmits the waveform data acquired by the first signal receiver to the second communication apparatus by a second signal, and
a transmission data controller that controls a data amount of the waveform data generated by the first signal receiver on a basis of information regarding communication quality between the relay apparatus and the first communication apparatus at a relay apparatus position where the first signal has been received, and
the second communication apparatus includes
a second signal receiver that receives the second signal transmitted from the relay apparatus,
a second signal reception processor that performs reception processing of the second signal received by the second signal receiver and acquires the waveform data, and
a first signal reception processor that performs reception processing of the first signal indicated by the waveform data acquired by the second signal reception processor, and acquires data set to the first signal by the first communication apparatus.

2. The wireless communication system according to claim 1, wherein
the transmission data controller controls the data amount of the waveform data generated by the first signal receiver by changing a quantization bit number used for generating the waveform data.

3. The wireless communication system according to claim 1, wherein
the transmission data controller controls the data amount of the waveform data generated by the first signal receiver by increasing or decreasing a number of the reception antennas from which the waveform data is obtained among a plurality of the reception antennas.

4. The wireless communication system according to claim 3, wherein
the transmission data controller selects the reception antenna from which the waveform data of the first signal is obtained in such a manner that a distance between selected reception antennas increases.

5. The wireless communication system according to claim 1, wherein
the information regarding the communication quality is information of an elevation angle from a predetermined position in an area where the first communication apparatus that communicates with the relay apparatus is installed to the relay apparatus position, or information of a population density of an area where the first communication apparatus that communicates with the relay apparatus is installed.

6. The wireless communication system according to claim 1, wherein
the information regarding the communication quality is information of reception quality of a first signal obtained when the first signal received by the reception antenna in a past is subjected to the reception processing in the first signal reception processor.

7. The wireless communication system according to claim 1, wherein
the information regarding the communication quality is information of an interference signal measured by a measurement apparatus.

8. The wireless communication system according to claim 1, wherein
the information regarding the communication quality is one or both of a number of the first communication apparatuses estimated on a basis of the first signal received by each of the plurality of reception antennas and an arrival direction of the first signal.

9. The wireless communication system according to claim 1, wherein
the second communication apparatus further includes an instructor that instructs the relay apparatus to increase the data amount of the waveform data when a decrease in the communication quality is detected during the reception processing in the first signal reception processor.

10. The wireless communication system according to claim 1, further comprising
a controlled variable determiner that determines a control value for the transmission data controller to control the data amount of the waveform data generated by the first signal receiver at the relay apparatus position on a basis of information of the communication quality between the relay apparatus and the first communication apparatus at the relay apparatus position.

11. The wireless communication system according to claim 10, wherein
the transmission data controller controls the first signal receiver to generate, at a predetermined timing, waveform data of a waveform data amount larger than a waveform data amount corresponding to the information regarding the communication quality between the relay apparatus and the first communication apparatus at the relay apparatus position at the predetermined timing, and
the controlled variable determiner determines the control value corresponding to the relay apparatus position at the predetermined timing on a basis of the waveform data at the predetermined timing obtained by the second signal reception processor performing the reception processing of the second signal.

12. The wireless communication system according to claim 1, wherein
the second signal transmitter transmits the wireless second signal using a plurality of transmission antennas, and
the relay apparatus further includes a transmission antenna controller that controls the second signal transmitter to transmit the second signal using the transmission antennas of a number of transmission antennas corresponding to the data amount of the waveform data transmitted by the second signal.

13. The wireless communication system according to claim 1, wherein
the relay apparatus is provided in a flying object.

14. The wireless communication system according to claim 1, wherein
the relay apparatus is provided in a low earth orbiting satellite, and
the first communication apparatus and the second communication apparatus are installed on the earth.

15. A relay apparatus in a wireless communication system including a first communication apparatus, a second communication apparatus, and a moving relay apparatus, the relay apparatus comprising:
a first signal receiver that receives a wireless first signal transmitted by the first communication apparatus by a reception antenna, and acquires waveform data of the first signal received by the reception antenna;
a second signal transmitter that transmits the waveform data acquired by the first signal receiver to the second communication apparatus by a second signal; and
a transmission data controller that controls a data amount of the waveform data generated by the first signal receiver on a basis of information regarding communication quality between the relay apparatus and the first communication apparatus at a relay apparatus position where the first signal has been received.

16. A wireless communication method executed by a wireless communication system including a first communication apparatus, a second communication apparatus, and a moving relay apparatus, the wireless communication method comprising:
receiving, by the relay apparatus, a wireless first signal transmitted by the first communication apparatus by a reception antenna, and acquiring, by the relay apparatus, waveform data of the first signal received by the reception antenna;
transmitting, by the relay apparatus, the waveform data acquired by the relay apparatus to the second communication apparatus by a second signal;
controlling, by the relay apparatus, a data amount of the waveform data acquired by the relay apparatus on a basis of information regarding communication quality between the relay apparatus and the first communication apparatus at a relay apparatus position where the first signal has been received;
receiving, by the second communication apparatus, the second signal transmitted from the relay apparatus;
performing, by the second communication apparatus, reception processing of the second signal and acquiring, by the second communication apparatus, the waveform data; and
performing, by the second communication apparatus, reception processing of the first signal indicated by the waveform data acquired by the second communication apparatus, and acquiring data set to the first signal by the first communication apparatus.

17. (canceled)

18. (canceled)

19. The wireless communication system according to claim 2, wherein
the information regarding the communication quality is information of an elevation angle from a predetermined position in an area where the first communication apparatus that communicates with the relay apparatus is installed to the relay apparatus position, or information of a population density of an area where the first communication apparatus that communicates with the relay apparatus is installed.

20. The wireless communication system according to claim 2, wherein
the information regarding the communication quality is information of reception quality of a first signal obtained when the first signal received by the reception antenna in a past is subjected to the reception processing in the first signal reception processor.

21. The wireless communication system according to claim 2, wherein
the information regarding the communication quality is information of an interference signal measured by a measurement apparatus.

22. The wireless communication system according to claim 2, wherein
the information regarding the communication quality is one or both of a number of the first communication apparatuses estimated on a basis of the first signal received by each of the plurality of reception antennas and an arrival direction of the first signal.
